(19) United States
(12) Patent Application Publication
(10) Pub. No.: US 2018/0234320 A1
(43) Pub. Date: Aug. 16, 2018

(54) CAPACITY COMPARISONS

(71) Applicant: Aruba Networks, Inc., Sunnyvale, CA (US)

(72) Inventors: Arogyaswami Paulraj, Sunnyvale, CA (US); Bernd Bandemer, Santa Clara, CA (US); Jose Tellado, Santa Clara, CA (US); Pradeep Nemavat, Sunnyvale, CA (US)

(21) Appl. No.: 15/952,563

(22) Filed: Apr. 13, 2018

Related U.S. Application Data
(63) Continuation-in-part of application No. 14/994,026, filed on Jan. 12, 2016.
Application No. 14/994,026 is a continuation-in-part of application No. 14/827,282, filed on Aug. 15, 2015, now Pat. No. 9,894,536.
Application No. 14/827,282 is a continuation-in-part of application No. 14/720,755, filed on May 23, 2015, now Pat. No. 9,720,760.
Application No. 14/720,755 is a continuation-in-part of application No. 14/643,332, filed on Mar. 10, 2015.

(51) Int. Cl. H04L 12/26

(52) U.S. Cl. CPC H04L 43/0888; H04W 84/12

(57) ABSTRACT

Example implementations relate to capacity comparisons. For instance, an example network device may include a processing resource and a memory resource storing machine readable instructions. The instructions may cause the processing resource to receive, from a device that performs a network application, a first stream of a wireless link between the device and a wireless network and a second stream of the wireless network that competes with the first stream, estimate a capacity of the stream that corresponds to a potential throughput of the stream over the wireless network, compare the estimated capacity with a demanding capacity of the network application whose associated data are transmittable by the stream, and determine a degree in which the demanding capacity of the network application is met by the estimated capacity.

### RELATED APPLICATIONS

This patent application is a continuation-in-part (CIP) of U.S. patent application Ser. No. 14/994,026, filed Jan. 12, 2016, which is a continuation-in-part (CIP) of U.S. patent application Ser. No. 14/827,282, filed Aug. 15, 2015 and granted as U.S. Pat. No. 9,894,536 on Feb. 13, 2018, which is a continuation-in-part (CIP) of U.S. patent application Ser. No. 14/720,755, filed on May 23, 2015 and granted as U.S. Pat. No. 9,720,760 on Aug. 1, 2017, which is a continuation-in-part (CIP) of U.S. patent application Ser. No. 14/643,332, filed Mar. 10, 2015, which are herein incorporated by reference.

### BACKGROUND

Data networks route data traffic via a collection of network devices that take the form of, for example, routers, hubs and switches. Very large networks may involve hundreds or even thousands of network devices such as switches, routers, access points, telecommunications towers, gateways, client devices, etc.

### BRIEF DESCRIPTION OF THE DRAWINGS

FIG. 1A shows a block diagram of a sensor and a capacity estimator estimating a capacity of at least one stream of a wireless link between a transmitter and a receiver, according to the disclosure.

FIG. 1B shows a block diagram of a sensor and a capacity estimator estimating a capacity of at least one stream of a wireless link between a transmitter and a receiver, according to the disclosure.

FIG. 2 shows a block diagram of a sensor and a capacity estimator estimating a capacity of at least one stream of a wireless link between a transmitter and a receiver, according to the disclosure.

FIG. 3 shows a block diagram of a sensor and a capacity estimator estimating a capacity of at least one stream of a wireless link between a transmitter and a receiver, according to the disclosure.

FIG. 4 shows a time line of an example of multiple streams of the wireless link, according to the disclosure.

FIG. 5 shows a block diagram of multiple sensors and a capacity estimator estimating a capacity of at least one stream of a wireless link between a transmitter and a receiver, according to the disclosure.

FIG. 6 is a flow chart of a method of estimating a capacity of at least one wireless stream of a wireless link, according to the disclosure.

FIG. 7 shows a block diagram of a motion-controlled device that supports deployment and operation of a wireless network, according to the disclosure.

FIG. 8 shows another block diagram of a motion-controlled device that supports deployment and operation of a wireless network, according to the disclosure.

FIG. 9 shows another block diagram of a motion-controlled device that supports deployment and operation of a wireless network, according to the disclosure.

FIG. 10 shows another block diagram of a motion-controlled device that supports deployment and operation of a wireless network, according to the disclosure.

FIG. 11 shows a block diagram of a motion-controlled device that supports deployment and operation of a wireless network that includes a docking mechanism, according to the disclosure.

FIG. 12 shows a device at a sequence of locations of a wireless network, according to the disclosure.

FIG. 13 shows a multiple motion-controlled devices that support deployment and operation of a wireless network, according to the disclosure.

FIG. 14 is a flow chart that shows a method of supporting deployment and operation of a wireless network, according to the disclosure.

FIG. 15 shows a wireless network that includes an analytic engine operative to mitigate wireless networking issues, according to the disclosure.

FIG. 16 shows an analytics engine interfaced with a wireless device agent of an end device, according to the disclosure.

FIG. 17 shows a wireless network that includes an analytic engine and a network device operative to mitigate wireless networking issues, according to the disclosure.

FIG. 18 shows a wireless network that includes an analytic engine and a network device operative to mitigate wireless networking issues, according to the disclosure.

FIG. 19 shows a wireless network that includes an analytic engine and a network device operative to mitigate wireless networking issues, according to the disclosure.

FIG. 20 shows an end device that is interfaced with a network through a first channel and a second channel, according to the disclosure.

FIG. 21 shows a wireless device that is interfaced with a network through a first channel, and through a second channel provided by a second device, according to the disclosure.

FIG. 22 shows an analytics engine operative to allow a wireless device to facilitate mitigating a wireless network issue associated with a second wireless device, according to the disclosure.

FIG. 23 shows multiple wireless devices that are interfaced with corresponding local analytics engines and a global analytics engine, according to the disclosure.

FIG. 24 is a flow chart that includes a method of mitigating an issue associated with a wireless mesh network, according to the disclosure.

FIG. 25 shows a block diagram of a sense, model and control methodology for improving performance of a wireless network, according to the disclosure.

FIG. 26 shows a wireless network that includes multiple wireless sensors, according to the disclosure.

FIG. 27 shows a wireless sensor, according to the disclosure.

FIG. 28 is a flow chart that includes a method of operating a wireless sensor, according to the disclosure.

FIG. 29 is a flow chart that includes a method of estimating quality of wireless links between different wireless end devices, according to the disclosure.

FIG. 30 shows a pair of wireless end devices and wireless sensors, according to the disclosure.

FIG. 31 illustrates an example network layout according to the disclosure.

FIG. 32 is a block diagram of an example network device for capacity comparisons according to the disclosure.

FIG. 33 is a block diagram of an example analytic engine for capacity comparisons according to the disclosure.

FIG. 34 is a block diagram of an example system according to the disclosure.

### DETAILED DESCRIPTION

Wireless networks may be deployed to provide various types of communication to multiple users through the air using electromagnetic waves. As a result, various types of communication may be provided to multiple users without cables, wires, or other physical electric conductors to couple devices in the wireless network. Examples of the various types of communication that may be provided by wireless networks include voice communication, data communication, multimedia services, etc.

An example of a wireless network is a wireless local area network (WLAN). As used herein, the term “wireless local area network (WLAN)” can, for example, refer to a communications network that links two or more devices using some wireless distribution method (for example, spread-spectrum or orthogonal frequency-division multiplexing radio), and usually providing a connection through an access point to the Internet; and thus, providing users with the mobility to move around within a local coverage area and still stay connected to the network. WLANs may include multiple stations, controllers (e.g., WLAN controller(s)), and/or access points (APs) that may communicate over wireless channels. That is, WLANs may include stations and/or access points (APs) that may communicate over a plurality of wireless channels. As used herein, an AP can be a networking hardware device that allows a wireless-compliant device (e.g., a station) to connect to a network, while a controller may perform configuration operations and/or authentication operations on APs and/or station.

An AP may provide connectivity with a network such as the internet to the stations. As used herein, a station can be a device that has the capability to use the Institute of Electrical and Electronics Engineers (IEEE) 802.11 protocol. Examples of stations include smart phones, laptops, physical non-virtualized computing devices, personal digital assistants, etc. In some examples, a station may be a device that contains an IEEE 802.11-conformant media access control (MAC) and physical layer (PHY) interface to a wireless medium (WM).

Wireless networks such as WLANs such as those defined in the IEEE wireless communications standards, e.g., IEEE 802.11a, IEEE 802.11n, IEEE 802.11ac, 802.11ax can use various wireless communication technologies, for example, orthogonal frequency division multiplexing (OFDM), a single-in-single-out (SISO), and/or a multiple-in-multiple-out (MIMO) communication approach, among other types of approaches to transmit and receive signals.

Resources of WLANs may be finite such that different network devices and/or different network applications attempting to utilize the resource of WLANs may compete with each other. Such a competition may result in undesired latencies in transmitting information (e.g., data) and/or performance rate that may be undesirably reduced due to the resulting latencies. In these circumstances, specifying a degree of the undesired latencies and/or reduced performance rate may be beneficial.

Accordingly, the disclosure is directed to capacity comparisons that provides an indication of a state of traffic in a communicable form. A network device suitable for capacity comparisons may include a memory resource, and a processing resource to execute executable instructions stored in the memory resource. For example, the processor can execute executable instructions stored in the memory resource to cause receive, from a device that performs a network application, a first stream of a wireless link between the device and a wireless network and a second stream that competes with the first stream, estimate a capacity of the stream that corresponds to a potential throughput of the stream over the wireless network, compare the estimated capacity with a demanding capacity of the network application whose associated data are transmittable by the stream, and determine a degree in which the demanding capacity of the network application is met by the estimated capacity.

As used herein, ‘network device’ can include a device that is adapted to transmit and/or receive signaling and to process information within such signaling such as a station (e.g., any data processing equipment such as a computer, cellular phone, personal digital assistant, tablet devices, etc.), an access point, data transfer devices (such as network switches, routers, controllers, etc.) or the like. The network device may be adapted with circuitry to support wireless connectivity with other network devices being part of a wireless network.

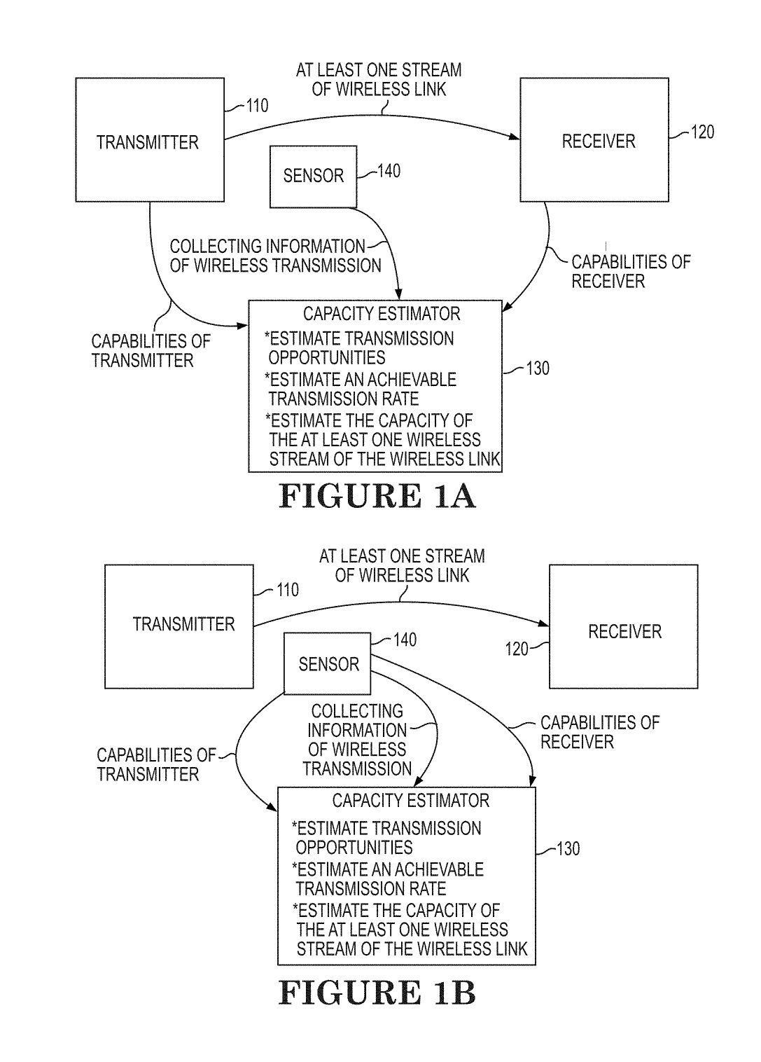

FIG. 1A shows a block diagram of a sensor 140 and a capacity estimator 130 estimating a capacity of at least one stream of a wireless link between a transmitter 110 and a receiver 120, according to the disclosure. As shown, the at least one stream of wireless signals is communicated from the transmitter 110 to the receiver 120. That is, the transmitter 110 transmits the at least one stream of the wireless signals of the wireless link, and the receiver 120 receives the at least one stream of the wireless signals of the wireless link.

In various examples, the wireless link is established between the transmitter 110 and the receiver 120. In various examples, the wireless link includes multiple wireless streams of different access categories. In various examples, a stream includes a priority and/or a traffic type.

In some examples, a link includes a wireless connection between two wireless devices and is formed by exchange of a set of connection frames. Further, in some examples, the wireless link includes multiple logical wireless streams where each stream has a different priority to send its traffic over the wireless medium (through the wireless link). A wireless link with priority defines a wireless stream. Traffic from higher priority stream is given a different treatment as compared to traffic from lower priority stream.

In the context of an WiFi (IEEE 802.11) medium access control (MAC) entity, a wireless link includes a physical path including one traversal of the wireless medium (WM) that is used to transfer an MAC service data unit (MSDU) between two stations (STAs or transmitters). In various examples, the traffic stream (TS) includes a set of medium access control (MAC) service data units (MSDUs) to be delivered subject to the quality-of-service (QoS) parameter values provided to the MAC in a particular traffic specification (TSPEC). TSs are meaningful to MAC entities that support QoS within the MAC data service. These MAC entities determine the TSPEC applicable for delivery of MSDUs belonging to a particular TS using the priority parameter provided with those MSDUs at the MAC service access point (MAC_SAP).

In various examples, the capacity of the at least one stream is the potential throughput that is achievable for the at least one stream. In various examples, the capacity of a wireless link is the potential throughput that is achievable for the wireless link.

In some examples, the sensor 140 is operative to sense information of a wireless transmission, wherein the wireless transmission includes at least a portion of a transmission signal with electromagnetic energy above a certain threshold within a frequency band of a wireless link. In some examples, the wireless transmission is between the transmitter 110 and the receiver 120. In some examples, the wireless transmission includes electromagnetic energy of wireless transmission of different transmitters and receivers. In some examples, the wireless transmission includes electromagnetic energy from a completely different communication system. In some examples, the wireless transmission includes electromagnetic energy from separate source, such as, for example, a microwave oven.

In some examples, the capacity estimator is operative to obtain capabilities of a transmitter and of a receiver of the wireless link. As illustrated in FIG. 1A, the capabilities are shown as being obtained from the transmitter 110 and the receiver 120. However, the capabilities can be obtained in many different ways. For example, FIG. 1B shows a block diagram of a sensor and a capacity estimator estimating a capacity of at least one stream of a wireless link between a transmitter and a receiver, according to the disclosure, wherein the capabilities of a transmitter and of a receiver of the wireless link are obtained from the sensor 140. In some examples, the capacity estimator obtains the capabilities of a transmitter and of a receiver from a database of a plurality of wireless devices of various types. In various examples, the database is populated based on historical capability observations per device or per device type. In various examples, the capabilities of a transmitter and of a receiver that are obtained by the capacity estimator include one or more of the following: Backoff/contention parameters (CWmin, CWmax, AIFSN), Rate parameters (Nss (Number of spatial streams), Bandwidth, Modulation and Coding, Guard interval), Aggregation parameters (Number of mpdus in AMPDU, length of AMPDU, MPDU size), Burst behavior (This defines how many PPDUs (PLCP Protocol Data Units) will be sent in succession on a transmit opportunity win), PER (Packet error rate is a measure of how many packets had to be transmitted multiple times before the transmitter received the acknowledgement from the receiver), Overhead (Protocol overhead, protection frames overhead, security overhead etc.).

In some examples, the capacity estimator is operative to collect the information of the wireless transmission. As shown and described, in various examples, the sensor 140 senses the wireless transmission. In various examples, the sensor 140 communicates the sensed wireless transmission to the capacity estimator 130.

In some examples, the capacity estimator 130 estimates transmission opportunities available for the transmitter to transmit wireless communications to the receiver based on the obtained capabilities and the collected information, estimates an achievable transmission rate by the transmitter based on the determined capabilities and the collected information, and estimates the capacity of at least one wireless stream of the wireless link based on the estimated transmission opportunities and the estimated achievable transmission rate.

In various examples, in a WiFi system, the capacity estimator 130 estimates transmission opportunities available for the transmitter to transmit wireless communications to the receiver based on the obtained capabilities and the collected information as described. In some examples, the WiFi follows CSMA/CA medium access. That is all the STAs (transmitters) sense the medium before transmission and transmit if the medium is sensed available. If the medium is busy the STAs backoff transmission for a random duration based on some parameters. Therefore, if two WiFi STAs have the same parameters for backoff and always have traffic to transmit, in the long run the two WiFi STAs will have identical number of transmission opportunities distributed fairly among them.

In various examples, a transmission opportunity includes sensing the medium (wireless link) as idle after completion of the backoff period. Based on the backoff parameters for different streams, and streams usage of the transmission opportunities, how many transmission opportunities will be available for the at least one stream can be determined for doing which capacity estimation is being done. It is assumed that the stream has a constant flow of traffic available to send.

In various examples, determining the transmission opportunities includes executing a max-min fairness algorithm. In various examples, this includes all the streams using less than their fair share of transmission opportunities winning all they demand and the remaining transmission opportunities are equally divided among the remaining streams. Each stream might transmit a different average amount of time for its transmission opportunities. So the average medium usage of the stream combined with its transmit opportunities usage may be used to determine the transmission opportunities win for the at least one stream. For example, assuming there is one stream that wins 180 transmission opportunities and transmits for 5 milliseconds each in a 1 second interval (accounting for about 10% of backoff overhead). If there is a new stream (with same priority as existing stream) that starts to contend and use the medium for 10 ms every time it wins the contention, the number of transmission opportunities will be equally divided between the existing stream and the new stream. But the time will not be, as the existing stream will use about half the time of the new stream as it transmits half of the time of the new stream every time it wins the medium. In this case, one-contention-cycle can be computed as sum of all medium usage. In this case it will be 15 ms (10+5). Dividing 1-sec intervals into 15 msec contention cycles it can be found that about 60 cycles can be accommodated, accounting for about 10% of backoff overhead. So the existing stream will have 60 transmission opportunities and can use the wireless medium for 300 ms. The new stream will have 60 transmission opportunities and can use the wireless medium for 600 ms.

In various examples, the existing stream and the new stream are of different priorities. In this case the number of transmission opportunities won by the two streams will not be equal but will be higher for higher priority stream. The exact ratio can be computed based on the parameters for contention or can be looked up from a pre-determined table.

In some examples, the existing stream and the new stream are of different priorities and multiple levels of min-max fairness algorithm are used. The higher priority stream will win all the transmission opportunities that are demanded and the remaining will be distributed equally among the next priority of the streams. The multiple levels may be utilized for multiple levels of priority. Within the same priority streams, another instance of min-max fairness can be executed favoring low stream users as explained earlier.

As described herein associated with determining the transmission opportunities, a waiting period before each transmission can be defined. The waiting period can be divided into pre-backoff (distributed coordination function interframe space (DIFS) and arbitration interframe space (AIFS)) time and actual backoff (down-counting of actual backoff slots) time. The pre-backoff time overhead is applied for every transmit opportunity win and backoff time overhead is applied once for a contention cycle. The idea is that the down-counting of backoff slots happens in parallel at all the transmitters.

In some examples, the capacity estimator 130 estimates an achievable transmission rate by the transmitter based on the determined capabilities and the collected information using one or more of the following methods: determining the actual rate from the PHY header of data PPDUs (PHY protocol data unit), lookup the rate information from an application running on the client or from the wireless LAN controller if it provides such information.

In some examples, the capacity estimator 130 estimates an achievable transmission rate by the transmitter based on the determined capabilities and the collected information by determining the time duration from CTS (Clear to send frame) to BA (block acknowledgment frame), or the time duration from one BA to another BA in a burst. Based on the time duration and the AMPDU length (aggregate MAC protocol data unit), the rate at which the AMPDU was sent can be approximated. The AMPDU length itself can be estimated based on BA bitmap and the known or estimated MPDU length used by the transmitter.

In some examples, the capacity estimator 130 estimates an achievable transmission rate by the transmitter based on the determined capabilities and the collected information by determining the RSSI of the link and lookup the rate that is most likely to be used at this RSSI. In some examples, the capacity estimator 130 estimates an achievable transmission rate by the transmitter based on the determined capabilities and the collected information by using the rate from one of the previous AMPDUs assuming the rate has not changed more than a threshold.

In some examples, estimating the capacity of the at least one wireless stream of the wireless link based on the estimated transmission opportunities and the estimated achievable transmission rate includes accounting for protocol overhead. That is, account for medium resources that are used for transmitting auxiliary information and are thus not available for transmitting payload information. In various examples, one or more of the following kinds of overhead are accounted for Physical layer (PHY) header, Frame headers (includes MPDU header, MPDU delimiters in AMPDU, LLC (logical link control) header, Security header, AMSDU header in case of AMSDU, FCS (frame check sequence), Mandatory waiting periods before transmission due to backoff or SIFS time, TCP acknowledgements, Control frames (Protection frames such as RTS (request to send)/CTS, acknowledgement frames such as ack/blockacks).

In some examples, estimating the capacity of the at least one wireless stream of the wireless link based on the estimated transmission opportunities and the estimated achievable transmission rate includes accounting a reverse stream. In various examples, the reverse stream is the one where the transmitter and receiver in the original stream are swapped to become receiver and transmitter respectively. The priority of the stream may stay the same or change to some default priority such as Best Effort. That is, the reverse stream is a stream in which the roles of the transmitter and the receiver are reversed. The reverse stream impacts the achievable throughput on the stream. For example, TCP traffic entails ACK messages that travel in the reverse direction and compete for airtime with the data on the forward direction.

In some examples, estimating the capacity of the at least one wireless stream of the wireless link based on the estimated transmission opportunities and the estimated achievable transmission rate includes accounting for the packet error rate (PER) of the stream. In various examples, PER is observed during an observation period and assumed to remain constant. In various examples, the PER is looked up based on RSSI/rate. In various examples: the achievable transmission rate is estimated based on observing the transmission rate distribution of the transmitter.

In some examples, estimating the capacity of the at least one wireless stream of the wireless link based on the estimated transmission opportunities and the estimated achievable transmission rate includes assuming the wireless stream is part of a multi-hop network communication link, and accounting for link properties of the (wireless/wired) hops external to the at least one wireless stream of the wireless link. That is, within a multi-hop system, the wireless stream traverses more links than the present wireless link, and the capacity may be limited by characteristics of one or more of the other links, and the capacity of the present link may be limited to the capacity of the one or more other links. In some examples, the characteristics of the other link includes one or more of other hop capacity, latencies, drop rates, jitter, fragmentation, window size.

In some examples, as described herein, include collecting information of the wireless transmission. In some examples, the wireless transmission is passively collected. That is, for example, a sensor collects the information of the wireless transmission without affecting the wireless transmission. That is, the sensor “listens” in on the wireless transmission without influencing the wireless transmission.

In some examples, the wireless transmission is actively collected. That is, for example, the collecting includes directing one or more packets to be transmitted from the transmitter to the receiver. That is, packets are proactively directed to be transmitted from the transmitter to the receiver, and these packets aid in the collecting of information of the wireless transmission for the purpose of capacity estimation.

In some examples, a packet includes a data unit of a specified size. In various examples, a packet is designed specifically such that when transmitted from the transmitter to the receiver, a certain aspect of the wireless link is readily observed. For example, a packet is designed to be transmitted at a pre-specified transmission rate to determine whether this transmission rate is successfully achievable between the transmitter and the receiver at the time the packet is transmitted. For another example, a packet is part of a plurality of packets designed to allow the rate adaptation algorithm of the wireless system to reach a steady state for the wireless link between the transmitter and the receiver.

Some examples may include adaptively determining when to direct the one or more packets to be transmitted from the transmitter to the receiver. In various examples, if traffic of packets transmitted between the transmitter and the receiver is sensed to be above a threshold, then no packets or a selected number of packets are directed to be transmitted from the transmitter to the receiver. In various examples, if the traffic of packets transmitted between the transmitter and the receiver is sensed to be below a threshold, then the packets are directed to be transmitted from the transmitter to the receiver.

In some examples, estimating the achievable transmission rate is based on observation of one or more packets during an observation period. In various examples, this includes observing at what transmission rate the transmitter decides to send the packet. In various examples, this includes observing the transmission rate distribution. In various examples, this includes observing a PHY header of a packet and inferring the transmission rate based on number of bytes and duration as encoded in the PHY header. For example, the PHY header of a transmission packet is encoded more reliably than the remainder of the packet, and can thus be decoded with a lower error probability than the remainder of the packet. Thus, decoding PHY header while disregarding the remainder of the packet will yield more evidence for the transmission rate than the alternative approach of considering packets that are decoded successfully in their entirety. In various examples, this includes observing control packets and inferring the transmission rate of the data packets.

In some examples, the collected information of the wireless transmission includes a transmission rate distribution of signals of interest of the wireless link over an observation period. In various examples, the signal of interest is the communication signal that is intended to be sent over the wireless link.

In various examples, the rate distribution is represented by a frequency table of how many times each rate was seen (observed) in the last observation period. The frequency table allows lookups such as to determine the mean transmission rate, median transmission rate, or the transmission rate that will be exceeded with a pre-specified probability. The observation period is the interval of time during which information of the wireless transmission is collected.

In some examples, estimating the achievable transmission rate comprises extrapolating the achievable transmission rate from the transmission rate distribution. In various examples, the achievable transmission rate is assumed to be same as the observed transmission rate distribution if predicting the rate for the immediate period following the observation period. In various examples, the achievable transmission rate is the average data rate used during observation period or can capture the rate used majority of the times in the observation interval or some other statistical measure of the rate in observation period.

In some examples, estimating the achievable transmission rate includes decoding encoded PHY headers of packets of the wireless transmission. For high-rate packets, it might not be possible to observe the entire packet, but it may be still be possible to observe the robustly encoded PHY header, and deduce the information employed to determine the achievable transmission data rate from the from the robustly encoded PHY header.

In some examples, collecting information of the wireless transmission comprises receiving control messages of the wireless transmission, and further comprising estimating the achievable transmission rate based on the received control messages. In various examples, in a WiFi system, the transmission rate is estimated based on the time difference between CTS to BA control messages, and/or the time difference between one BA message to another BA message in a burst, and/or the estimated AMPDU length, and/or the BA bitmap. Using these, the rate at which the AMPDU was sent can be approximated.

Some examples may further include aggregating obtained capabilities and collected information of a plurality of wireless streams, and estimating the capacity of at least one of the plurality of wireless streams based on the aggregated obtained capabilities and collected information, wherein the estimating of the capacity accounts for the interactions between the wireless streams. In various examples, the estimating of the capacity includes estimating interactions between the plurality of wireless streams. This includes a plurality of streams within a single link, as well as a plurality of streams among several links. In various examples, the interaction occurs among multiple streams of the same link or multiple streams of multiple links. An example of former would be when a Best-Effort stream in WiFi is competing with a Video stream; both originating from the same transmitter and destined for the same receiver. An example of latter would be when two Best-Effort streams originating from two different transmitters contend for the medium.

Some examples may include obtaining capabilities/collecting information by one or more sensors. Some examples include at least one sensor close to the transmitter and the receiver of the wireless stream. Some examples include information collected directly from the transmitter or receiver. Some examples include sensors located in the vicinity of transmitters/receivers of other streams. Some examples include sensors located in the vicinity of wireless transmitters using a different wireless protocol.

Some examples may include estimating interactions between the plurality of wireless streams. In various examples, the interaction between the plurality of wireless streams is determined by the number of transmission opportunities available for the at least one stream for which the capacity is being estimated. To determine the transmission opportunities the max-min fairness algorithm can be executed. All the streams using less than their share of transmission opportunities will win all they demand and the remaining transmission opportunities will be equally divided among the remaining streams. Each stream might transmit a different average amount of time for its transmission opportunities. So the average medium usage of the stream combined with its transmit opportunities usage used to determine how many times a transmitter wins the transmission opportunity.

In some examples, collecting the information includes estimating a quality metric of the wireless transmission transmitted by the transmitter and received by the receiver, and further includes estimating the achievable transmission rate based on the estimated quality metric. For example, in various examples, an RSSI (received signal strength indicator) of the wireless transmission between the transmitter and the receiver is estimated. Based on the estimated RSSI, an MCS (modulation and coding scheme) that can be supported by the transmission between the transmitter and the receiver is estimated, which determines the achievable transmission rate by the transmitter. For another example, the rank of MIMO channel matrix is estimated for the same purpose. For another example, the motion of the transmitter and/or receiver is estimated for the purpose of estimating the expected variance in the wireless channel between the transmitter and receiver.

In some examples, collecting the information includes sensing use of the frequency band of the at least one wireless stream by other wireless streams, and further includes estimating the transmission opportunities based on the sensed use of the frequency band of the at least one wireless stream by the other wireless streams. In some examples, collecting information of a wireless transmission further includes identifying that the wireless transmission includes a different wireless protocol than a protocol of the at least one stream of the wireless link, and further includes measuring at least one property of the wireless transmission. Further, the estimating of the transmission opportunities available for the transmitter comprises accounting for the at least one measured property. In various examples, the other wireless protocols include wireless transmissions that occupy the same spectrum (frequency) as the at least one stream of the wireless link. In various examples, the other wireless protocols include wireless transmissions of non-communication systems that have spurious emissions in the same spectrum (microwave ovens). In some examples, the at least one property of the wireless transmission includes one or more of a duty cycle, a signal strength, or a signal frequency/band/bandwidth.

Some examples may account for different protocol wireless transmission (such as, non-WiFi) airtime, including measuring a power level of the different protocol wireless transmission, applying a threshold for the power level and consider the time for which the power is above this threshold level to compute interference from different protocol wireless transmission. In various examples, the total duration of different-protocol transmissions above the threshold is subtracted from the time available to the wireless stream of the wireless link. In various examples, in a WiFi system that is impeded by a wireless video surveillance system in the same frequency band, timeslots taken by the wireless video surveillance system will be avoided by WiFi transmitters.

In some examples, obtaining the capabilities of the transmitter and of the receiver of the wireless link further includes tracking dynamic capabilities of the at least one wireless stream, wherein the estimating of the capacity accounts for the tracked dynamic capabilities. In some examples, the tracked dynamic capabilities of the at least one wireless stream includes a subset of protocol features that the transmitter and receiver have agreed to use. In some examples, the tracking may be employed because it may not be possible to directly observe the capability exchange (between the transmitter and the receiver), but rather have to infer it from ongoing transmissions. In various examples, in a WiFi system, the tracking dynamic capabilities includes receiving action frames in which capabilities are renegotiated, and/or observing the transmitter's behavior in order to infer updated effective capabilities. In various examples, dynamic capabilities include power save states at the transmitter and receiver, capability reduction due to high load, and/or capability reduction based on the presence of legacy clients.

In some examples, the estimating the capacity of the at least one wireless stream of the wireless link further includes estimating a lower and upper bound on the estimated capacity and estimating a probability of an actual capacity being within the lower and upper bound. In various examples, the lower and upper bound are close together and estimated probability is high when prediction period is short and temporally close to the observation period, and grows as the prediction extends further into the future. Some examples may include a bound tightness and estimated probability depending on how well a state of the stream has been observed, how well transmitter and/or receiver of the stream are characterized/classified, and/or how many random quantities enter the computation (error propagation).

Some examples may include reporting the estimated capacity of the at least one wireless stream to an analytics engine. Further, in some examples, the analytics engine uses the estimated capacity to manipulate a parameter of a wireless network. In some examples, the manipulation of the parameter allows for performance optimization, load balancing, monitoring, deployment planning, and/or detecting anomalous network users/behaviors.

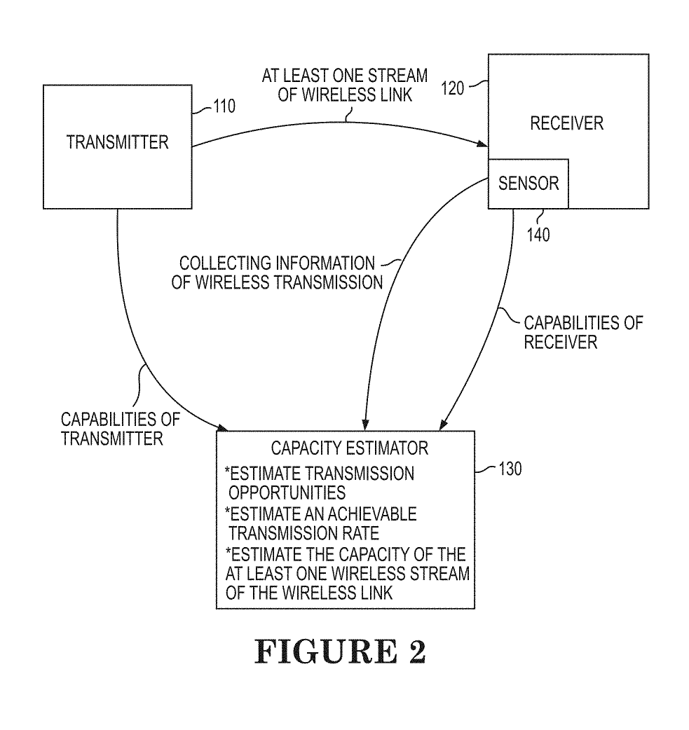

FIG. 2 shows a block diagram of a sensor and a capacity estimator estimating a capacity of at least one stream of a wireless link between a transmitter and a receiver, according to the disclosure. In this example, the sensor 140 is co-located with the receiver 120. In various examples, the sensor 140 is implemented as a software agent that runs on the receiver 120.

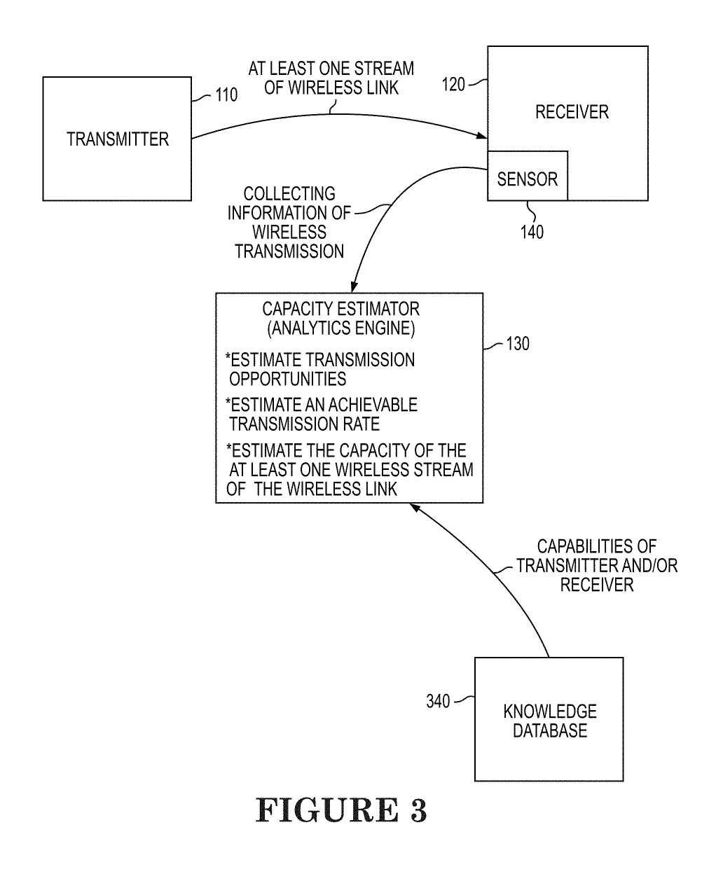

FIG. 3 shows a block diagram of a sensor and a capacity estimator estimating a capacity of at least one stream of a wireless link between a transmitter and a receiver, according to the disclosure. This example may further includes a knowledge database 340. In some examples, the capacity estimator obtains the capabilities of the transmitter and/or the receiver from the knowledge database 340. In various examples, the knowledge database 340 includes capabilities for each individual transmitter and receiver, based on historical observations of the transmitter and receiver. In some examples, the knowledge database further includes capabilities of wireless transmitters and receivers categorized by device class. For example, device classes include mobile phone, handheld tablet, laptop, etc. The per-class capabilities are used to complement the per-device capabilities. For example, capacity estimation for a device whose capabilities are not known (yet) is carried out based on the expected device capability based on its device class. Capacity estimation for a device whose capabilities are previously observed (and thus known) is based on these capabilities while ignoring the per-class capabilities.

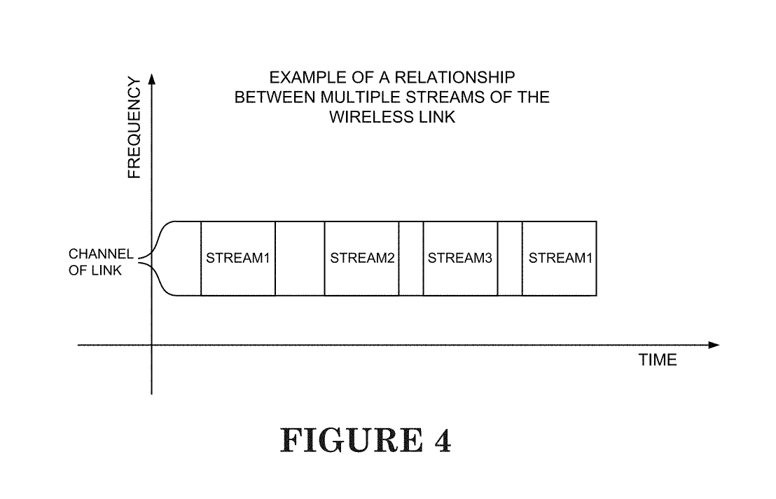

FIG. 4 shows a time line of an example of multiple streams of the wireless link, according to the disclosure. In this example, the link occupies a frequency allocation as designated by the channel of the link. Further, the different streams (Stream1, Stream2, Stream3) of the wireless link occupy different time slots of the channel of the link. The different streams are time multiplexed within the frequency allocation of the channel of the wireless link. It is to be understood that this is merely an example. The streams may alternatively or additionally be multiplexed across different subcarriers (e.g., OFDM), multiplexed across different spatial modes (spatial multiplexing), or multiplexed across different orthogonal codes (e.g., CDMA).

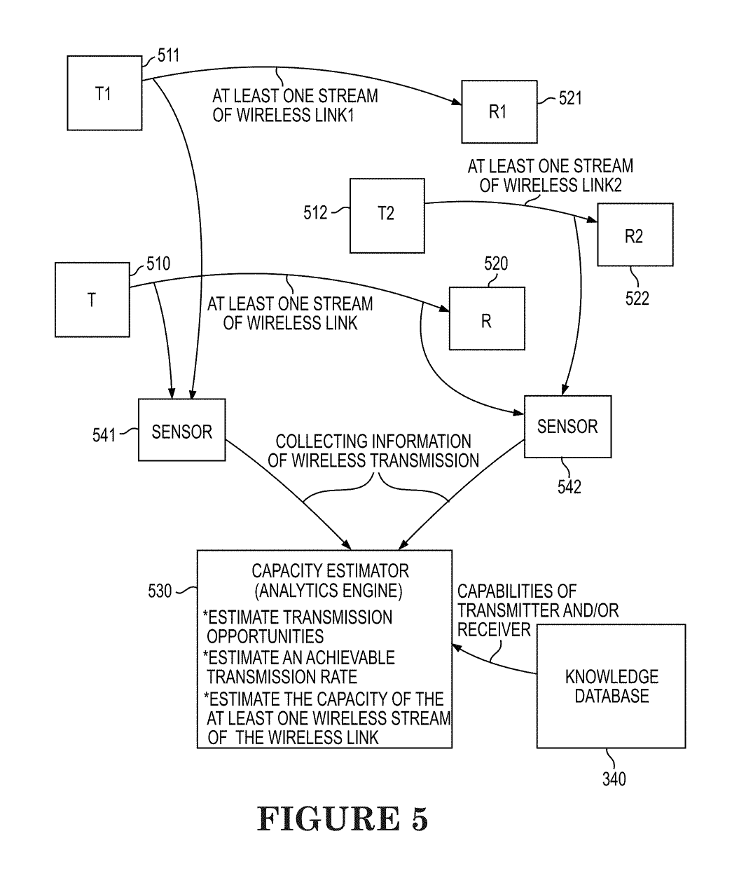

FIG. 5 shows a block diagram of multiple sensors 541, 542, and a capacity estimator 530 estimating a capacity of at least one stream of a wireless link between a transmitter and a receiver, according to the disclosure. As shown, the sensors 541, 542 are operable to sense at least one stream of a plurality of wireless links. For example, a transceiver (T) and a receiver (R) form a first wireless link which may be sensed by both sensor 541 and sensor 542. Another transceiver (T1) and another receiver (R1) form another wireless link (link1) that may be sensed, for example, by the sensor 541. Another transceiver (T2) and another receiver (R2) form another wireless link (link2) that may be sensed, for example, by the sensor 542.

In some examples, the capabilities of each of the transmitters 510, 511, 512 and each of the receivers 520, 521, 522 are obtained, for example, by the capacity estimator 530. As previously described, the capabilities may be obtained from the transmitters and receivers themselves, from the sensors 541, 542, and/or from the knowledge database 340.

In some examples, information of wireless transmission of at least one stream of each of the wireless links is collected. As previously described, the wireless transmissions includes at least a portion of a transmission signal with electromagnetic energy above a certain threshold within a frequency band of each of the wireless links. As previously described, in various examples, the sensors 541, 542 collect the information of the wireless links between the transmitters 510, 511, 512 and each of the receivers 520, 521, 522, and/or of other electromagnetic sources.

Further, as previously described, some examples may include estimating transmission opportunities available for each transmitter 510, 511, 512 to transmit wireless communications to the receivers 520, 521, 522 based on the obtained capabilities and the collected information. Further, as previously described, some examples may include estimating an achievable transmission rate by each transmitter 510, 511, 512 based on the determined capabilities and the collected information. Further, as previously described, some examples may include estimating the capacity of the at least one wireless stream of each wireless link based on the estimated transmission opportunities and the estimated achievable transmission rate.

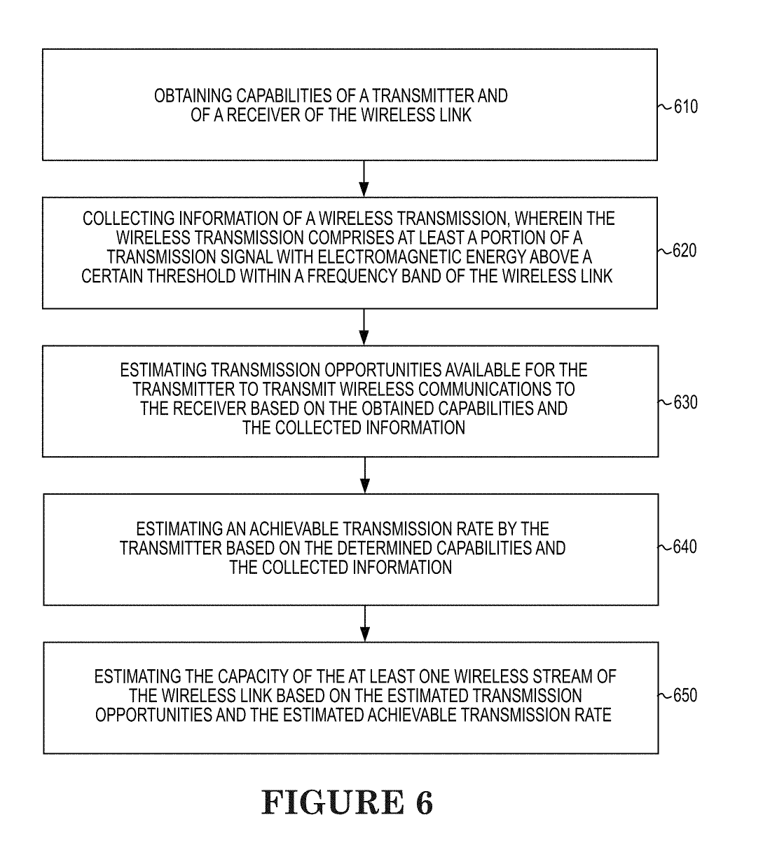

FIG. 6 is a flow chart of a method of estimating a capacity of at least one wireless stream of a wireless link, according to the disclosure. A method at 610 includes obtaining capabilities of a transmitter and of a receiver of the wireless link. In some examples, the receiver is merely a hypothetical receiver (not physically present). That is, for example, a user may query “if the user has a smart phone at this location of the user's house right now, what throughput would it be able to get?” The user would enter, for example, “iPhone” in the GUI, and the processing would assume the iPhone's capability (that is, the iPhone is the hypothetical receiver).

In one example for WiFi (802.11 WLAN) the capabilities of two wireless devices forming the link and the capability of the wireless link can be determined by looking at fields in association-request and association-response management frames. If an association-response frame is missing the AP capabilities can be obtained from a beacon as well.

In another example for WiFi, the capabilities for a hypothetical STA (transmitter) can be looked up in a database and the capability of the link can be determined from the capabilities of STA and AP. In another example for WiFi, the capabilities of the STA (transmitter) and/or AP (access point) and/or the link can be obtained by doing a SNMP query on wireless controller, which are typically used in managed enterprise WiFi environment.

In another example for WiFi, the capabilities for a STA, an AP and for the link between STA and AP can be stored in a database. For a later connection, if any of the capability information is missing, it can be looked up from the past stored information for the device or the link.

In another example for WiFi, a subset of capabilities for a device can be obtained by looking at the actual data frames being transmitted. For e.g. if a STA transmits an 80 Mhz data frame to the AP, it is definitely 80 Mhz capable, the AP is 80 Mhz capable and the link allows 80 Mhz capability. In another example for WiFi, if some of the capabilities are re-negotiated using other management frames, those can be determined by looking at the management frames. For e.g. operating mode field from a STA can indicate when it is moving from lower to higher channel bandwidth and vice-versa.

A method at 620 includes collecting information of a wireless transmission, wherein the wireless transmission comprises at least a portion of a transmission signal with electromagnetic energy above a certain threshold within a frequency band of the wireless link. It is to be understood that In some examples, the wireless transmission includes one or more of signals of interest of the wireless link, other wireless links in same system, other wireless links outside the system, spurious transmissions (e.g., microwave oven).

A method at 630 includes estimating transmission opportunities available for the transmitter to transmit wireless communications to the receiver based on the obtained capabilities and the collected information. In some examples, the transmission opportunities include one or more of time slots, frequency sub-channels, code slots, or a combination of the each. Further, in some examples, estimating transmission opportunities includes counting the number of opportunities out of a total, counting the fraction or a percentage.

As previously described, in various examples, one way to determine the transmission opportunities is to execute a max-min fairness algorithm. In various examples, this includes all the streams using less than their fair share of transmission opportunities winning all they demand and the remaining transmission opportunities are equally divided among the remaining streams. Each stream might transmit a different average amount of time for its transmission opportunities. So the average medium usage of the stream combined with its transmit opportunities usage employed to be used to determine the transmission opportunities win for the at least one stream. For example, assuming there is one stream that wins 180 transmission opportunities and transmits for 5 milliseconds each in a 1 second interval (accounting for about 10% of backoff overhead). If there is a new stream (with same priority as existing stream) that starts to contend and use the medium for 10 ms every time it wins the contention, the number of transmission opportunities will be equally divided between the existing stream and the new stream. But the time will not be, as the existing stream will use about half the time of the new stream as it transmits half of the time of the new stream every time it wins the medium. In this case, one-contention-cycle can be computed as sum of all medium usage. In this case it will be 15 ms (10+5). Dividing 1-sec intervals into 15 msec contention cycles it can be found that about 60 cycles can be accommodated, accounting for about 10% of backoff overhead. So the existing stream will have 60 transmission opportunities and can use the wireless medium for 300 ms. The new stream will have 60 transmission opportunities and can use the wireless medium for 600 ms.

As previously described, in various examples, the existing stream and the new stream are of different priorities. In this case the number of transmission opportunities won by the two streams will not be equal but will be higher for higher priority stream. The exact ratio can be computed based on the parameters for contention or can be looked up from a pre-determined table.

As previously described, in some examples, the existing stream and the new stream could be of different priorities and multiple levels of min-max fairness algorithm are used. The higher priority stream will win all the transmission opportunities that are demanded and the remaining will be distributed equally among the next priority of the streams. The multiple levels may be employed for multiple levels of priority. Within the same priority streams, another instance of min-max fairness can be executed favoring low stream users as explained earlier.

As previously described, in some examples, a waiting period before each transmission can be defined determining the transmission opportunities. The waiting period can be divided into pre-backoff (distributed coordination function interframe space (DIFS) and arbitration interframe space (AIFS)) time and actual backoff (down-counting of actual backoff slots) time. The pre-backoff time overhead is applied for every transmit opportunity win and backoff time overhead is applied once for a contention cycle. The idea is that the down-counting of backoff slots happens in parallel at all the transmitters.

A method at 640 includes estimating an achievable transmission rate by the transmitter based on the determined capabilities and the collected information.

A method at 650 includes estimating the capacity of the at least one wireless stream of the wireless link based on the estimated transmission opportunities and the estimated achievable transmission rate.

As previously described, some examples may include a sensor that collects the information of the wireless transmission. In some examples, the sensor is a specialized hardware. In some examples, the sensor is included in a motion-controlled mobile platform, the positioning of which is controlled to facilitate sensing. In some examples, the sensor is implemented as a software agent on existing network components (access points, stations, switches).

Some examples may include a motion-controlled device (such as, a robot or a drone) that is operable to sense signals (and is implemented as one of the previously described sensors) of a wireless network at multiple positionings of the motion-controlled device. At one or more of the positionings, the motion-controlled device is operable to receive wireless signals of the wireless network and support deployment or operation of the wireless network. In some examples, the sensed wireless signals provide at least a portion of the motion control of the motion-controlled device. In some examples, the motion-controlled device is activated on demand when an issue associated with the wireless network occurs, and senses information that is relevant to the issue.

In some examples, the motion-controlled device is operable to characterize an service area for pre-deployment analysis/planning of the wireless network. In some examples, the motion-controlled device is operable to determine how wireless signals propagate between a plurality of candidate locations for transceivers of the wireless network. In some examples, the motion-controlled device is operable to use optical sensors to determine whether a line-of-sight wireless connection is feasible between candidate locations for transceivers of the wireless network.

In some examples, the motion-controlled device is operable to characterize a deployed wireless network, and further operable to aid in diagnosing operation and/or performance of the deployed wireless network. In some examples, the motion-controlled device is operable to characterize a deployed wireless network, and further operable to aid in repairing, fixing and/or improving operation of the deployed wireless network. In some examples, the motion-controlled device is operable to monitor the wireless network continuously to detect performance and/or connectivity issues. In some examples, the motion-controlled device is operable to detect precursors of issues in the wireless network. That is, the motion-controlled device is operable to detect early warning signs of potential future issues.

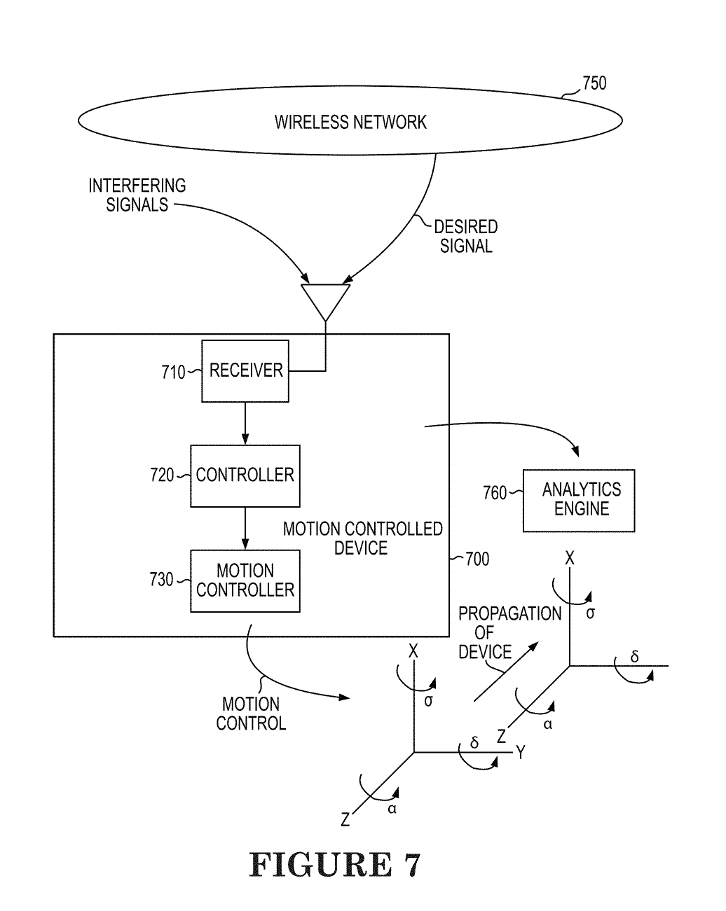

FIG. 7 shows a block diagram of a motion-controlled device that supports deployment and operation of a wireless network, according to the disclosure. The motion-controlled device 700 includes a receiver 710 operative to sense wireless communication signals of the wireless network 750 (which can be considered a target network). While depicted as a receiver 710, it is to be understood that the receiver 710 could be a part of a transceiver of the motion-controlled device 700. A motion controller 730 is operative to control a positioning of the motion-controlled device 700 in a plurality of dimensions. In various examples, the motion controller 730 includes a motion actuator. A controller 720 of the motion-controlled device 700 is operative to at least facilitate analysis of the sensed wireless communication signals (from the target network 750), and provide a control signal to the motion controller 720, wherein the control signal at least partially controls the positioning of the motion-controlled device 700 based on the sensed wireless communication signals.

As stated, the motion controller 730 controls positioning of the motion-controlled device 700. In some examples, the position control includes control of the location of the motion-controlled device 700. For example, the motion controller 720 can enable the motion-controlled device 700 to travel to multiple locations for receiving signals from or communicating with the wireless network 750, or communicating with other similar devices, for supporting deployment or operation of the wireless network 750. In some examples, the positioning control includes control of the orientation of the motion-controlled device 700. For example, the motion controller 720 can enable the motion-controlled device 700 to translationally and/or rotationally adjust the orientation of the motion-controlled device 700 to allow the motion-controlled device 700 to inspect and/or characterize features of the wireless network 750. In some examples, the position control includes control of the location and the orientation of the motion-controlled device 700. In some examples, the position control further includes control of positioning of a component of the motion-controlled device 700, for example an antenna or other sensors. The xyz axis of FIG. 7 shows possible adjustments in the positionings of the motion-controlled devices. That is, the positioning (which could include position or orientation of the device) can be adjusted in the x, y and z orientations, and rotated about any axis. Additionally, the x, y, z reference coordinates can change position over time. Further, a sensor or receiver of the motion-controlled device can be controlled in all of these positionings as well.

In some examples, the motion controller 730 may include mechanical means for controlling the positioning of the motion-controlled device 700. Many different implementations of the motion controller 730 are possible. In various examples, the motion controller 730 is implemented as a robot or drone that includes, for example, airborne vehicles such as helicopter, a multi-copter, a fixed-wing aircraft, or a ground-based wheeled vehicle, such as tracked or wheeled robots as well as wall or tower climbing vehicles and also water based vehicles that may operate on surface or below water.

FIG. 7 additionally includes an analytics engine 760. In various examples, the analytics engine 760 is included and operable within the motion-controlled device 700. In various examples, the analytics engine 760 is at least partially included within a server external to the motion-controlled device 700. If external, in various examples, at least a portion of information of the sensed communication signals is shared by the motion-controlled device 700 with the external server. That is, in various examples, the controller 720 is further operative to support communication with the analytics engine 760. In some examples, the communications link between the motion-controlled device 700 and analytics engine 760 is a separate communications link than the link supported by receiver 710 (or the transceiver 210 of FIG. 2). In some examples, the separate communications link may include a wireless link, a wired link, and optical fiber link.

Some examples may include a control loop in which the sensed communication signals are processed and used to control operation of at least some wireless devices associated with the wireless network 750. In some examples, the control loop includes the motion-controlled device 700 and/or the analytics engine 1550.

As described, the controller 720 of the motion-controlled device 700 is operative to at least facilitate analysis of the sensed wireless communication signals, and provide a control signal to the motion controller 720, wherein the control signal at least partially controls the positioning of the motion-controlled device 950 based on the sensed wireless communication signals.

In some examples, the controller 720 being operative to provide the control signal to the motion controller includes the controller determining a received signal quality parameter at the receiver 710 of a signal received from at least one terminal of the wireless network 750, and selecting the control signal to the motion controller 730 to reposition the motion-controlled device 700 to change the received signal quality parameter of the signal received from the at least one terminal of the wireless network 750. In some examples, control signal to the motion controller 730 is selected to reposition the motion-controlled device 700 to change (In various examples, the change increases) the received signal quality parameter of the signal received from the at least one of terminals of the wireless network 750, while maintaining a received signal quality parameter of at least one signal received from other terminals of the wireless network relative (either above or below) to a specified threshold. In various examples, the motion-controlled device 700 is repositioned to maximize (increase) the received signal strength of the signal (a desired signal) from one terminal of the wireless network, while ensuring that the received signal strength of the signal from another terminal (a second desired signal) remains above a specified threshold. In some examples, the motion-controlled device 700 is repositioned to maximize (increase) the received signal strength of the signal (a desired signal) from one terminal of the wireless network, while ensuring that the received signal strength of the signal from another terminal (an undesired interfering signal) remains below a specified threshold. In some examples, the motion-controlled device 700 is operative to move along the signal power gradient of a wireless signal that interferes with the wireless network, thus locating the signal source.

The motion control can be influenced by the motion-controlled device 700 a software agent operating on the motion-controlled device 700, the analytics engine 760, and/or an operator. That is, in various examples, motion control of the motion-controlled device 700 is at least partially controlled by the analytics engine 760. In various examples, motion control of the motion-controlled device 700 is at least partially controlled by an operator. In various examples, the operator is located in network operator control (NOC). In various examples, a fleet of drones is ready to be dispatched at NOC. In various examples, the operator is located in a vehicle, such as a van, wherein the drone is launched from the van. In various examples, the operator uses visual control/oversight of partially autonomous drone operation.

The sensing of the wireless signals can be influenced by the motion-controlled device 700, a software agent operating on the motion-controlled device 700, the analytics engine 760, and/or an operator. That is, in various examples, sensing of the wireless signals is at least partially controlled by the analytics engine. In various examples, sensing of the wireless signals is at least partially controlled by an operator. In various examples, the motion-controlled device 700 has two sensing modes: In a first mode, sensing of the wireless signals is used for maneuvering the device to a desired position with respect to the transceivers (wireless devices) of the wireless network, and comprises measuring received signal strengths. In a second mode, sensing of the wireless signals is used for diagnosing an issue associated with the wireless network, and comprises measuring received signal strengths, signal source identifiers, wireless protocol sequence information, wireless protocol traffic patterns. In some examples, the motion-controlled device switches between the two sensing modes repeatedly at the direction of the analytics engine 760. In some examples, the two modes of sensing are carried out simultaneously (hybrid mode). In various examples, the motion-controlled device 700 is equipped with additional sensors that are activated based on previously sensed wireless signals.

In various examples, the sensed wireless signals include signals transmitted from a first external transceiver to a second external transceiver, wherein the analysis of the sensed wireless communication signals comprises diagnosing an issue condition associated with signals transmitted from the first external transceiver to the second external transceiver. For example, in various examples, the motion-controlled device determines whether the received signal strength of the signals from the first external transceiver at the location of the second external transceiver exceeds a predetermined threshold. In some examples, the motion-controlled device determines an estimate of the number of distinct propagation paths of the signal transmitted from a first external transceiver to a second external transceiver. In some examples, the motion-controlled device determines a probability, over a predetermined period of time, of the signals transmitted from the first external transceiver to the second external transceiver being impaired by external interference.

As described, in some examples, the sensed signals are communication signals of the wireless network. Further, in some examples, the sensed wireless signals include signals interfering with communication within the wireless network.

In some examples, the motion-controlled device 700 is operative to modify or update a condition of a wireless device of the wireless network. In various examples, the update to the condition of the wireless device includes upgrading firmware of the wireless device. In various examples, the update to the condition of the wireless device includes reconfiguring, including for example, connecting the wireless device to a new/different access point. In various examples, the update to the condition of the wireless device includes replacing at least a portion of hardware of the wireless device. In various examples, the update to the condition of the wireless device includes repointing or redirecting an orientation of the wireless device or an antenna of the wireless device. In various examples, the wireless device includes a magnetic switch, and the update to the condition of the wireless device includes turning the wireless device on or off which reboots the wireless device. As will be described, in various examples, the motion-controlled device 700 physically interfaces through, for example, a docking mechanism, and the updates can be performed while the motion-controlled device 700 is docked to the wireless device.

In some examples, the sensed wireless signals include signals transmitted from a first external transceiver to a second external transceiver of the wireless network. That is, the motion-controlled device eavesdrops or listens (receives) wireless communication occurring within the wireless network. Further, the analysis of the sensed wireless communication signals includes diagnosing an issue condition associated with signals transmitted from the first external transceiver to the second external transceiver.

In some examples, the motion-controlled device is operative as a relay station within the wireless network. That is, the motion-controlled device itself becomes a part of the wireless network and aid at least one device of the wireless network to maintain a connection with the wireless network.

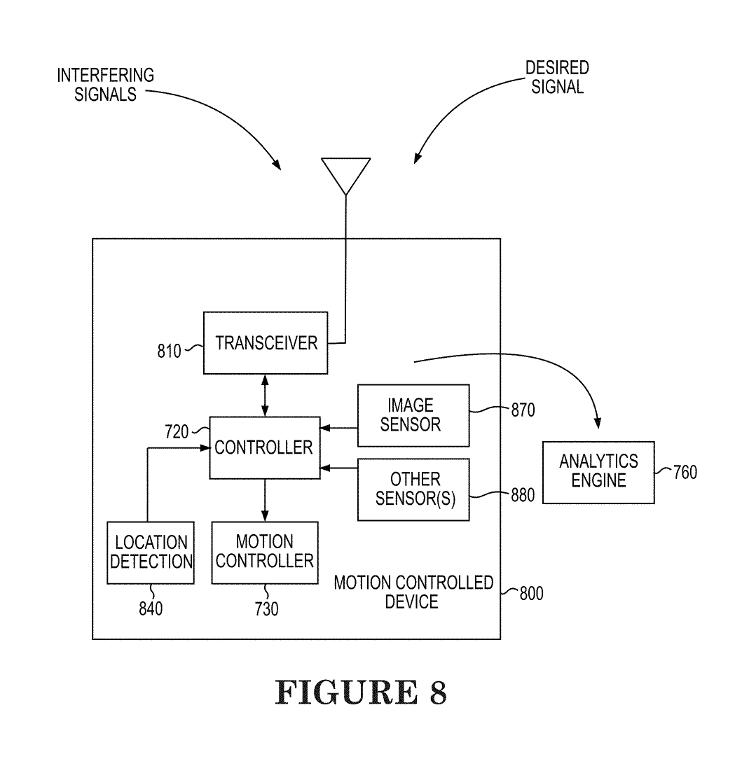

FIG. 8 shows another block diagram of a motion-controlled device 800 that supports deployment and operation of a wireless network, according to the disclosure. In this example, the receiver in included within a transceiver 810. In various examples, the transceiver 810 allows the motion-controlled device 800 to communication with wireless devices of, for example, the wireless network 750.

In some examples, the communication with the wireless device of the wireless network is through a second communication channel of the wireless device. For example, a first mode of communication within the wireless network could be an 802.11 (WiFi) wireless communication, whereas the communication between the motion-controlled device 800 and the wireless device could include cellular, Bluetooth and/or wired communication. In various examples, the motion-controlled device uses the second communication channel for its communication with the wireless device for purposes of robustness to failure of the first mode of communication. For example, in various examples, the motion-controlled device determines that the first communication channel is inoperative, and then falls back on the second communication channel. In some examples, the second communication channel exists for the purposes of secure communication with well-defined access control. For example, in various examples, the motion-controlled device determines that the first communication channel is not sufficiently secure for a particular type of information to be communicated, for example, a firmware upgrade, configuration update, etc., and then uses the second communication channel for this secure communication.

In some examples, the motion-controlled device is operable to control its positioning to maintain a distance from the wireless device that is below a predefined threshold (that is, the motion controller maintains the distance between the motion-controlled device and the wireless device to be within a threshold distance). Example second communication channels include near-field communication, short-distance networks, personal area networks (PAN). For example, this positioning control is implemented for the purpose of security by proximity. For another example, this positioning control is implemented for the purpose of maintaining a data transmission rate above a certain threshold via the first or second communication channel. Maintenance of the distance to within the threshold distance allows for the first or second channel to be established and maintained, enhances the security of the communication, and allows for a transmission data rate of communication through the first or second communication channel to be greater than a threshold.

In some examples, the communication with the wireless device of the wireless network includes the motion-controlled device receiving internal state information of the wireless device. In some examples, the internal state information includes one or more of transmitted packet count, received packet count, packet failure count, packet count per modulation and coding scheme (MCS), received signal strength, history of received signal strength, rate control state, protocol state, traffic profile information, history of traffic information, interfering signal state, event logs, environmental sensor state, operating system state, file system state, firmware state, and/or hardware state.

Further, the motion-controlled device 800 includes an image sensor 870 and/or other sensors 880. Although examples are not so limited, a list of possible sensors includes camera, a light sensor, power detector, thermal imaging/heat sensor, humidity sensor, and/or an image sensor.

In various examples, the sensor includes an image sensor 870, and the controller 720 is further operative to facilitate analysis of a wireless device of the wireless network based on at least one image generated by the image sensor. For example, in various examples, the at least one image is utilized to detect miss-pointing of an antenna of the wireless device, detect physical antenna damage.

Further, the controller 720 is operative to determine from at least one image generated by the image sensor an approximation of a quantity related to the wireless network, determine, based on the approximation of the quantity, whether to conduct a direct measurement of the quantity related to the wireless network, perform the direct measurement of the quantity related to the wireless network, and select the control signal to the motion controller to reposition the motion-controlled device to change the quantity towards a pre-specified target value.

In some examples, the approximation of the quantity related to the wireless network includes at least one of estimates of angles, distances, obstruction, line of sight, etc. In some examples, the direct measurement of the quantity related to the wireless network includes at least one of signal strength, interference level, connectivity matrix, etc. The direct measurement of the quantity may take long (for example, 8 seconds). Using the image sensor allows a targeting of the measure at positions that are promising.

Further, as shown in FIG. 8, the motion-controlled device 800 includes location detection 840. The location detection unit 840 allows for a determination of one or more locations of the motion-controlled device. In various examples, the sensed wireless communication signals of the wireless network are monitored or tracked along with the determined locations. In various examples, the location detection unit 840 includes at least one of a GPS receiver, a WiFi signature analysis, an accelerometer, a gyroscope a, magnetic sensor, other GPS-like triangulation systems etc.

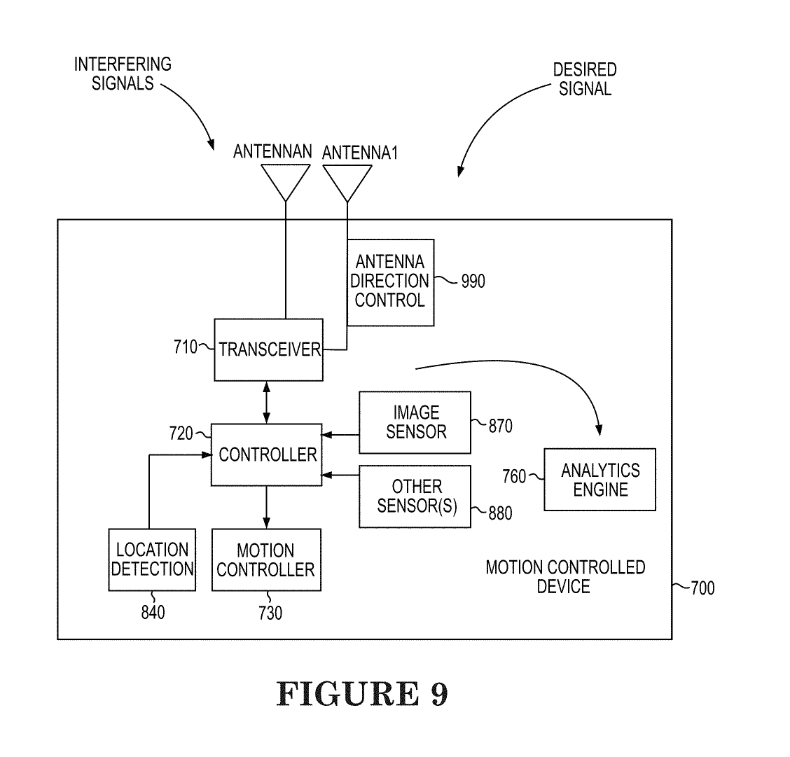

FIG. 9 shows another block diagram of a motion-controlled device that supports deployment and operation of a wireless network, according to the disclosure. This example includes at least one of a directional antenna (antenna1) wherein an actuator (antenna direction control 990) controls the direction of the directional antenna, or multiple antennas (antenna1-antennaN).

In various examples, the actuator 990 of the directional antenna is operable to control the directional antenna in as many as three dimensions. In various examples, the actuator 990 of the directional antenna includes motors that move the directional antenna to point in a predetermined direction. In some examples, the actuator 990 of the directional antenna is operable to vary the directional gain of the antenna. In some examples, the actuator 990 of the directional antenna is operable to ensure the directional antenna remains pointed at a predetermined target regardless of the positioning of the motion-controlled device 700.

It is to be understood that, n some examples, the actuator control can extend to other sensors of the motion-controlled device, such as image sensor 870 or other sensors 880. In various examples, the actuator control of the image sensor 870 can implement panoramic image acquisition. In some examples, multiple images taken from different image sensor positionings enable faster detection of issues in the wireless network.

As previously stated, in various examples, the motion-controlled device is operative to communicate with a wireless device of the wireless network. In various examples, based on directional pointing of the one or more antennas, the motion-controlled device is operative to determine desirable placements of to-be-deployed wireless devices of the wireless network. In various examples, the directional antenna includes the same design as the antenna in the to-be-deployed wireless device. In some examples, the directional antenna of the motion-controlled device 700 is an adaptive antenna that can be configured to behave as either one of a plurality of possible antenna designs in the to-be-deployed wireless device. In This example, sensing results from the motion-controlled device 700 help in choosing one of the plurality of possible antenna designs. In some examples, the motion-controlled device 700 records data that helps select among a plurality of different to-be-deployed wireless device designs.

In various examples, the motion-controlled device is operative to indicate desirable placement of the to-be-deployed wireless device by physically marking the position. For example, a roof-top may be marked to indicate a desired placement of an access point, or an antenna of a receiving device. This can include, for example, marking chalk on a roof tile, or marking a location with (washable) ink or chalk spray.

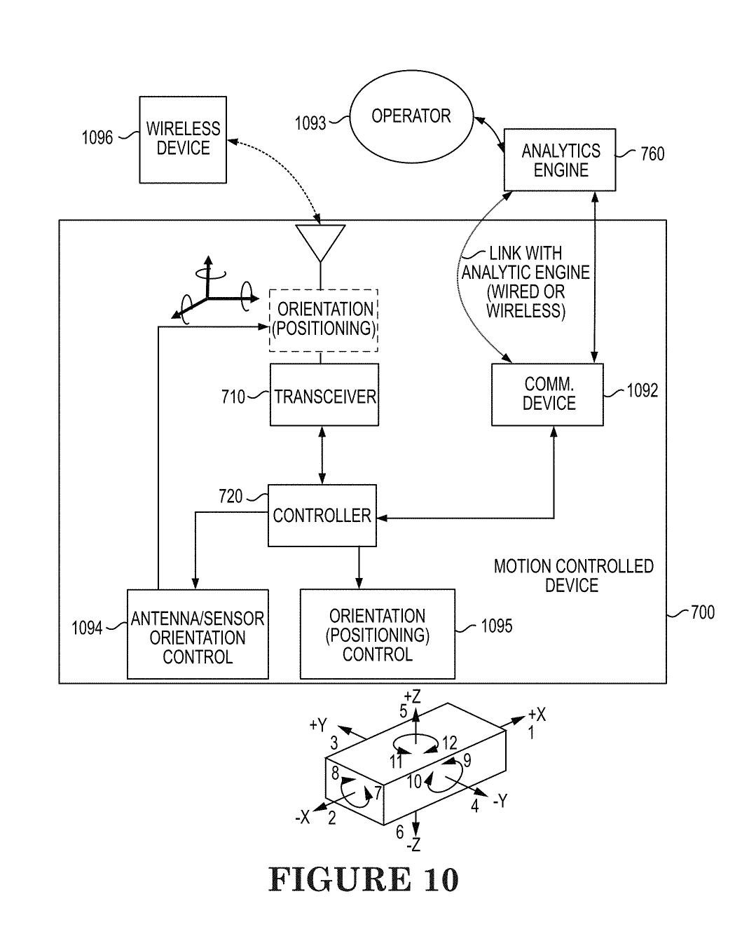

FIG. 10 shows another block diagram of a motion-controlled device 700 that supports deployment and operation of a wireless network, according to the disclosure. As previously described, this example includes the orientation (positioning) control 1095 that controls a positioning of the motion-controlled device 700. As previously described, this example includes the orientation (positioning) control 1094 that controls a positioning of the antenna of the motion-controlled device 700.

Examples illustrated in FIG. 10 further includes a communication device 1092 that supports a separate communication channel with the analytics engine 760, or at least a portion of the analytics engine 760. That is, separate from the communication channel between the motion-controlled device and the wireless device 1096 of the wireless network. As such, in various examples, the motion-controlled device 700 is operable to support a first communications channel with the wireless device 1096, and a second communications channel with at least a portion of the analytics engine 760. Further, in various examples, an operator 1093 interfaces with the analytics 760.

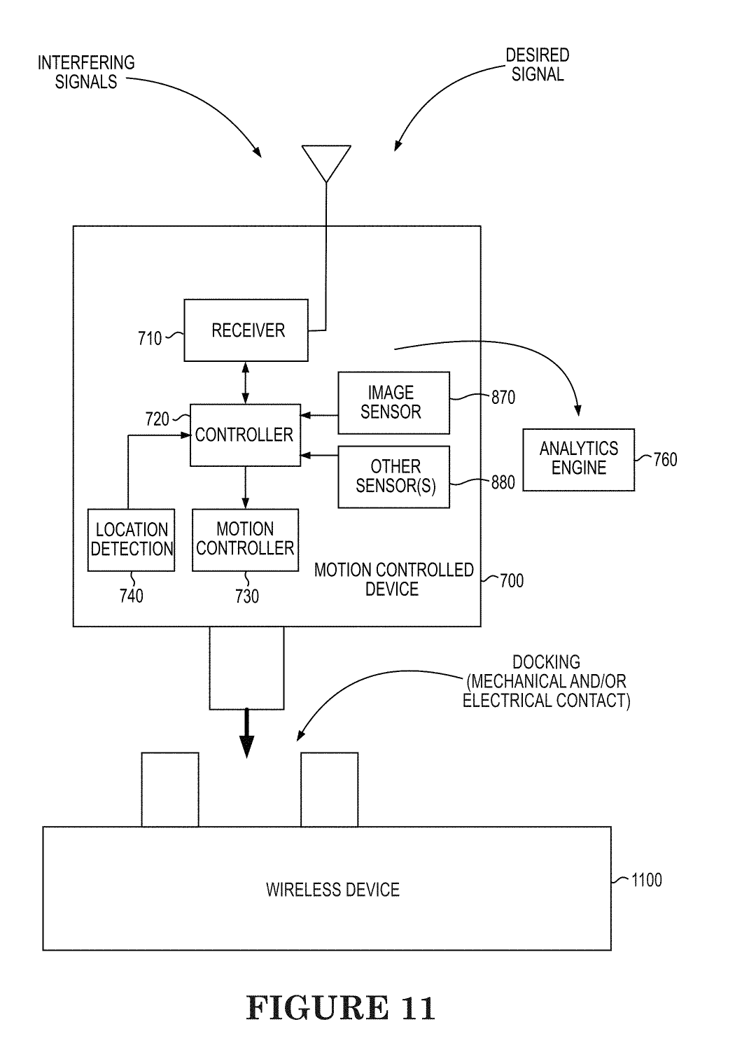

FIG. 11 shows a block diagram of a motion-controlled device 700 that supports deployment and operation of a wireless network that includes a docking mechanism, according to the disclosure. In various examples, the controller 720 and the motion controller 730 are further operative to dock the motion-controlled device 700 with a wireless device 1100 of the wireless network 750. Once physically docked with the wireless device 1100, the motion-controlled device 700 can extract at least some information from the wireless device 1100, or provide at least some information (which is secure) to the wireless device 1100. In various examples, once docked, the motion-controlled device 700 is operative to provide temporary replacement service (for example, drone stays in place until technician arrives). In various examples, once docked, the motion-controlled device 700 is operative to mechanically replace at least a part of the wireless device 1100.

In various examples, once docked, at least some information is communicated between the motion-controlled device and the wireless device through a mechanical/electrical connection that is established while the motion-controlled device is docked with the wireless device.

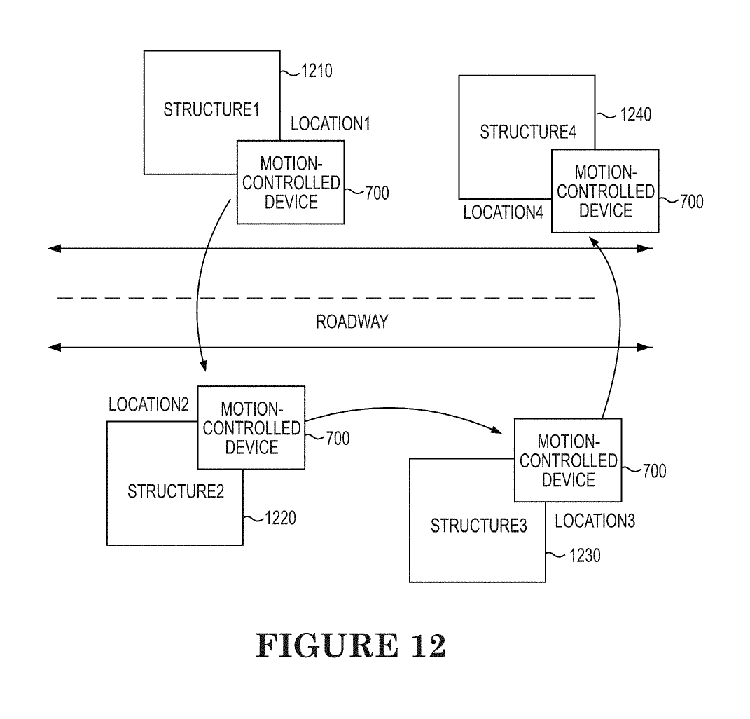

FIG. 12 shows a motion controlled device 700 at a sequence of locations of a wireless network, according to the disclosure. The sequence of locations can include, for example, visits to a first structure 1210, a second structure 1220, a third structure 1230, and a fourth structure 1240. As previously described, in various examples, a location detection unit (such as location determination unit 740) is operative to determine one or more physical locations of the motion-controlled device 700. Further, in various examples, the motion-controlled device 700 is operative to visit multiple locations, determine a physical location of the motion-controlled device 700 at each of the multiple locations, and measure a quantity of interest at each of the multiple locations and/or positionings of the motion-controlled device 700.

In various examples, at least one of the motion-controlled device 700 or the analytics engine 760 records the locations/measured quantities of interest. In various examples, the motion-controlled device 700 is operative to communicate the measured quantities of interest and corresponding locations to an analytics engine. In various examples, the measured quantities of interest include at least one of signal strength, wireless capacity, MIMO channel characteristics, and/or interference levels.

In some examples, the analytic engine 760 generates a map of the quantity of interest. In various examples, the map is a 2D (two-dimension) map that includes values of the quantity of interest at, for example, longitude (x), latitude (y). In various examples, the map is a 3D map that includes values of the quantity of interest at, for example, longitude (x), latitude (y) and elevation (z). In various examples, the map is greater than a 3D map and further includes an orientation of the motion-controlled device or an orientation of an antenna or sensor of the motion-controlled device. In various examples, the map is greater than a 6D map that further includes an orientation of the motion-controlled device and an orientation of an antenna or sensor of the motion-controlled device.

To optimize the travel of the motion-controlled device to any particular location of the wireless network, in various examples, the motion-controlled device is one of a plurality of devices, wherein each device of the plurality of devices is physically stored at an optimized location when inactive, wherein each point in the wireless network can be navigated to within a predetermined time by at least one of the plurality of devices.

Further, in various examples, the motion-controlled device is operative to follow a predefined measurement schedule when an issue associated with the wireless network is detected. Further, in various examples, the motion-controlled device is operative to determine desirable placements of to-be-deployed wireless devices of the wireless network.

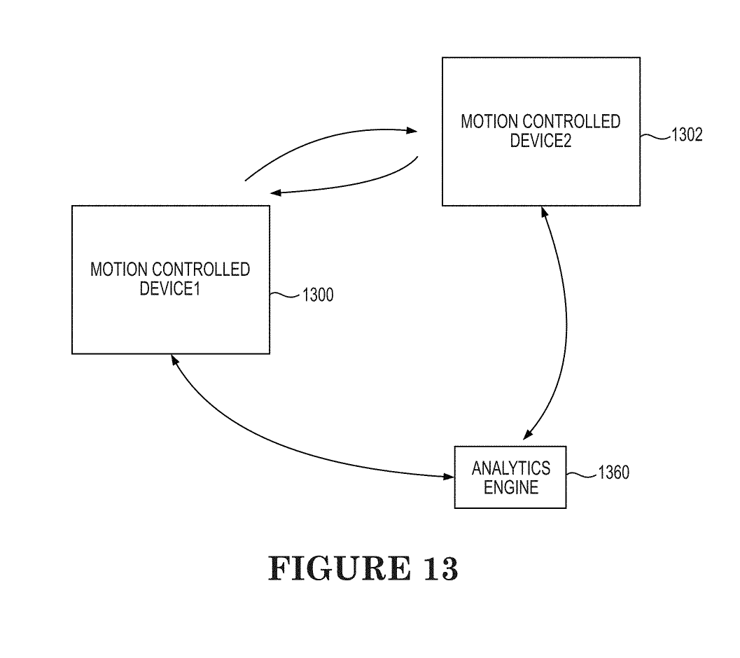

FIG. 13 shows a multiple motion-controlled devices 1300, 1302 that support deployment and operation of a wireless network, according to the disclosure. In various examples, the multiple motion-controlled devices 1300, 1302 are used in conjunction to characterize the wireless network. In various examples, motion between the motion-controlled devices 1300, 1302 is coordinated by an analytics engine that is communicating with each of the plurality of devices.

In various examples, at least some of the motion-controlled devices of the plurality of devices sensing wireless signals at overlapping time intervals. In some examples, a subset of motion-controlled devices of the plurality of devices are sensing wireless signals, while the remainder of the plurality is deployed as wireless network nodes in a predetermined fashion to generate a specific wireless network scenario of interest. For example, at least one motion-controlled device of the plurality of devices is configured as a network access point, while a second motion-controlled device of the plurality of devices senses the access point signal strength at various locations. If more than one motion-controlled device of the plurality of devices is configured as a network access point, this enables determining frequency reuse patterns and capacity coverage. In some examples, two motion-controlled devices of the plurality of motion-controlled devices act as wireless communication partners, while a third motion-controlled device of the plurality of devices transmits a predetermined interference signal from predetermined locations.

In various examples, the plurality of motion-controlled devices is coordinated by the analytics engine 1360. In some examples, the plurality of motion-controlled devices is coordinated by a distributed algorithm that runs on this plurality. For example, in various examples, two drones (wherein each drone is a motion-controlled device) act as communication partners, one drone connects to AP while the other drone creates interference. One drone acts as AP (located at candidate AP location) while other drone measures AP signal strength from multiple locations.

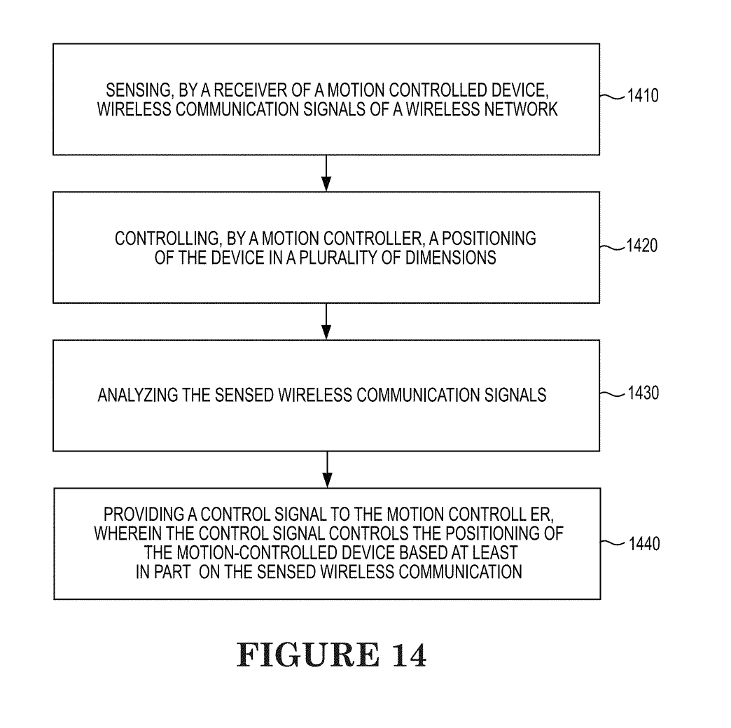

FIG. 14 is a flow chart that shows a method of supporting deployment and operation of a wireless network, according to the disclosure. A method at 1410 includes sensing, by a receiver of a motion-controlled device, wireless communication signals of a wireless network. A method at 1420 includes controlling, by a motion controller, a positioning of the motion-controlled device in a plurality of dimensions. A method at 1430 includes analyzing the sensed wireless communication signals. A method at 1440 includes providing a control signal to the motion controller, wherein the control signal controls the positioning of the motion-controlled device based at least in part on the sensed wireless communication signals.

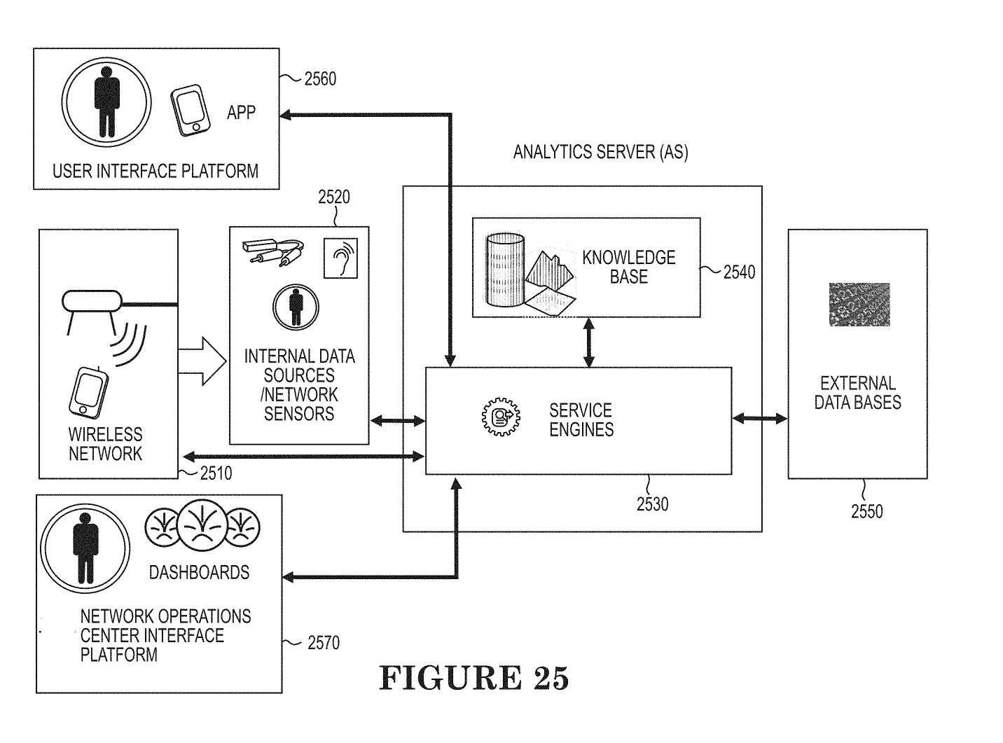

For the following described examples, the motion-controlled devices are implemented as, for example, the internal data sources and data sources 2520 of FIG. 25. Alternatively, or additionally, the motion-controlled devices are implemented as, for example, as at least a portion of the wireless network 2510. For example, in various examples, the motion-controlled devices operate as wireless devices or access nodes of the wireless network 2510. Alternatively, or additionally, the motion-controlled devices are implemented as, for example, as at least a portion of the service engines 2530. That is, in various examples, at least a portion of the service engines operate on one or more of the motion-controlled devices.

Some examples may an analytics engine that determines an issue exists by either receiving an indication that the issue exists, or by detecting that the issue exits. Some examples may include a “man-in-the-loop” which includes, for example, a user or a wireless network operator that provides additional input(s) and/or controls for the analytics engine. The analytics engine uses one or more of available resources to characterize the issue and provide actions for mitigating the issue.

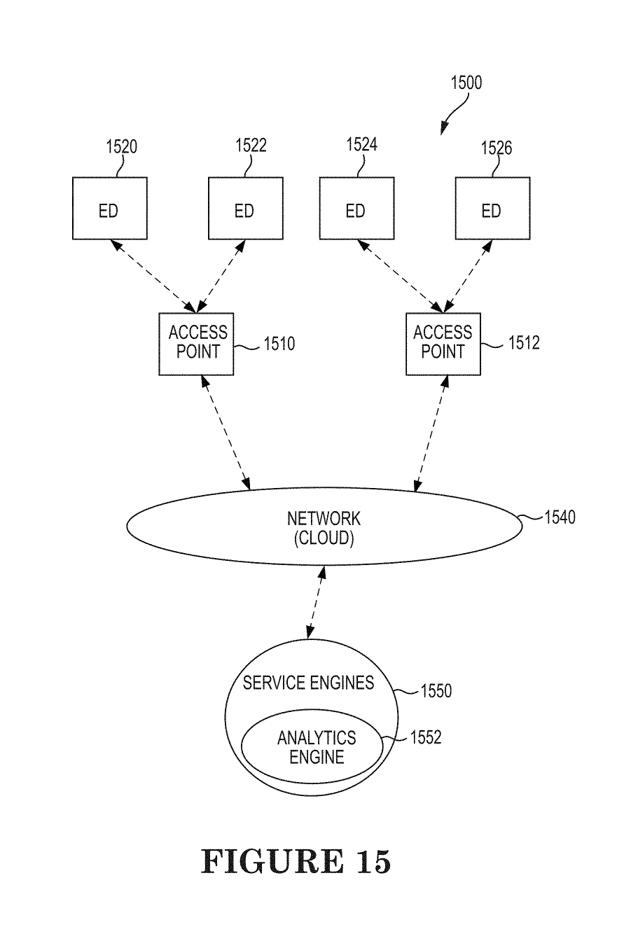

FIG. 15 shows a wireless network 1500 that includes an analytic engine 1552 operative to mitigate wireless networking issues, according to the disclosure. As shown, multiple end devices (ED(s)) 1520, 1522, 1524, 1526 are connected to a network 1540 through access points 1510, 1512. In some examples, the network 1540 provides a communication channel between service engines 1550 and the ED(s) 1520, 1522, 1524, 1526 and the access points 1510, 1512. In various examples, the service engines 1550 include the analytics engine 1552. While depicted as a single block, it is to be understood that the service engines 1550 and the analytics engine 1552 are functionally operating units that can be distributed amongst one or more servers or computers that are connectable to the network 1540. In some examples, one of the previously describe motion-controlled devices may be operational as at least one of the ED(s) 1520, 1522, 1524, 1526 or one of the access points 1510, 1512. Further, as previously described, in some examples, one of the previously describe motion-controlled devices may be operational as at least a portion of the analytics engine.

In some examples, the analytics engine 1552 is operative as a central intelligence for detection, analyzing, classifying, root-causing, or controlling the wireless network. In various examples, the analytics engine 1552 mitigates a wireless networking issue of a wireless network.

In various examples, the analytics engine 1552 determines an issue associated with the wireless network. Although examples are not so limited, wireless network issues include network performance, and/or network connectivity issues. In various examples, the issue associated with the wireless network is determined by the analytics engine detecting the existence of an issue based on the state information. In various examples, the issue associated with the wireless network is determined by the analytics engine receiving identification notification of the existence of the issue from a user of a wireless device (for example, end device 1520).

In various examples, the analytics engine 1552 receives collected user input(s) and state information. The collected user input(s) include, for example, answers by the user to multiple choice questions that relate to the nature of the wireless networking issue, numeric input, or binary input (for example, whether a suggested solution did indeed mitigate the issue).

The state information includes, for example, sensor information, or variables read from network elements (not originating from a physical sensor). In various examples, the state information includes the entirety of information available at the analytics engine about the network at a certain point of time. In various examples, the sensor information includes physical measurements. In various examples, the state information includes a protocol state, and other quantities that are not specifically measured, but already present in memory.

In various examples, the analytics engine 1552 maps a problem signature of the user input and the sensor information to at least one of a number of possible issues associated with network conditions. While the term “signature” is used in the described examples, it is to be understood that this term can be generally interpreted as one or more variables (sensed measurements, user inputs) that are related to the issue.

In various examples, the problem signature includes at least one of a wireless device type, a type of access point that the wireless device is connected or attempting to connect to, or a network type. In various examples, the problem signature includes the wireless network topology. In various examples, the problem signature includes configuration data of the access point.

In various examples, the problem signature includes a data traffic type. In various examples, the problem signature includes measured data traffic transmission rates. In various examples, the problem signature includes at least one of a deployment type, or applications that are currently in use in the network. In various examples, the problem signature includes a list of applications obtained from end device.

In some examples, mapping a problem signature of the user input and the sensor information with at least one of a number of possible issues associated with network conditions includes comparing features of the problem signature with issue characterizations stored in the knowledge database. As previously described, the term “signature” is to be understood generally as one or more variables (sensed measurements, user inputs) that are related to the issue.

In some examples, the mapping implements an inference, where the nature of the issue is inferred from the problem signature. In various examples, the mapping includes applying one or more decision models to the problem signature. In various examples, the decision models are constructed based on multiple previously observed problem signatures and the instructions that led to successful mitigation of the issues associated with the previously observed problem signatures. In various examples, the decision models include one or more partitions of the set of possible problem signatures to a finite number of subsets, wherein each of the subsets maps to a particular instruction. In various examples, the one or more partitions are specified by one or more of decision trees, closest neighbor mapping, table lookups, expert systems, probabilistic models of cause and effect.

In various examples, the mapping, decision models and/or partitions are constructed from multiple previously observed problem signatures and the instructions that led to their successful mitigation. In various examples, the previously observed problem signatures and the instructions that led to their successful mitigation originate from the same wireless network. In some examples, the previously observed problem signatures and the instructions that led to their successful mitigation originate from a plurality of wireless networks, wherein one of the plurality of networks is wireless network.

In various examples, the mapping, decision models and/or partitions are constructed by an optimization that enhances the probability of a successful issue mitigation. In various examples, the analytics engine 1552 determines instructions for alleviating the issue based on the mapping of the problem signature.

In various examples, the analytics engine provides the instructions. In various examples, the instructions includes actions that can be taken to mitigate of eliminate the effects of the issue. In some examples, the instructions in include one or more of device action, operator action, user action, operator action, and/or equipment update. Although examples are not so limited, device action includes a transmission channel change, a modification of a wireless transmission parameter, setting modulation and coding, and/or setting a MIMO (multiple-input, multiple-output) mode. Although examples are not so limited, user action includes changing a device location, changing an application setting and/or executing a test. Although examples are not so limited, operator action includes changing a device configuration, changing a network configuration, and/or rebooting a network component. Although examples are not so limited, equipment modification and update include adding an additional access point and/or repositioning an access point. It is to be understood that these list are limited to those examples as listed herein and that many other such actions may be utilized.

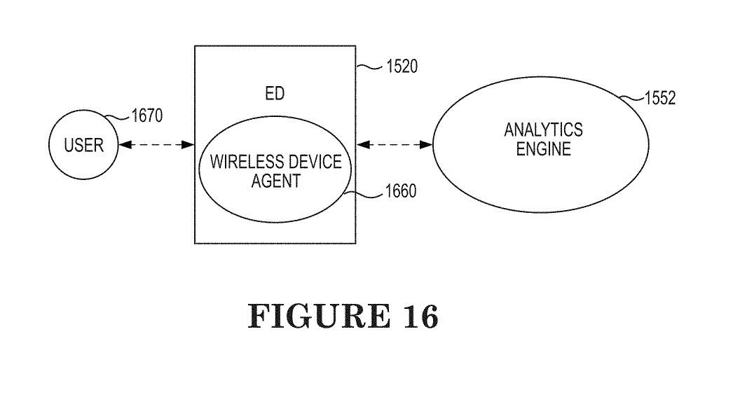

FIG. 16 shows an analytics engine 1552 interfaced with a wireless device agent 1660 of an end device 1520, according to the disclosure. In some examples, the analytics engine 1552 activates the wireless device agent 1660 of the end (wireless) device 1520. In some examples a communication channel is established between the wireless device agent 1660 and the analytics engine 1552, and wherein the wireless device agent 1660 is operative to interpret commands of a user 1670 of the wireless device 1520, display information to the user 1670, and interface with hardware operations of the wireless device 1520. Further, the wireless device agent 1660 collects the user inputs. Further, in some examples, the wireless device agent 1660 collects sensor information of the wireless device 1520. The user inputs and the collected sensor information is feedback to the analytics engine 1552, and can be used to diagnose and provide actions for mitigating the issue.

In some examples, the analytics engine 1552 provides the instructions to the wireless device agent 1660, and further the wireless device agent 1660 applies the instruction to mitigate the detected issue.

In some examples, the analytics engine 1552 provides the instructions to the wireless device agent 1660, and further the wireless device agent 1660 initiates an action based on the instruction, thereby enabling additional analysis of the issue. That is, the information (user inputs and sensed information) can be used to generate instructions. The instructions can include actions for mitigating the issue, or for providing additional information for diagnosing the issue. That is, mitigating the issue can include an iterative process of analyzing collected and sensed information, taking action, collecting information after taking action, and then preforming further analysis. The result of taking action in a previous iteration is used in the generation of the instructions for an issue mitigation in subsequent iterations.

Some examples include the wireless device agent 1660 communicating the instruction to a user of the wireless device 1520, thereby allowing the user to implement the instruction. Further, in some examples, the analytics engine provides the instructions to the wireless device agent, and further comprising the wireless device agent 1660 communicating an action to be performed by the user, thereby enabling additional analysis of the issue.

In Some examples, the wireless device agent 1660 is an application that runs on the end device 1520. In Some examples, the wireless device agent 1660 runs in a web browser. In Some examples, the wireless device agent 1660 is part of device driver in the end device 1520. In Some examples, the wireless device agent 1660 is part of the operating system of the end device 1520.

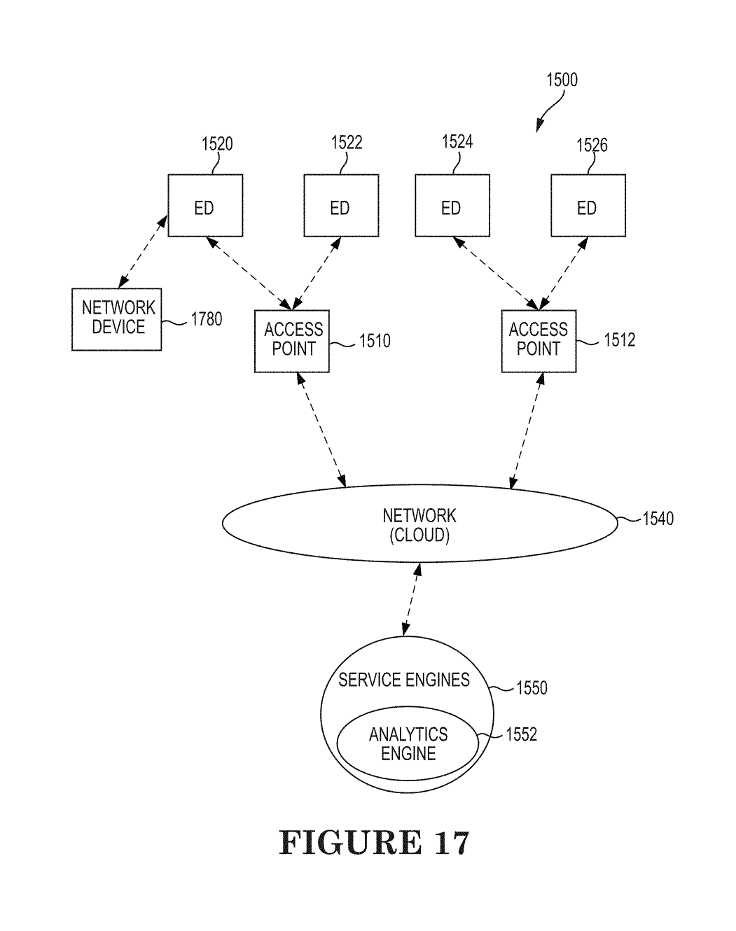

FIG. 17 shows a wireless network that includes an analytic engine 1552 and a network device 1780 operative to assist mitigation of wireless networking issues, according to the disclosure. In some examples, the network device includes a separate device that provides additional information that can be used for determining the existence of the issue and for diagnosing the issue. Further, network device can be utilized for mitigating the effects of the issue. In various examples, the network device 1780 includes at least one of the previously described motion-controlled devices.

Some examples may include the analytics engine 1552 receiving information from the network device 1780. As shown in FIG. 17, the analytics engine 1552 receives information from the network device 1780 through the wireless device agent. That is, the network device 1780 is connected to the end device 1520. The end device 1520 includes a wireless device agent that communicates the information of the network device 1780 to the analytics engine 1552 through, for example, the access point 1510 and the network 1540. That is, in various examples, the wireless device agent receives inputs or sense information from the network device 1780, which is communicated to the analytics engine 1552.

In various examples, a network device agent of the network device 1780 is operative to interpret commands of a user of the wireless device (ED 1520). In various examples, the network device agent of the network device 1780 is operative to convey information to the user, for example through a display or a visual indicator located on the network device 1780.

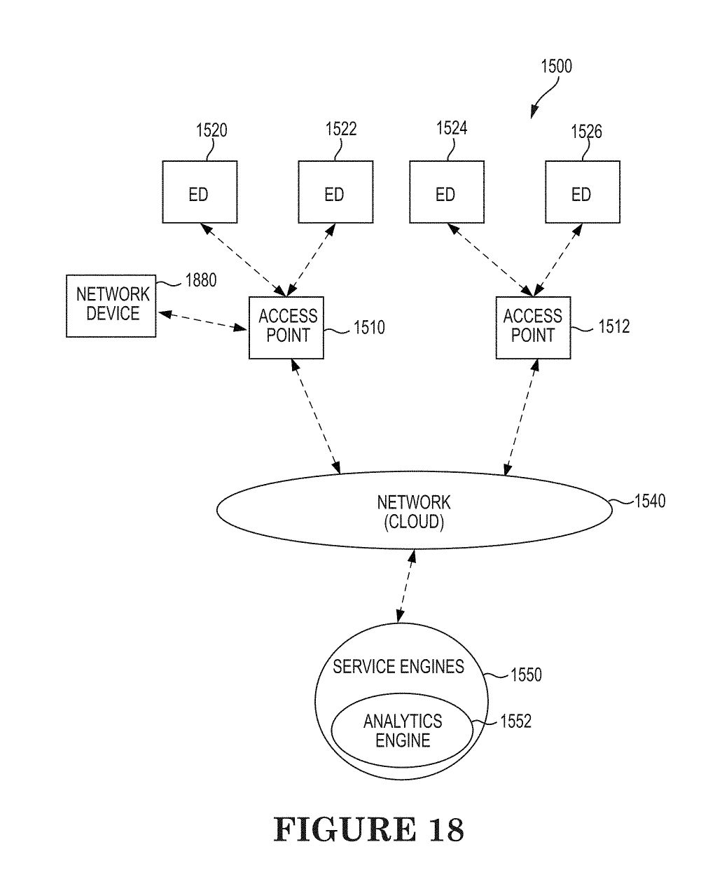

FIG. 18 shows a wireless network that includes an analytic engine 1552 and a network device 1880 operative to assist mitigation of wireless networking issues, according to the disclosure. While the network device 1180 of FIG. 11 communicated with the wireless device agent of the end device 1520, the network device 1880 communicates directly with the network 1540 through, for example, the access point 1510. In various examples, the network device 1880 includes at least one of the previously described motion-controlled devices. In various examples, the network device 1880 is a device that is operative to collect sensor information about the wireless network and transmit the sensor information to the analytics engine 1552 for inclusion in the problem signature. In some examples, the network device 1880 is embedded in existing components of the network, for example access points, access point controllers, routers, or switches.

In various examples, the network device 1880 is operable to assist in determining whether a determined issue is located between the end device 1520 and the access point 1510, or between the access point 1510 and the network 1540. That is, the network device 1880 is operable to bisect the issue located between the wireless device (ED 1520) and the network 1540. That is, is the issue located between the wireless device (ED 1520) and the access point 1510, or between the access point 1510 and the network 1540.

In some examples, the bisection is performed by temporarily providing a second channel between the end device 1520 and the network 1540 via the network device 1880. If the second channel between the end device 1520 and the network 1540 is operative, it can be concluded that the original issue is located between the end device 1520 and the access point 1510, as opposed to between the access point 1510 and the network 1540. If it is not operative, it can be concluded that the original issue is located between the access point 1510 and the network 1540.

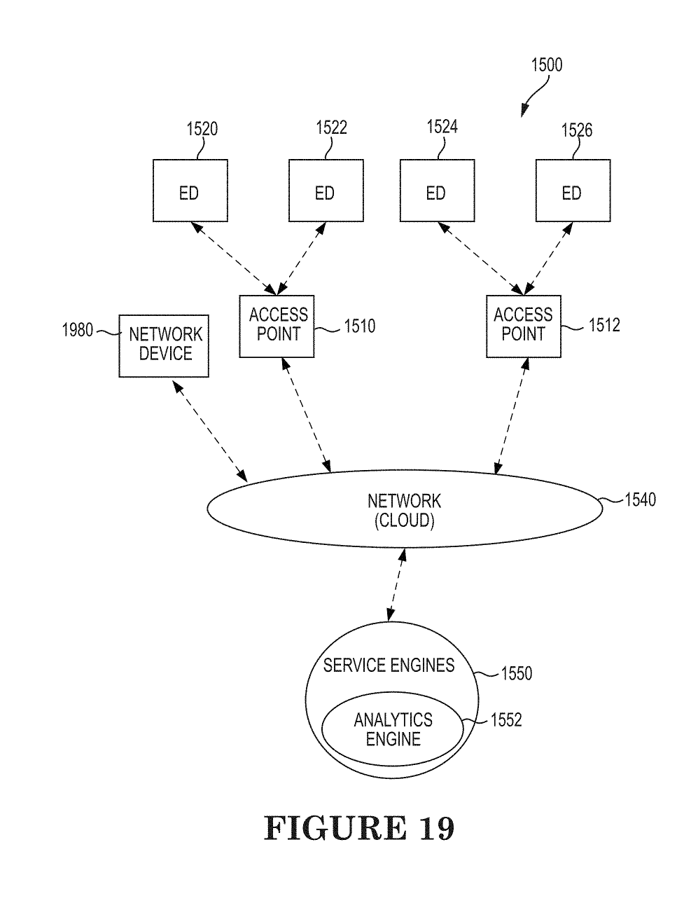

FIG. 19 shows a wireless network that includes an analytic engine 1552 and a network device 1980 operative to assist in mitigating wireless networking issues, according to the disclosure. Some examples may include activating a network device agent of the network device 1980. In various examples, the network device agent of the network device 1980 is operative to interpret commands of a user and display information to the user, wherein the user can be a network operator. In various examples, a communication channel is established between the network device agent and the analytics engine 1552. In various examples, the network device 1980 includes at least one of the previously described motion-controlled devices.

In some examples, the network device agent of the network device 1980 is operative to collect the user inputs, select a wireless device from the wireless network based on the previously determined issue in the wireless network, and collect state information that includes information from the wireless device. In some examples, the selection is based on one or more of the issue, the structure the wireless network, and other state information. In some examples, the wireless device is selected because the wireless device is affected by the issue.

In various examples, the state information includes information of the wireless device. In various examples, the state information includes information of other devices that are at least one of within a proximate vicinity of the wireless device or includes at least a threshold number of common characteristics. In various examples, the state information includes inputs of a user of the wireless device. In various examples, the state information includes global knowledge of a Network Operations Center (NOC). In various examples, the state information includes inputs collected from a second user. In various examples, the state information includes collected network state information from other sources than the wireless device (from other devices in the vicinity, of similar type).

In some examples, the analytics engine 1552 provides the instructions to the network device agent of the network device 1980. Further, in various examples, the network device agent applies the instruction to mitigate the detected issue. In various examples, the network device agent initiates an action based on the instruction, thereby enabling additional analysis of the issue. In various examples, the network device agent communicates an action to be performed by the user (network operator), thereby enabling additional analysis of the issue. The result of taking action in a previous iteration will inform the instructions for issue mitigation in subsequent iterations.

While each of the network device 1780, 1880, 1980 is similarly designated as a “network device”, it is to be understood that each may operate similarly or differently than the others.

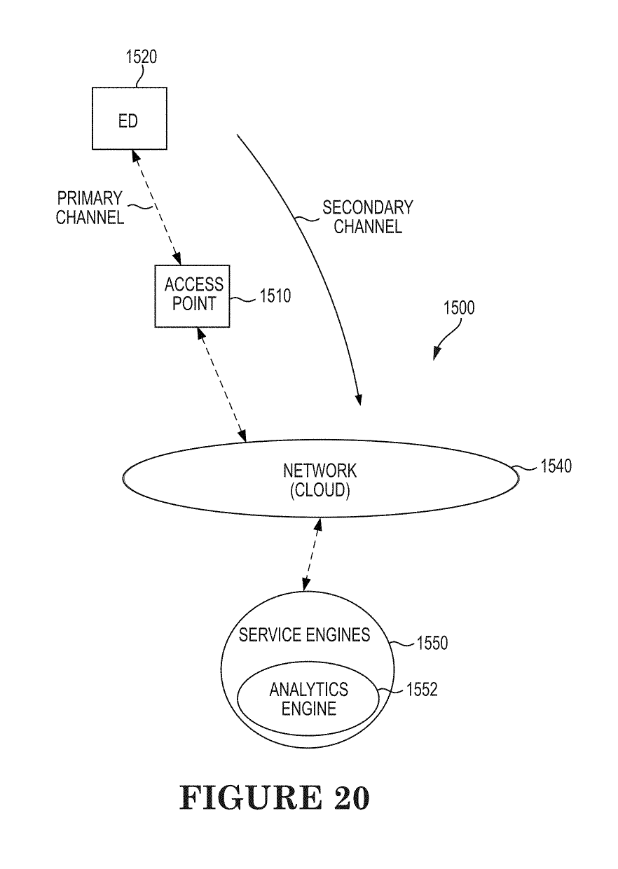

FIG. 20 shows an end device that is interfaced with a network through first channel and a second channel, according to the disclosure. The second channel provides the analytics engine 1552 a way to communicate with the wireless device agent if the first channel is inoperative, compromised, operating below a predetermined threshold, or undesirable for some other reason. For example, the second channel can be used by the wireless device agent to indicate to the analytics engine that the wireless device cannot communicate through the first channel. In various examples, the second channel is provided by a separate network. More specifically, in various examples, the first channel is provided by a WiFi network, while the second channel is provided by a cellular wireless network.

In various examples, the first channel is operative to support an application of the user, while the second channel is operative to aid diagnosis of the issue. That is, for example, if the first channel is currently used for an application that the user is running, a diagnosis function of the analytics engine will use second channel so as not to further impair the first channel.

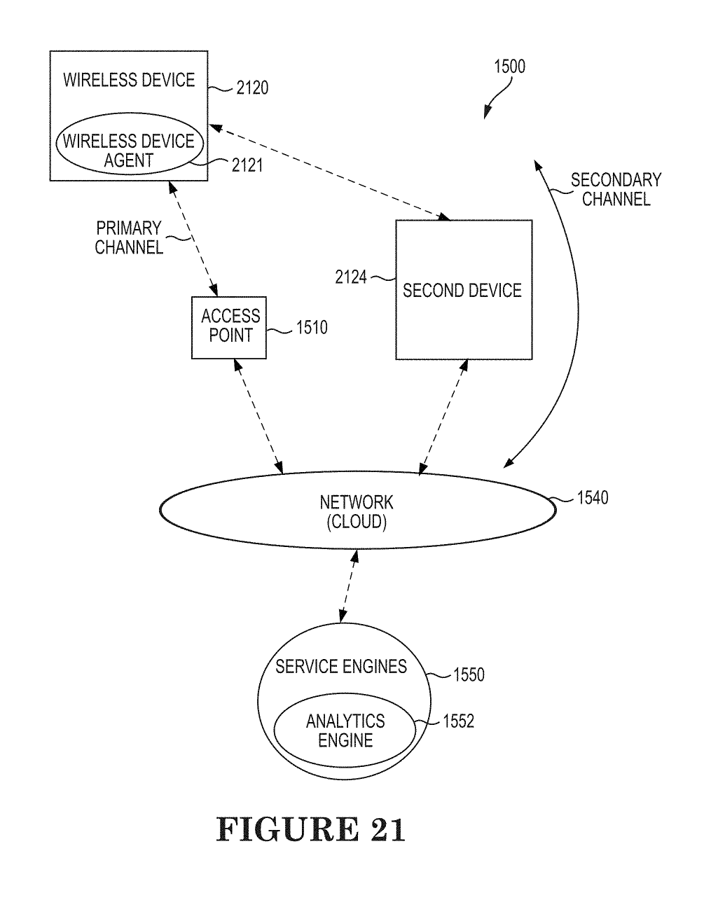

FIG. 21 shows a wireless device 2120 that is interfaced with a network 1540 through a first channel, and through a second channel provided by a second device 2124, according to the disclosure. Examples illustrated in FIG. 21 may be similar to the examples illustrated in FIG. 20, wherein the second device 2124 provides the second channel. The wireless device 2120 includes a wireless device agent 2121 that operative in conjunction with the analytics engine 1552 to mitigate the effects of identified wireless networking issues. In various examples, the network device 2120 includes at least one of the previously described motion-controlled devices.

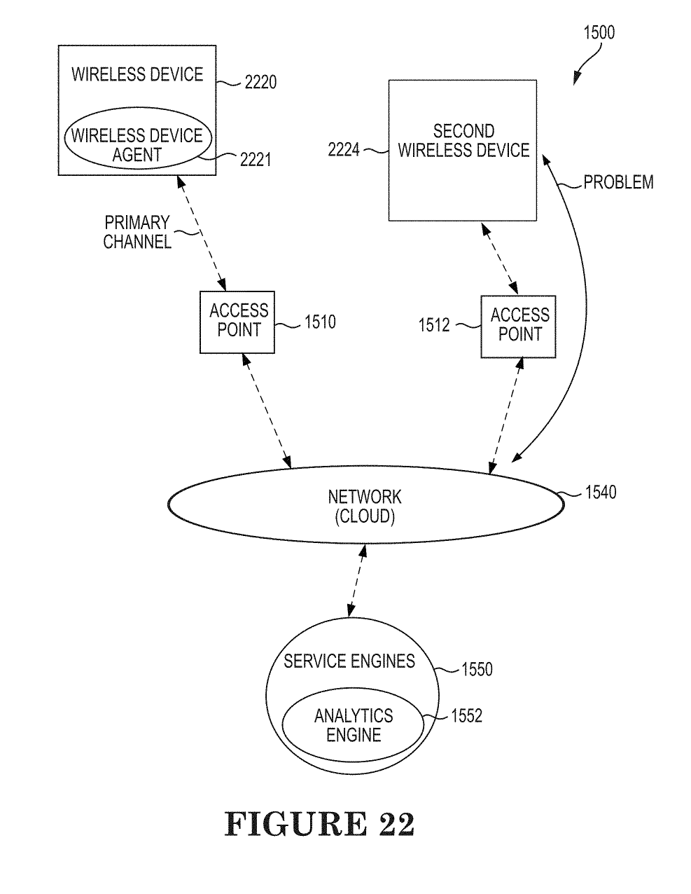

FIG. 22 shows an analytics engine 1552 operative to allow a wireless device 2220 to facilitate mitigating a wireless network issue of a second wireless device 2224, according to the disclosure. That is, in various examples, the issue includes a network issue between the second wireless device 2224 and the network 1540, and the second wireless device 2224 has the issue to be diagnosed, and hopefully mitigated. For example, the second wireless device 2224 may include a printer that has a connection issue, and the wireless device 2220 is a mobile phone of the user that is being used to diagnose the connection issue of the second device 2224 (the printer). In various examples, the wireless device 2220 (and wireless device agent) is a diagnosis device used by a field technician. In various examples, the network device 2220 includes at least one of the previously described motion-controlled devices.

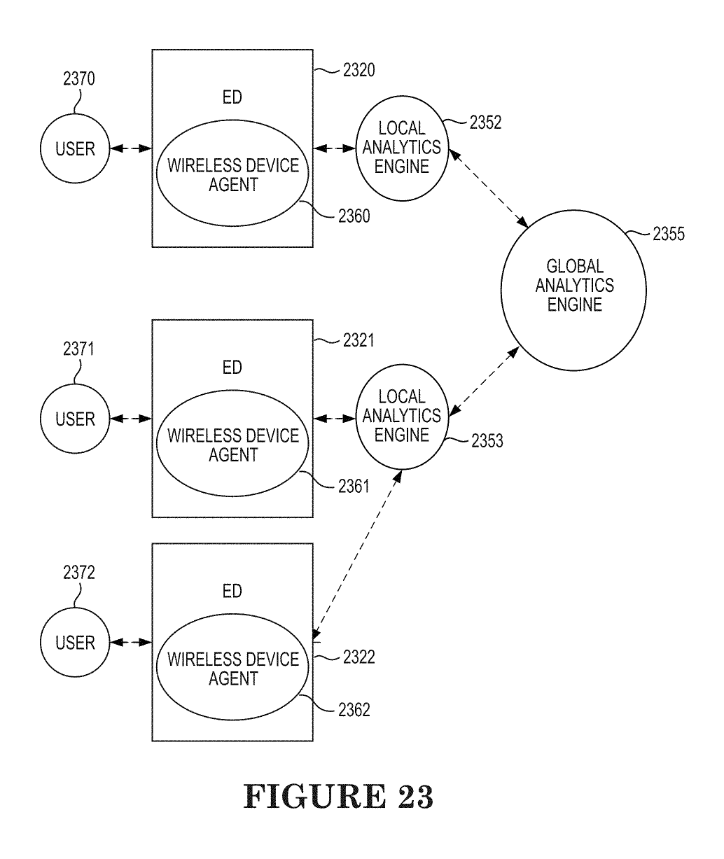

FIG. 23 shows multiple wireless devices 2320, 2321, 2322 (that include wireless device agents 2360, 2361, 2362) that are interfaced with corresponding local analytic engines 2352, 2353 and a global analytic engine 2355, according to the disclosure. In various examples, the local analytics engines 2352, 2353 are operable to process all of the collected user input (from users 2370, 2371, 2372) and the state information. This information can include sensitive information that user(s) may want control for privacy reasons. As shown, the local analytics engine 2353 is operable to server multiple wireless devices 2321, 2322 and multiple users 2371, 2372. For example, the local analytics engine 2352 may be running on the end device 2320 while the local analytics engine 2353 may be running on an on-premises computer. In some examples, at least one of the wireless devices 2320, 2321, 2322 includes a previously described motion-controlled device.

In various examples, the global analytics engine 2355 is operable to process a subset of the collected user input and the state information. The subset includes, for example, non-secure information, while not including privacy-sensitive information. While the global analytics engine 2355 works with a subset of information, the global analytics engine 2355 has the benefit of having access to information from multiple sources (from, for example, multiple wireless device agents). Therefore, the global analytics engine 2355 can make inferences across different networks. In some examples, each local analytics engine 2352, 2353 is located in a customer's network. In some examples, the global analytics engine 2355 provides inference across customers, wherein a local analytics engine is associated with each of the customers.

In some examples, the analytics engine includes a plurality of local analytics engines and a global analytics engine, wherein each of the plurality of local analytics engines is operable to process the collected user input and the state information corresponding to its associated devices, and wherein the global analytics engine is operable to process a subset of the collected user input and the state information of each local analytics engine, jointly across all local analytics engines.

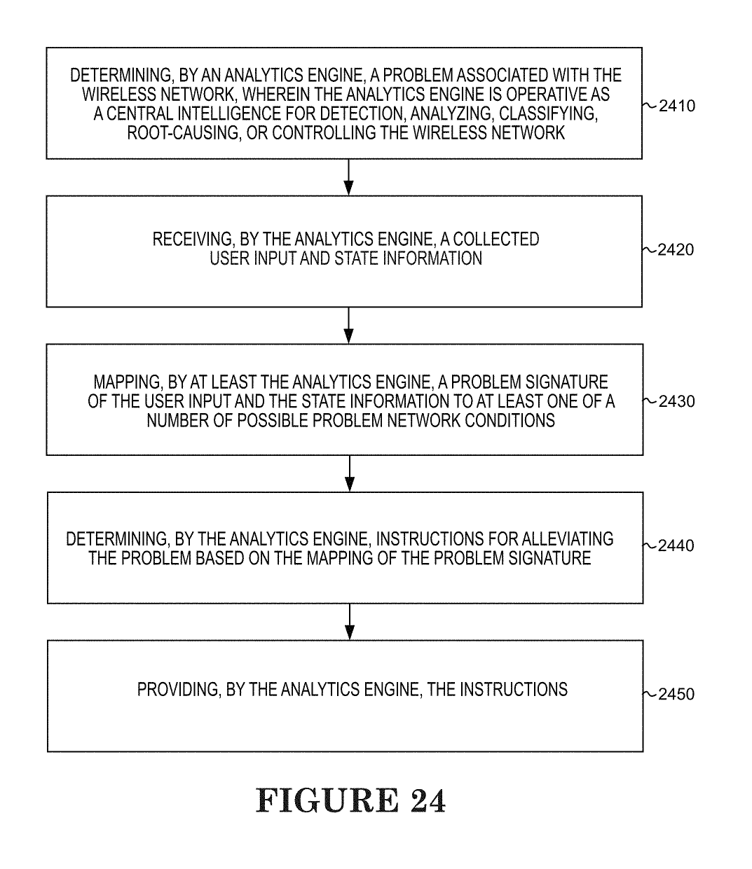

FIG. 24 is a flow chart that includes a method of mitigating an issue associated with a wireless mesh network, according to the disclosure. A method at 2410 includes determining, by an analytics engine, an issue associated with the wireless network, wherein the analytics engine is operative as a central intelligence for detection, analyzing, classifying, root-causing, or controlling the wireless network. A method at 2420 includes receiving, by the analytics engine, a collected user input and state information. A method at 2430 includes mapping, by at least the analytics engine, a problem signature of the user input and the state information to at least one of a number of possible issues associated with network conditions. A method at 2440 includes determining, by the analytics engine, instructions for alleviating the issue based on the mapping of the problem signature. A method at 2450 includes providing, by the analytics engine, the instructions.

As previously described, in some examples, the collected user input(s) include, for example, answers to multiple choice questions that relate to the nature of the wireless networking issue, numeric input, or binary input (for example, whether a suggested solution did indeed mitigate the issue). As previously described, in some examples, the state information includes the entirety of information available at the analytics engine about the network at a certain point of time. In various examples, the state information includes sensor information. In various examples, the sensor information includes physical measurements. In various examples, the state information includes a protocol state, other things that are not specifically measured, but already present in memory.

As previously described, some examples further include activating an wireless device agent of a wireless device, wherein a communication channel is established between the wireless device agent and the analytics engine, and wherein the wireless device agent is operative to interpret commands of a user of the wireless device, display information to the user, interface with hardware operations of the wireless device. The wireless device agent is operative to collect the user inputs and at least a portion of the state information of the wireless device.

As previously described, in various examples, the analytics engine provides the instructions to the wireless device agent, and further the wireless device agent applies the instruction to mitigate the detected issue. In various examples, the agent initiates an action based on the instruction, thereby enabling additional analysis of the issue.

As previously described, in various examples, the wireless device agent communicates the instruction to a user of the wireless device, thereby allowing the user to implement the instruction. In various examples, the analytics engine provides the instructions to the wireless device agent, and the wireless device agent communicates an action to be performed by the user, thereby enabling additional analysis of the issue.

The instructions can include actions for mitigating the issue, or for providing additional information for diagnosing the issue. That is, mitigating the issue can include an iterative process of analyzing collected and sensed information, taking action, collecting information after taking action, and then preforming further analysis. The result of taking action in a previous iteration is used in the generation of the instructions for issue mitigation in subsequent iterations.

As previously described, in various examples, the communication channel includes a first channel and a second channel, and wherein the wireless device agent communicates with the analytics engine through the second channel when the first channel is operating below a predetermined threshold, or undesirable for other reason.

As previously described, in various examples, the communication channel includes a first channel and a second channel, wherein the first channel is operative to support an application of the user, while the second channel is operative to aid diagnosis of the issue. For example, the first channel may be currently used for an application that the user is running, and the diagnosis function of the analytics engine will use second channel so as not to further impair the first channel.

As previously described, in various examples, the analytics engine receives information from a network device, and the wireless device agent receives inputs or sense information from the network device. In various examples, network device communicates with the wireless device agent, but not to the analytics engine. In various examples, the analytics engine may still receive information from the network device, but through the wireless device agent. As previously described, the network device can assist in bisecting the issue located between the wireless device and the network. That is, whether the issue located between the wireless device and an access node, or between the access node and the network.

In various examples, the network device is operational to provide the communication channel between the wireless device and the analytics engine. That is, the network device acts as a relay for the linking between the wireless device agent and analytics engine. Further, in various examples, the network device helps in diagnosing the problem. For example, the network device may be a wireless probe or another access point. Further, in various examples, the network device is second device is polled in by the wireless device agent or by the analytic engine.

As previously described, some examples further include activating a network device agent of a network device, wherein a communication channel is established between the network device agent and the analytics engine, and wherein the network device agent is operative to interpret commands of a user of the network device and display information to the user. Further, these examples further include collecting, by the network device agent, the user inputs, selecting a wireless device from the wireless network based on the previously determined issue in the wireless network, and collecting, by the network device agent, at least a portion of the state information that includes information from the wireless device. As previously described, in various examples, the selection is based on one or more of the issue, the structure the wireless network, and other state information. In some examples, the wireless device is selected because it is affected by the issue.

As previously described, in various examples, the state information includes information of the wireless device. As previously described, in various examples, the state information includes information of other devices that are at least one of within a proximate vicinity of the wireless device or includes at least a threshold number of common characteristics. As previously described, in various examples, the state information includes inputs of a user of the wireless device. As previously described, in various examples, the state information includes global knowledge of the NOC. As previously described, in various examples, the analytics engine provides the instructions to the network device agent, and further comprising the network device agent applying the instruction to mitigate the detected issue. In various examples, the network device agent initiates an action based on the instruction, thereby enabling additional analysis of the issue. In various examples, the network device agent communicates an action to be performed by the user, thereby enabling additional analysis of the issue.

As previously described, in various examples the issue includes a network issue between a second wireless device and the network. That is, for example, the second device has the issue to be diagnosed and mitigated. For example, the second wireless device may be a printer that has a connection issue, and the wireless device is a mobile phone of the user that is being used to diagnose the connection issue of the second device (the printer).

As previously described, in various examples, the second device receives the instructions from the from the analytics engine. As previously described, in various examples the second device acts as relay for wireless device.

As previously described, in various examples the problem signature includes at least one of a wireless device type, a type of access point that the wireless device is connected or attempting to connect to, a network type. In various examples, the problem signature includes the wireless network topology. In various examples, the problem signature includes configuration data of the access point.

As previously described, in various examples the problem signature includes a data traffic type. In various examples, the problem signature includes measured data traffic transmission rates.

As previously described, in various examples the problem signature includes at least one of a deployment type, or applications that are currently in use in the network. In various examples, the problem signature includes a list of applications obtained from end device.

As previously described, in various examples mapping the problem signature of the user input and the sensor information with at least one of a number of possible issues associated with network conditions includes comparing features of the problem signature with issue characterizations stored in a knowledge database. As previously described, the term “signature” is to be understood generally as one or more variables (sensed measurements, user inputs) that are related to the issue.

As previously described, in some examples, the mapping implements an inference, where the nature of the issue is inferred from the problem signature. In various examples, the mapping includes applying one or more decision models to the problem signature. In various examples, the decision models are constructed based on multiple previously observed problem signatures and the instructions that led to successful mitigation of the issues associated with the previously observed problem signatures. In various examples, the decision models include one or more partitions of the set of possible problem signatures to a finite number of subsets, wherein each of the subsets maps to a particular instruction. In various examples, the one or more partitions are specified by one or more of decision trees, closest neighbor mapping, table lookups, expert systems, probabilistic models of cause and effect.

In various examples, the mapping, decision models and/or partitions are constructed from multiple previously observed problem signatures and the instructions that led to their successful mitigation. In various examples, the previously observed problem signatures and the instructions that led to their successful mitigation originate from the same wireless network. In some examples, the previously observed problem signatures and the instructions that led to their successful mitigation originate from a plurality of wireless networks that includes the same wireless network.

In various examples, the mapping, decision models and/or partitions are constructed by an optimization that enhances the probability of successful issue mitigation. In some examples, the analytics engine receives second state information from a network device, and wherein matching the problem signature additionally includes matching the second state information received from the network device.

As previously described, in various examples the analytics engine includes a local analytics engine and a global analytics engine, wherein the local analytics engine is operable to process all of the collected user input and the state information, and wherein the global analytics engine is operable to process a subset of the collected user input and the state information.

In some examples, while the global analytics engine works with a subset of information, the global analytics engine has the benefit of having access to information from multiple sources (multiple local analytics engines). Therefore, the global analytics engine can make inferences across different networks. In some examples, each local analytics engine is located in a customer's network. In some examples, the global analytics engine provides inference across customers, wherein a local analytics engine is associated with each of the customers.

As previously described, in some examples, the analytics engine includes a plurality of local analytics engines and a global analytics engine, wherein each of the plurality of local analytics engines is operable to process the collected user input and the state information corresponding to its associated devices, and wherein the global analytics engine is operable to process a subset of the collected user input and the state information of each local analytics engine, jointly across all local analytics engines.

Some examples for addressing issues in wireless network include sensing a variety of information directly or indirectly related to the wireless network, building comprehensive models of the wireless network, and then exploiting these models to derive anomaly reports, issue diagnosis and recommended changes to network settings. Implemented through automatic control or through man-in-the-loop interventions, these outcomes can be used to improve both user experience and operator costs. In some examples, the sensing function is broad and includes wireless sensors that work in-band to the target network, wired sensors that tap data at various end points in the wired segments of network and other sensors such as imaging sensor, occupancy sensor, audio sensor, other radio sensor, light sensor etc. to support comprehensive model building.

In some examples, the modeling of the wireless network and the related radio environment captures the complex interactions of the elements in the wireless network including path losses, channel condition, as well as the other in-band networks or interferers. Such network models held in databases may also include user locations, user movement, application being used, characteristics of the user device, user presence/location occupancy, user identity and profile etc. In some examples, the model techniques include multi-category models, lists, if then rules and other techniques, and formats. The modeling function depends on internally sensed data as well as on data obtained from external databases.

In some examples, the controlling or output function includes automatic (direct) control of network parameters, or man-in-the-loop interventions including interactive diagnostic support or recommendations to network operators or to end users who can take corrective action. These control or output function are generated by various Service Engines that interact with various entities such as internal data sources/sensors, end devices with associated users, NOC (Network Operations Center) with associated operators, and knowledge databases.

While the modeling function gathers and organizes data to support improvement of user experience or operator costs, such data may also be useful to outside entities or data bases for purposes of coordinating or understanding network or user behavior. Suitable external interface can be defined for this purpose. The net result of such a sense-model-control/interact overlay to wireless network is improved user experience and lower operator costs.

### Definitions

For the described examples, a network end device or end device is generally defined as a device that terminates a wireless link, and could be a Station/STA or terminal (user end)) or access point or base station or relay node (network end). Further, a station/STA is generally defined as an end device that is associated with a user end of link. An access point (AP) is generally defined as an end device associated with network end of the link. A sensor is generally defined as any device that can sense the environment of a wire or a device. The sensor can be active or passive, and can also be a radio, acoustic, optical, IR etc. Further, the sensor can read data off a wire or register. A wireless sensor is generally defined as a sensor that senses the radio environment to listens to signals, analyses the signals or decode/demodulate the signals.

As mentioned, at least some of the described provide systems, methods and apparatuses for sensing, modeling and controlling a wireless network, providing improved user experience and lower operator costs. Some examples improved abilities to understand and solve connectivity issues such as wireless STA being unable to connect or to re-connect with network. Further, some examples improved abilities to understand, anticipate and solve performance issues such mutual interference, or interference from non-WiFi devices, poor throughput, poor coverage, etc. Further, some examples involve improved abilities of wireless end devices to support improved or augmented data collection, sensing and reporting functions. Likewise, some examples also involve end devices that are augmented to improve performance based on accepting additional control inputs.

Further, some examples may provide interactions with external data entities to aid network modeling or knowledge database development. Further, some examples may include providing data from the knowledge database or sensor outputs to external entities for improved third party data analytics.

FIG. 25 shows a block diagram of a sense, model and control system for improving performance of a wireless network 2510, according to the disclosure.

### Wireless Network

The wireless network 2510 may be any type of network using wireless radio transmission in any electromagnetic frequency, spanning global area, wide area, local area and personal area. The wireless network 2510 can be long range to very short range. The wireless network 2510 can serve end users or machines (no human user). The wireless network 2510 can involve any wireless standard from Iridium like LEO satellite communications, mobile networks like 3G and 4G, to WiFi networks to Bluetooth and 802.14 networks.

In some examples, the wireless network 2510 includes STAs and APs. In some examples, the wireless network includes one or more STAs and one or more APs. In some examples, the wireless network includes two or more wireless stations (STAs). The STAs and the APs may include, for example, the previously described access points 1510, 1512, and/or the previously described end point devices 1522, 1524, 1526. Further, the STAs and the APs may include, for example, the previously describe motion-controlled devices.

### Network Sensors/Internal Data Sources

FIG. 25 shows internal data sources (including network sensors) 2520 that represent the various network sensors that are the sources of monitoring data about the wireless network 2510. The network sensors 2520 sense the state of the wireless network 2510, which can then be used to model and eventually control the wireless network 2510 to improve user experience and lower operator costs. In some examples, the network sensors 2520 are, for example, the previously described network devices 1780, 1880, 1980. In some examples, the previously described motion-controlled devices are operational as the network sensors 2520, and/or the network devices 1780, 1880, 1980.

In some examples, multiple of the depicted network sensors are a single motion-controlled device that is operable to move or locate itself to different points or locations within the wireless network 2510. That is, while shown as multiple network sensors in the described examples, the multiple network sensors are actually a single motion-controlled device that is moving to different positions or locations, thereby virtually operating a multiple network sensors. That is, the motion-controlled device (virtually operational as multiple network sensors) can function in any physically feasible position (location universality). Owing to the motion control of the motion-controlled device, the motion-controlled device provides convenience of positioning an opposed to requiring a human being to position the network sensor, thereby providing convenience, and providing safety to the user, and saving costs. In various examples, the motion-controlled device is operable to automatically position itself (using, for example, received signal strength) which provides for faster automated positioning versus requiring manual positioning of the network sensor. Further, even if the motion-controlled device is itself statically positioned, the sensors (sensors or antenna) are operable to control their positioning which is useful.

In some examples, the network sensors 2520 include one or more of multiple sensing modalities, such as wireless sensing covering licensed and unlicensed bands; wired network sensors that listen to traffic on the wired segments or read internal registers inside network elements such as routers, controllers, APs, STAs, switches; cameras or imaging devices in multiple spectrum bands, motion detectors, light detectors. Sensing can also extend to humans-in-loop providing specific data or inputs on network state or fault condition. The list of possible functions of the network sensors 2520 is not limited.

In some examples, the network sensors 2520 form their own parallel (overlay) network to the first wireless network 2510. In some examples, the network sensors 2520 include wireless probes or sensors that are placed at different points within the wireless network 2510. In some examples, at least a portion of the network wireless sensors 2520 are embedded within one or more APs or one of more STAs.

In some examples, at least a portion of the network sensors 2520 are independent of APs or STAs and may be housed in independent boxes. In some examples, network sensors 2520 listen on wired connections as data exit or enter components of the wireless network 2510 such as APs, switch, AP controller, AP manager to extract data from their communication behavior. In some examples, network sensors include software agents that run on components of the wireless network 2510 such as APs, switch, AP controller, AP manager to extract data from their internal operation. In some examples, the network sensors 2520 are configurable. As previously stated, in some examples, the network sensors 2520 are controllable by service engine 2530.

As stated, in some examples, the network sensors 2520 sense conditions of the network 2510. Moreover, in some examples, the network sensors 2520 include receiving manual (man-in-the-loop) inputs from a user device such as, user interface platform 2560 or NOC interface platform 2570.

In some examples, the network sensors 2520 receive wireless packets transmitted from one wireless device to another wireless node of the wireless network 2510. That is, the network sensors 2520 include a receiver that is operable to receive wireless packets that are intended for reception by the other wireless node of the wireless network. In various examples, the network sensors 2520 passively “over hear” the wireless packets. Characteristics of the overheard wireless packets can be used to characterize performance of the wireless network 2510.

In some examples, the network sensors 2520 include functionality that allows for more optimal network sensor placement using the sensed data. Further, some examples include orchestration of data collection to reduce data bandwidth (to, for example, the knowledge database). Further, some examples include real time control of data collection and transmission. Further, some examples include multiple levels of probes that accommodate trade-offs between cost and function. Further, some examples, the network sensors can act as relays for main network. Further, some examples include the network sensors are embedded into powered appliances (such as, Light bulbs, USB charging points, coffee pots).

In some examples, the data collected by the sensors may be sensitive involving security and or privacy concerns. Therefore, the data collection, data transmission, and data editing/compression may be employed for security policies that are in force or agreed upon.

In some examples, the network sensors are configured based on a demand basis or anomaly basis. In some examples, the multiple network sensors are orchestrated to fuse sensed data and improve the quality of the sensed data. In some examples, the sensed data of the multiple network sensors is compressed to reduce bandwidth employed to transmit such data to the sensor service engine and knowledge database.

### Service Engine

In some examples, service engine 2530 refers to a collection of different engines, one each for a specific function. However, examples are not so limited to the list of service engines provided. In various examples, the service engine 2530 includes the service engines 2550 and the analytics engine 1552.

### Sensor Service Engine

In some examples, the sensor service engine of the service engines 2530 receives data from internal data sources, and In some examples, provides at least some control over the internal data sources (1920). Further, in some examples, the sensor service engines both update and store wireless network information in a knowledge database 2540, and as well as accesses previously stored wireless network information to determine what additional sensing can be demanded or how sensors should be configured. Further, in some examples, the sensor service engine process data received from the network sensors 2520.

Some examples include sensor service engines that control data collection, compression, orchestration, configuration of sensors guided by the knowledge database 2540, for example status and anomaly detects reported by an anomaly service engine.

### External Service Engine

In various examples, an external service engine of the service engines 2530 interacts with external databases 2550 to send data from knowledge database 2540 or from internal data sources 2520. Further, the external service engine fetches data on as demanded basis from external data bases and sends them to knowledge database/network modeling entity.

### User Service Engine

In various examples, a user service engine of the service engines 2530 interacts with the end user with an end device (user interface platform) 2560, and In some examples, the user service engine interacts with a user via application interfaces running on the user device (user interface platform) 2560. Further, in some examples, the user service engine provides information to the user device (user interface platform) 2560, and additionally receives information from the user device (user interface platform) 2560. In various examples, the user device 2560 is the previously described end point device 1520.

### Network Operations Center (NOC) Service Engine

In various examples, an NOC service engine of the service engines 2530 interacts with the NOC interface platform 2570 that is used by operators to monitor the condition of the wireless network 2510. Further, in some examples, the NOC service engine interacts with a NOC staff via application interfaces such as dashboards running on the NOC servers. Further, in some examples, in some examples, the NOC service engine provides information to the NOC interface platform 2570 and additionally receives information from the NOC interface platform 2570. In various examples, the NOC interface platform 2570 is the previously described network device 1980.

### Control Service Engine

In various examples, a control service engine of the service engines 2530 interacts with the network 2510 and the end devices such as APs and STAs as well as controllers and routers to change settings on these devices. In various examples, the control service engine is guided by an inference service engine which determines how network settings should be altered.

### Anomaly Service Engine

In various examples, an anomaly service engine of the service engines 2530 interacts with the other service engines and the knowledge database 2540 to detect network anomalies. The anomaly detection is used by other service engines to take specific actions that result in final diagnosis and solution of the anomaly.

### Inference Service Engine

In various examples, an inference service engine of the service engines 2530 is triggered by the anomaly detection and it uses the data form the knowledge database and other information from user interface platform 2560, NOC interface platform 2570 and sensor data 2520 to diagnose the network issue as well as find a solution to the anomaly. Solutions may be in terms of recommendations to the user interface platform interface 2560 or NOC interface platform 2570 or direct control of parameters of the network via the control service engine.

### Network Models/Knowledge Database

In some examples, the Network model/knowledge database 2540 includes a repository of all knowledge employed to provide services. In some examples, the knowledge database 2540 includes different information segments each of which is relevant to a single wireless network 2510. In some examples, the knowledge database 2540 contains information segments that are globally relevant and is shared across multiple wireless networks.

In some examples, the knowledge database 2540 is operable with different formats. Such formats include, for example, relational databases, network, lists, association rules, graphical models, neural networks, decision trees, or probabilistic models. In some examples, the knowledge database 2540 includes dynamic (real-time) and/or persistent (historical) data. In some examples, the knowledge database 2540 includes different knowledge representations that are unique to WiFi or other specific networks. In some examples, the knowledge database 2540 includes black lists and white lists.

In some examples, the knowledge database 2540 includes geographic (map) representation of data—STA location, inter device interference, Non-WiFi interference maps. In some examples, the knowledge database 2540 includes information that is global. That is information obtained from one wireless network is utilized at one or more different wireless networks. In some examples, the knowledge database 2540 is integrated with other entities. The other entities include, for example, calendar/event data base, STA location from GPS, home security database (for example, information on whether a user is in or out of house or office).

### External Databases

In some examples, the external databases 2550 include data inputs from third parties. The data input include, for example, end point characteristics, floor plans, AP location, firmware status of STA and APs or routers.

In some examples, the external databases 2550 are interactive, and include, for example, a query response. In various examples, the query response includes sending captured network packets and receiving a classification result as to what application the packets belong to (Netflix, Skype, etc.).

In some examples, the external databases 2550 include data outputs for third analytics, and include co-ordination with other networks to jointly improve user experience and lower operator costs. In some examples, the external databases 2550 is connectable with other entities—calendar/event data base, home security data bases (for example, information on whether a user is in or out of house or office), visit patterns, visit locations. In some examples, the external databases 2550 are connectable with external service entities like—what applications is this user using (packet inspection), what are known issues about this device (from MAC address).

### User Interface Platform

In various examples, the user interface platform 2560 includes a user device wherein an application is running on the user device. In some examples, the user interface platform 2560 is utilized for improving the performance of the wireless network. As an alternative example, the user interface platform 2560 includes an application running on a separate device, including, for example, a web server, or a network sensor with built-in UI.

In various examples, the user interface platform 2560 is utilized as a “man in the loop”. Particularly, a human operator (user) of the user device is utilized to monitor, interact and correct network issues. As stated, the user interface 2560 can include the user device (STA), a client and/or an application running on the user device, and/or an application running on a separate device.

In some examples, the user interface platform 2560 monitors the status of the wireless network and raises alerts to the user service engines 2530. In some examples, the user interface platform 2560 changes network settings. In some examples, the user interface platform 2560 interacts with service engines 2530 to localize issues.

### Network Operations Center (NOC) Interface Platform

In various examples, the NOC interface platform 2570 includes an operator that interacts with the NOC services engine to provide the NOC operator with diagnostic information and suggestions for interventions in the network. In various examples, the NOC services engine interacts with the NOC interface platform 2570 through the use of alerts, messages, application interfaces.

Some examples allow the operator to observe status of the multiple wireless networks. Further, in some examples, the operator at the NOC interface platform 2570 is able to control settings or configurations of the wireless network 2510.

In some examples, the NOC interface platform 2570 includes displaying, monitoring, interacting and correcting network issues. In various examples, the operator (a human) is included within the control loop for solving issues associated with the wireless network 2510.

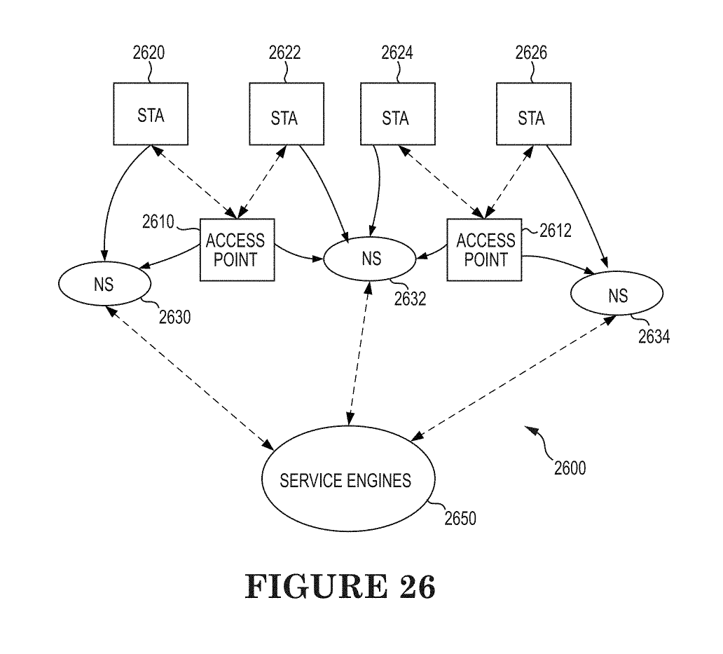

FIG. 26 shows a wireless network 2600 that includes multiple network sensor devices, according to the disclosure. The wireless network 2600 includes multiple wireless network nodes including access points 2610, 2612 (which could be previously described access points 1510, 1512) and stations (STA) 2620, 2622, 2624, 2626 (which could be previously described end point devices 1520, 1522, 1524, 1526). Further, network sensors 2630, 2632, 2634 (which could be the previously described network devices 1780, 1880, 1980) overlay the wireless network 2600.

The network sensors 2630, 2632, 2634 are operative to sample the state or conditions of the wireless network 2600. While three network sensors are shown in FIG. 26, it is to be understood that a large number of network sensors may be utilized. Further, with a large number of network sensor continuously sampling conditions of the wireless network 2600, the amount of sample data collected can be substantial. Accordingly, the disclosed examples provide for subsampling of the collected data to reduce system requirements, such as, backhaul requirements employed to support the network sensors. In various examples, the subsampling maintains a predetermined percentage of the packets. In various examples, the predetermined percentage is 10%.

In various examples, the network sensors 2630, 2632, 2634 receive packets transmitted from one wireless device, and intended for another wireless device. That is, in various examples, the network sensors 2630, 2632, 2634 form a second network that overlays the wireless network 2600. For example, network sensor 2630 may be physically placed within the wireless network 2600 so that the network sensor 2630 is able to receive packets being transmitted between a user device 2620 and an access point 2610. Further, the network sensor 2632 may be physically placed within the wireless network 2600 that the network sensor 2632 is able to receive packets being transmitted between a user device 2622 and the access point 2610. Network sensor 2632 may similarly receive wireless signals from the user device 2624 and the access point 2612, and network sensor 2634 may receive wireless signals from the user device 2626 and the access point 2612.

As wireless communication between the wireless devices of the wireless network 2600 typically includes large numbers of packets, in some examples, the network sensor 2630 intelligently determines which of the received packets to retransmit (either wired or wirelessly) to a service engine 2650. Further, in Some examples, the wireless network sensor transmits a descriptor of the received packet to further reduce backhaul usage. In some examples, the wireless network sensor transmits a representation of the received packet. In some examples, the service engine 2650 utilizes the packets, the descriptors of the packets, or the representations of the packets to identify conditions or anomalies of the wireless network for improving user experience and lower operator cost of the wireless network.

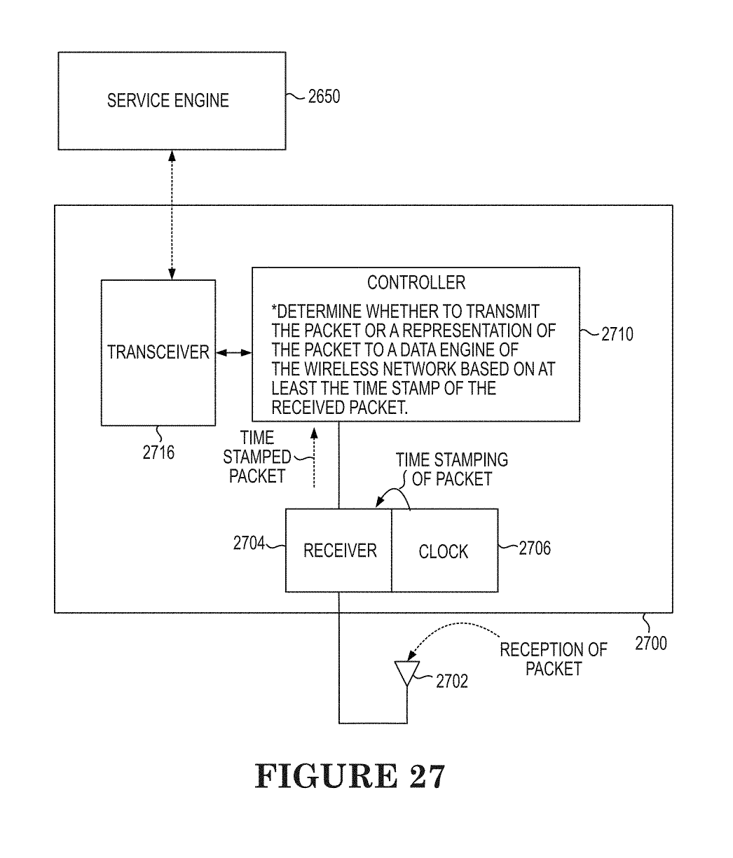

FIG. 27 shows a network sensor 2700 (which could be the previously describe network devices 1780, 1880, 1980, or the previously described motion-controlled devices (without the motion control being shown), according to the disclosure. In various examples, the network sensor 2700 includes an antenna 2702 and a receiver 2704 for receiving wirelessly transmitted packets. The network sensor 2700 includes a clock 2706 which is used to time-stamp packets as the packets are received by the receiver 2704. In various examples, the timestamp is based on the internal clock 2706 of the network sensor.

A controller 2710 of the network sensor 2700 determines if the received packets that have been time-stamped, are to be transmitted by the network sensor 2700 to the service engine 2650. It is to be understood that transmitting the packets to the service engine 2650 includes transmitting at least a representation of the packets. For example, for various examples, the representation of the packet includes at least one of the packet, a portion of the packet, a header of the packet, at least a portion of the header of the packet, and/or a descriptor of the packet. In some examples, the at least a representation of the packet includes a joint representation of an aggregation of representations of multiple packets. Various parameters can be used to make the determination. Particularly, the network sensor 2700 functions as a gate for determining which of received packets or representation of the packets are further transmitted to the service engine 2650 through, for example, transceiver 2716. The gating provides for orchestration between multiple of similar network sensors. The coordination results in subsampling of the packets, which reduces the impact of the packets on, for example, a backhaul of the network sensors.

In various examples, algorithms operating on the controller 2710 within the network sensor attempt to synchronize the internal clock 2706 to internal clocks of other network sensors. In various examples, time stamp rules are received by the network sensor 2700 from one or more external devices. In various examples, the time-stamp of a packet is used to aid in the determination of whether to transmit the packet to the service engine 2650.

In various examples, an absolute timestamp is determined on real-time clock hardware in the network sensor. In some examples, algorithms are operable within the network sensor that keeps these timestamps (roughly) synchronized between different sensors. In various examples, the rule that is applied to the timestamp is programmed into the sensor by service engine 2650. In various examples, a packet header or packet content of the packet is additionally or alternatively used in the determination of whether to transmit the packet to the service engine 2650.

In various examples, an internal state of the network sensor is additionally or alternatively used in the determination of whether to transmit the packet to the service engine 2650. In various examples, the internal state includes at least a data structure that stores list of previously seen transmitter addresses. In various examples, the data structure represents the list of transmitter addresses that were active in the wireless network during one or more past observation windows. In various examples, the data structure represents traffic patterns (for example, packet rates, data rates) over one or more past observation windows.

As stated, the network sensor 2700 selectively transmits packet to the service engine 2650. However, in some examples, the network server 2700 also receives information from the service engine 2650. The information received from the service engine 2650 can include, for example, rules and control messages. The rules can influence whether a packet is transmitted to the service engine 2650. The control messages can provide control of the network sensor 2700, including, for example, selecting one or more wireless channels for receiver 2704, the receiver bandwidth, selecting the type of data to be recorded, resetting the clock 2114.

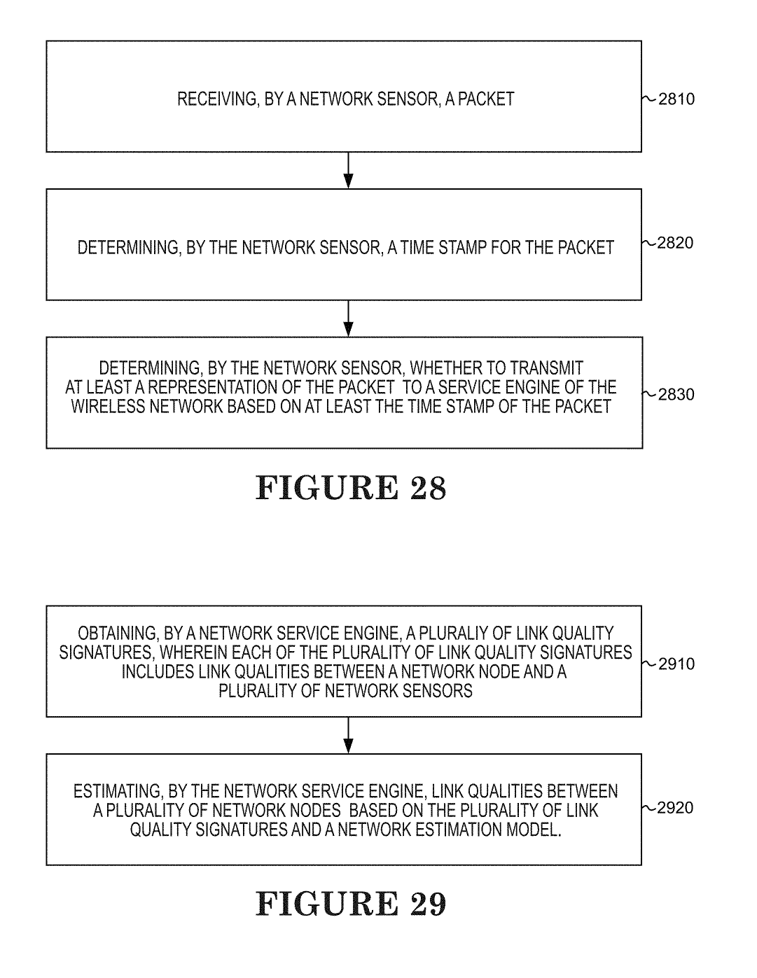

FIG. 28 is a flow chart that includes a method of sensing conditions of a wireless network, according to the disclosure. A method at 2810 includes receiving, by a network sensor, a packet. A method at 2820 includes determining, by the network sensor, a time stamp for the packet. A method at 2830 includes determining, by the network sensor, whether to transmit at least a representation of the packet to a service engine of the wireless network based on at least the time stamp of the packet. The network sensors transmits the at least the representation of the packet after determining to transmit the at least the representation of the packet.

In some examples, the at least a representation of the packet includes at least one of the packet, a portion of the packet, a header of the packet, at least a portion of the header of the packet, and/or a descriptor of the packet. In some examples, the at least a representation of the packet includes a joint representation of an aggregation of representations of multiple packets, wherein the representation of multiple packets includes representation of the present packet and representation of other packets. In some examples, the packet is a data packet, a management packet, or a control packet.

In some examples, determining whether to transmit the at least the representation of the packet is additionally or alternatively based on at least one of a packet header or packet content. In some examples, the packet header information includes one or more of transmit addresses, a destination addresses, packet data rate, packet priority, packet type (management, control, data), packet flags, a packet size, and/or other packet meta information. Further, in some examples, the packet content information include one or more of transmit and destination IP addresses, higher protocol content (for example, DHCP messages, ARP (address resolution protocol) messages), control message in application-level protocols. For example, flow control messages of the control message may precede data rate changes (for example, Netflix resolution changes, Skype adding another caller etc.). For encrypted packet content, some examples include the packet content information being surrogated by payload length, or sequencing information.

In some examples, determining whether to transmit the at least the representation of the packet is additionally or alternatively based on an internal state of the network sensor. In various examples, the internal state includes at least a data structure that stores list of previously seen transmitter addresses. In various examples, the data structure represents the list of transmitter addresses that were active in the wireless network during one or more past observation windows. In various examples, the data structure represents traffic patterns (packet rates, data rates) over one or more past observation windows. In various examples, the internal state includes probabilistic data structures that reduce a memory footprint at the cost of slightly reduced decision accuracy (for example, approximate membership tests, such as Bloom filters, quotient filters).

In some examples, determining whether to transmit the at least the representation of the packet is additionally or alternatively based on an external state of the network sensor, wherein the external state comprises non-wireless observations of the sensor or non-wireless events. This includes, for example, presence detection and/or motion detection (that is, determining whether there are people in the room). In various examples, the sensed conditions do not relate to the wireless aspect of the wireless network. In various examples, the external state includes sensing non-wireless observations of the network sensor, such as non-wireless events. In various examples, this includes additional sensing modalities (motion sensor, temperature sensor, etc.). In various examples, the external state includes receiving instruction from a user or operator. In some examples, determining whether to transmit the at least the representation of the packet is additionally based on an internal state of the network sensor, and based on at least one of a packet header or packet content.

In some examples, determining whether to transmit the at least the representation of the packet is additionally based on a decision rule received by the sensor from an external device. That is, the decision or the decision rule is provided to the network sensor from an external source. For example, the service engine provides the decision based on event detection. For example, in various examples, the service engine observes and event on at least one of a plurality of sensors, and once observed, the service engine changes the decision rule on another sensors to “zoom in” on this event in more detail. In various examples, zooming in includes modifying the decision rule in a way that transmits a larger number of packets or representations of packets.

In some examples, determining whether to transmit the at least the representation of the packet is additionally based on an at least pseudo randomization rule that results in at least pseudo random transmission of a plurality of packets by the network sensor. In various examples, the transmission of the plurality is random. The transmission of the at least the representation of the packet is based on the pseudo randomization rule in that the rule that uses above inputs (timestamp, packet header, packet content, internal state, external state) to make determination of whether to transmit the at least the representation of the packet or not. In some examples, the at least pseudo randomization rule includes a seed, wherein the seed is received from an external device (for example, service engine).

As previously stated, in various examples, the subsampling maintains a predetermined percentage of the packets. In various examples, the predetermined percentage can be 10%. In some examples, to transmit the at least the representation of the packet is additionally based on a periodic rule that results in periodic transmission of a plurality of packets by the network sensor.

As shown and described, the network sensor is typically used as one of many network sensor of the wireless network. Further, in some examples, the generation of packets or representations of packets amongst the network sensors is coordinated. That is, in some examples, each of the plurality of coordination sensors receive a corresponding packet, determine a corresponding time stamp for the corresponding packet, and determine whether to transmit at least a representation of the corresponding packet to the service engine of the wireless network based on at least the time stamp of the received corresponding packet. In various examples, corresponding packets mean observations of the same transmitted packet received by different network sensors. The observations can potentially be differently corrupted by the wireless channel. In This example, the plurality of network sensors provides diversity for receiving the same packet.

In some examples, the plurality of coordinated network sensors are coordinated in their transmission of the at least a representation of the corresponding packet due to the described processes (examples) of receiving joint or shared or common, rules, commands, seeds, time synchronization. In some examples, the coordination includes each of the multiple network sensors deriving their local timestamps from a common source (for example, the service engine), receiving their rules from common source, or receiving parts of the input for rule from common source (for example, the seed of the pseudorandom function). In some examples, if the decision rule is purely based on receive timestamp and packet header or content, and the timestamps between each of the plurality of sensors are synchronized, all of the plurality of sensors will make the same decisions on whether to transmit the at least the representation of the packet.

In some examples, the plurality of coordination network sensors is adaptively selected. In various examples, the plurality of coordinated network sensors are adaptively selected based on proximity of the network sensors. In various examples, the plurality of network sensor is selected based on an ability of the network sensors to wirelessly communicate with each other. In some examples, the plurality of network sensors is selected bases on a logical grouping, a tenant, an SSID, and/or a communications channel band.

In various examples, determining whether to transmit the at least the representation of the packet includes determining a function of a quantized time of the time stamp, the packet content, and a seed that generates random sampling. When the network sensor is one of many network sensor that are all randomizing (or pseudo random) their packet transmission according to the same rule, the upstream device (such as, the services engine) receives the representation of the packets from the many network sensors. Each packet is either received from all or a subset of the plurality of sensors, or from none at all. For a more specific example, determining whether to transmit the at least the representation of the packet includes determining whether a hash function applied to quantized time of the time stamp, the packet content, and the seed modulo n results in a number no larger than m, wherein the quantized time of the time stamp represents a rounded version of the timestamp, the seed is a pre-agreed number (for example generated from a service engine) amongst a plurality of sensor, and wherein n and m are preselected integers.

The quantized time of the time stamp exists because the timestamp synchronization error between sensors is not below a threshold. In some examples, a quantization level is chosen given the quality of time synchronization or a threshold error between the plurality of sensors.

In some examples, the seed, and the integers n and m are chosen by an external device, located, for example, in the cloud (for example a service engine). The integers n and m determine the amount of data reduction (sampling rate). Their values individually do not matter, but together they determine the subsampling rate as their ratio m/n.

In some examples, determining whether to transmit the at least the representation of the packet is additionally based on a confidence interval of time synchronization between the plurality of coordinated network sensors. In some examples, multiple network sensors receive a common time synchronization signal from a common source (for example, from a services engine), but due to network delays the synchronization is to a certain accuracy of +-delta. In various examples, the confidence interval is the maximum value that delta can take on.

In various examples, determining whether to transmit the at least the representation of the packet includes determining whether a hash function applied to quantized time of the time stamp minus (or plus) the confidence interval, the packet content, and the seed modulo n results in a number no larger than m, and/or whether a hash function applied to quantized time of the time stamp plus the confidence interval, the packet content, and the seed modulo n results in a number no larger than m, wherein the quantized time of the time stamp represents a rounded version of the timestamp, the confidence interval is an upper bound on the time synchronization error, the seed is a pre-agreed number amongst a plurality of sensor (for example received from a service engine), and wherein n and m are preselected integers.

In this example, for a plurality of network sensors, packets transmitted by the plurality of sensors are sub-sampled at a rate higher than m/n. If the timestamps of the plurality of sensors are synchronized to within plus or minus delta time between all the plurality of sensors, all of the plurality of sensors will make the same decisions on whether to transmit the at least the representation of the packet.

In some examples, the internal state of the network sensor and/or determining whether to transmit the at least the representation of the packet includes determining whether (a) a transmitter address of the packet is different than any transmitter address of any other packet evaluated or received within a last T1 seconds, or (b) the transmitter address of the packet matches a transmitter address of another packet that satisfied (a), within the last T2 seconds.

As previously shown and described, some examples includes a plurality of the described network sensors placed proximate to the wireless network, wherein a service engine receives a plurality of packets from the plurality of network sensors. Further, as described, the service engine(s) identify conditions of the wireless network based on the received plurality of packets. Such conditions include, but are not limited to, network events, network alerts, network anomalies, network performance issues, and/or protocol deadlocks.

FIG. 29 is a flow chart that includes a method of estimating qualities of links between devices of a wireless network, according to the disclosure. A method at 2910 includes obtaining, by a service engine, a plurality of link quality signatures, wherein each of the plurality of link quality signatures includes link qualities between a network node and a plurality of network sensors. A method at 2920 includes estimating, by the service engine, link qualities between a plurality of network nodes based on the plurality of link quality signatures and a estimation model.

As previously described, in various examples, the plurality of network sensors form an overlay network that overlays an existing wireless network that includes at least the plurality of network nodes. In some examples, the nodes of the existing wireless network provide limited RF information and/or feedback to service engine or to their own access network. The described examples provide augmenting information about these nodes to the wireless network 2510. In some examples, these nodes provide limited RF information to their own access network and overlay network extracts additional information which can be provided to the wireless network 2510.

In some examples, the link qualities of the signatures include at least one of RSSI, path loss, MIMO (multiple input, multiple output channel) order, capacity, and/or interference information. In some examples, the link qualities between a plurality of network nodes includes at least one of RSSI, path loss, MIMO order, modulation schemes, coding schemes, propagation characteristics (LOS, NLOS), capacity, interference information. In various examples, the plurality of network nodes includes two network nodes. That is, link qualities are estimated between a pair of nodes based on the plurality of link quality signatures and the estimation model.

Some examples include generating a coverage map by computing (estimating) the link qualities for each Access point and a plurality of access nodes in the coverage map. Some examples include building a graph/map that represents the wireless network by repeating the estimation of link qualities between pluralities of network nodes among many network nodes or locations of the wireless network. For example, the link qualities can be estimated for pairs of nodes within the wireless network. The estimated link qualities can be presented as a graph or map which depicts the link qualities between each of the nodes of the wireless network.

In some examples, the network service engine obtains a stream of pluralities of link quality signatures. This is, in various examples, a continual flow (stream) of link quality signatures are generated over time. In various examples, a continual flow (stream) of link quality signatures is generated over space. In various examples, a continual flow (stream) of link quality signatures is generated over time and space. In various examples, the continual flow (stream) of link quality signatures is received by the service engine. Some examples include averaging multiple of the stream of pluralities of link quality signatures. In various examples, the averaging is performed at the network service engine. In various examples, the averaging is performed by the network sensors before being received by the service engine. That is, the service engine received a stream of link quality signatures that have been averaged over time.

In some examples, each signature is based on a single packet received by the plurality of network sensors from the single network node. That is, the single packet was transmitted by the single network node, and received by the plurality of network sensors.

In some examples, obtaining the plurality of link quality signatures includes receiving a packet descriptor from each of a plurality of network sensors, and comparing the packet descriptors to determine which packets were commonly received from the single network node by multiple of the network sensors. In some examples, the packet descriptor includes a packet transmitter address. In some examples, the packet descriptor includes a timestamp of when the packet was received by a network sensor of the plurality of network sensors.

Some examples include determining the estimation model. In various examples, this includes characterizing wireless propagation with physical equations. In various examples, the determining the estimation model includes characterizing wireless propagation based on training measurements of link quality signatures from a second plurality of network sensors and corresponding training measurements of link quality from a second plurality of network nodes. In various examples, the second plurality of network sensors and/or network nodes is used for training the estimation model. In an some examples, the prior measurements are designed such that they cover possible relative locations of network sensors and/or network nodes. In some examples, the second plurality of network sensors is identical to the plurality of network sensors being utilized in link quality estimation based on the estimation model.

In various examples, the determining the estimation model includes determining the estimation model comprising characterizing wireless propagation with physical equations and characterizing wireless propagation based on prior measurements of link quality signatures and corresponding link quality between nodes. In some examples, determining the estimation model includes assigning different weights to different cases of the training measurements. In various examples, the weights are determined based on a function of the measured link quality between nodes. For example, during construction of the estimation model, cases in which the link quality is low are given additional weighting. Specifically, for example, an objective function used in model optimization is chosen such that errors at low link qualities are penalized more than errors at high link quality. For example, link quality estimation is used to monitor rate control algorithms. The cases for these algorithms are when the link quality is below a threshold, hence these cases are weighted more. In various examples, the training data is measured in a geometric. In various examples, the weights are used to rebalance the training data in order to match it better to the application case, thus (partially) compensating the mismatch.

Some examples include determining the estimation model by modeling network sensor operation before deployment of the network sensors. In some examples, an estimation model is precomputed for each of a plurality of different scenarios (for example, office, campus, residential, etc.), and one of the estimation models is selected for each actual deployment. Further, in various examples, the estimation model is based on physical equations of wireless propagation. During deployment of the network sensors, the sensor locations are recorded. These sensor locations can be used to determine the sensor distances, which together with the physical equations, can be used to determine the model.

In some examples, determining the estimation model includes modeling network sensor operation after deployment of the network sensors. Further, in some examples, the estimation model is initialized before deployment, and adapted to the deployment site based on a set of measurements performed by the plurality of network sensors. Further, in some examples, the estimation model continually adapts to additional measurements that become available while deployed.

In some examples, estimating the link qualities between the plurality of network nodes is further based on link quality signatures between the plurality network sensors. In various examples, the link quality signatures between the plurality of network sensors is further based on a subset of the plurality of network sensors transmitting packets and other network sensors of the plurality of network sensors receiving and estimating a link quality between the plurality of network sensors. Specifically, in various examples, this includes the network sensors determining link strengths between each other by transmitting sounding packets, and supplementing the estimation model with the link strengths determined between the network sensors.

As will be described, in some examples a processing engine uses sensor-to-sensor link strengths as additional model inputs. That is, along with the plurality of link quality signatures between a network node and a plurality of network sensors, the sensor-to-sensor link strengths are as additional model inputs into the network estimation model.

In various examples, the sounding packets are constructed in a way as not to interfere with regular operation of wireless network. For example, in various examples, the sounding packets are transmitted and utilized during periods of low-use of the wireless network, such as at night when a business that utilizes the wireless network is not very active, or active below a threshold level. In various examples, the sounding packets are transmitted when activity of the wireless network is sensed to be low or below a threshold. By transmitting and utilizing the sounding packets during low-use times, the impact of the sounding packets on the network can be minimized.

In some examples, the link quality signatures between the network sensors are determined upon sensing a motion of one or more of the network nodes of greater than a threshold. In some examples, the link quality signatures between the network sensors are determined periodically, wherein periodically could be regularly or within a max period of elapsed time or within a time interval.

Some examples further includes preprocessing each of the plurality of link quality signatures before estimating the link qualities, and estimating the link qualities between the pair of network nodes based on the plurality of preprocessed link quality signatures and the network estimation model. In some examples, the estimation model is based on one or more of a node type, a node capability, a node transmission power level, a node receiver sensitivity, a node receiver gain, a modulation/coding scheme, or a number of active transmitters. In some examples, preprocessing each of the link qualities of each signature of each network sensor includes determining a ratio of the link quality between the network sensor and the network node and a link quality between a selected network sensor and the network node, thereby accounting for variations in transmit power of the network node over time.

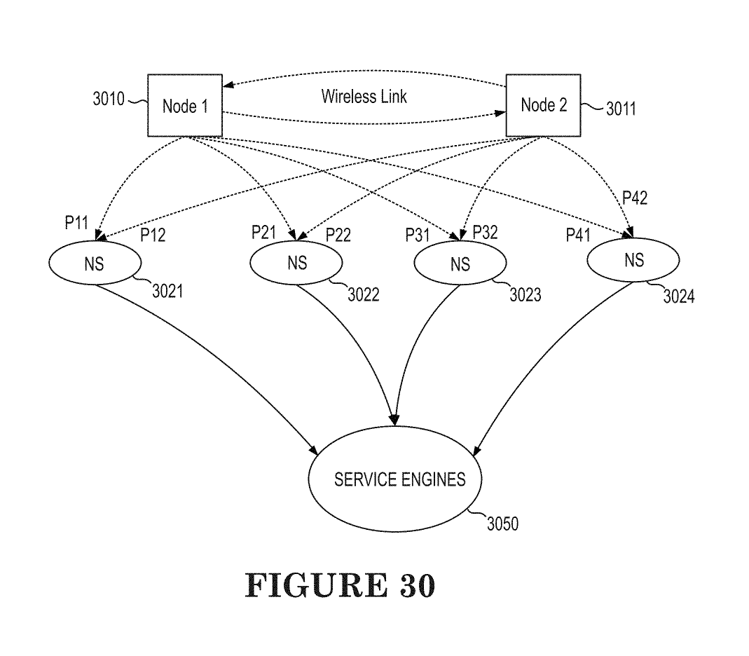

FIG. 30 shows a pair of network nodes 3010, 3011 and network sensors 3021,3022, 3023, 3024 (for example, the previously described network devices 1180, 1280), according to the disclosure. The network nodes 3010, 3011 represent two nodes of a wireless network that are communicating with each other. The network sensors 3021, 3022, 3023, 3024 are operable to “overhear” the wireless communication between the network nodes 3010, 3020. Based on the overheard wireless communication, the quality of the wireless link between the wireless access nodes 3010, 3020 is estimated. As previously described, in various examples, one or more of the network sensor is included within one of the previously described motion-controlled devices.

In various examples, a services engine 3050 receives representations of the wireless signals received by each of the wireless network sensors 3021, 3022, 3023, 3024. As described, in various examples, the network service engine 3050 is operable to obtain a plurality of link quality signatures, wherein each signature includes link qualities between a network node (such as, wireless node 3010 or wireless node 3011) and a plurality of network sensors (such as, wireless network sensors 3021, 3022, 3023, 3024), and estimate link qualities between the pair of network nodes (3010, 3011) based on the plurality of link quality signatures and a network estimation model. Examples of constructing the estimation model

In some examples, the use of the estimation model begins with:

Selecting a Parameterizable model, namely a function yₑₛₜ=f(x₁, x₂, x₃, . . . , xₚ, c₁, c₂, c₃, . . . , cₖ), where

f is the estimator function, and

yₑₛₜ is the output of the estimator.

In some examples as described herein, the estimated link quality (yₑₛₜ) is, for example, between node 3010 and node 3011, and x₁, x₂, x₃, . . . , xₚ are predictor variables (the inputs of the estimator). In some examples, x₁, x₂, x₃, . . . , xₚ are the link quality signatures for node 3010 and node 3011 (each including link quality numbers as observed by sensors 3021, 3022, 3023, 3024). In other words, p=8 numbers.

In some examples, these inputs additionally include pairwise link quality signatures between sensors 3021, 3022, 3023, 3024. In other words, an additional 6 numbers for a total of p=14. Further, c₁, c₂, c₃, . . . , cₖ are parameters of the estimator. In some examples, the values of these parameters are learned during a training phase.

A training dataset, namely n examples of the form (y⁽ⁱ⁾, x₁⁽ⁱ⁾, x₂⁽ⁱ⁾, x₃⁽ⁱ⁾, . . . xₚ⁽ⁱ⁾) for i=1 to n, where y⁽ⁱ⁾ is the link quality between nodes 3010 and 3011 for the ith training example, and x₁⁽ⁱ⁾, x₂⁽ⁱ⁾, x₃⁽ⁱ⁾, . . . , xₚ⁽ⁱ⁾ are the values of the predictor variables for the ith training example.

### Estimation Model Construction (Training):

In some examples, training of the estimation model includes:
1. First, the parameters of the estimator are initialized, using one of
   Set c₁, c₂, c₃, . . . , cₖ to random numbers in a predefined range, or
   Set c₁, c₂, c₃, . . . , cₖ to predefined fixed numbers, or
   Set c₁, c₂, c₃, . . . , cₖ to numbers derived from the training data set with a predefined computation rule, or
   Set c₁, c₂, c₃, . . . , cₖ to numbers derived from a physical equations of wireless signal propagation.
2. Next, for j in 1, 2, 3, . . .
   For i in 1, 2, 3, . . . , n, consider example i from the training dataset
      Compute estimate yₑₛₜ⁽ⁱ⁾=f(x₁⁽ⁱ⁾, x₂⁽ⁱ⁾, x₃⁽ⁱ⁾, . . . , xₚ⁽ⁱ⁾, c₁, c₂, c₃, . . . , cₖ) based on the current parameters of the estimator
      Compute the current estimation error e⁽ⁱ⁾=y⁽ⁱ⁾−yₑₛₜ⁽ⁱ⁾
      Based on a predefined rule that depends on the estimate yₑₛₜ⁽ⁱ⁾, the true value y⁽ⁱ⁾, and the current parameters of the estimator c₁, c₂, c₃, . . . , cₖ, compute new parameters of the estimator (to reduce the estimation error of the current example)
3. Stop the loop over j in method 2 based on one or more of the following stopping criteria
   Estimation error e⁽ⁱ⁾, averaged over all n examples in the training set, did not change significantly as compared to the previous run of the loop (previous value of j)
   Parameters of the estimator c₁, c₂, c₃, . . . , cₖ did not change significantly as compared to the previous run of the loop (previous value of j)
4. Store the final values of the parameters of the estimator c₁, c₂, c₃, . . . , cₖ. They specify the estimation model.

Some examples include variations on the method above:
weighting the training set:
   Assign a weight to each example in the training dataset. In the method above, the implicit weight for the ith example is the equal weight wᵢ=1/n. More generally, the weight can be computed based on the true link quality y⁽ⁱ⁾, the predictor values x₁⁽ⁱ⁾, x₂⁽ⁱ⁾, x₃⁽ⁱ⁾, . . . , xₚ⁽ⁱ⁾, or on a combination of the two
   Instead of visiting all examples i=1, . . . , n in equal proportion (in the inner loop of method 2), visit each example at a frequency proportional to its weight
in each loop over j, use a random subset of the training dataset instead of the entire dataset (to save computation)
construct multiple estimation models (with different random starting conditions, or different random subsets of the training set, or different parameterizable estimator function f), and combine the estimates with a combining function
. . . (there are a lot of variations: online learning, crossvalidation, . . . )
   Examples of parameterizable models f:
Neural networks
Support vector regression
Generalized linear models
Regression trees

Model Application:

In some examples, application of the estimation model includes:
1. Picking two nodes between which the wireless link quality is to be estimated;
2. Obtaining values of the predictor variables x₁, x₂, x₃, . . . , xₚ for the chosen nodes;
3. Load parameters of the estimator c₁, c₂, c₃, . . . , cₖ as computed during model construction;
4. Compute the estimated link quality yₑₛₜ=f(x₁, x₂, x₃, . . . , xₚ, c₁, c₂, c₃, . . . , cₖ);
5. Output the estimated link quality yₑₛₜ.
   The methods can be repeatedly executed:
for the same pair of nodes, if the predictor variables change over time.
for all pairs among a set of at least two nodes, in order to obtain a connectivity graph between the nodes.

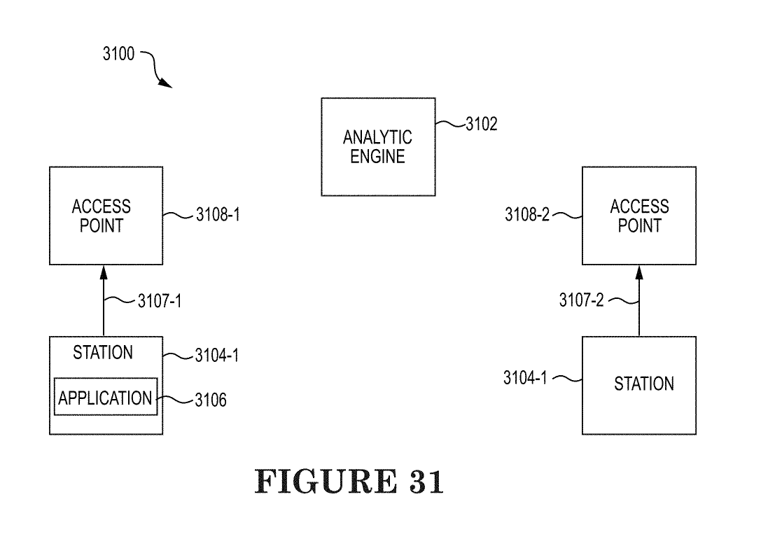

FIG. 31 illustrates an example network layout according to the disclosure. As illustrated in FIG. 31, the network layout 3100 includes a network device (e.g., analytic engine) 3102, stations 3104-1 and 3104-2 (e.g., collectively referred to as stations 3104), and access points) 3106-1 and 3106-2 (e.g., collectively referred to as access points 3106, although examples are not so limited.

Network 3100 may be a wireless local area network (WLAN). However, examples are not so limited. For example, network 3100 can be a wide area network (WAN), an enterprise private network, and/or a virtual private network (VPN), or combination thereof. Network 3100 further can be a software-defined network (SDN), which is a network architecture in which network control plane and policies are decoupled from network infrastructure and client devices and placed in, for example, the network controller 3102.

Stations 3104 may include and perform a network application 3106. As used herein, the term “station” can, for example, refer to a device including a processor, memory, and input/output interfaces for wired and/or wireless communication. A station may include a laptop computer, a desktop computer, a mobile device, and/or other wireless devices, although examples of the disclosure are not limited to such devices. A mobile device may refer to devices that are (or may be) carried and/or worn by a user. For instance, a mobile device can be a phone (e.g., a smart phone), a tablet, a personal digital assistant (PDA), smart glasses, and/or a wrist-worn device (e.g., a smart watch), among other types of mobile devices.

Stations 3104 may transmit/receive information (e.g., data) over network 3100 via a wireless link established between corresponding access points. As used herein, the term “access point (AP)”, can, for example, refer to a networking device that allows a station to connect to a wired or wireless network. An AP can include a processor, memory, and input/output interfaces, including wired network interfaces such as IEEE 802.3 Ethernet interfaces, as well as wireless network interfaces such as IEEE 802.11 WLAN interfaces, although examples of the disclosure are not limited to such interfaces. An AP can include memory, including read-write memory, and a hierarch of persistent memory such as ROM, EPROM, and Flash memory.

As illustrated in FIG. 31, a wireless link 3107-1 may be established between station 3104-1 and access point 3108-1 and a wireless link 3107-2 may be established between 3104-2 and access point 3108-2. Information transferred (e.g., transmitted from stations 3104) via wireless links 3107-1 and 3107-2 may be further transferred over network 3100 such that the transferred information may be communicated with different device, node, and/or network. For example, station 3104-1 may wirelessly communicates a stream 3107-1 to access point 3108-1, and station 3104-2 may wirelessly communicates a stream 3107-2 to access point 3108-2.

Information may be transmitted and/or received via wireless links 3107-1 and 3107-2 (e.g., collectively referred to as wireless links 3107) in a particular form that is suitable for corresponding type of channel communication (e.g., WiFi, LTE, and/or Bluetooth). As used herein, ‘information’ is defined as data, address, control, management (e.g., statistics) or any combination thereof. For transmission, information may be transmitted as a message, namely a collection of bits in a predetermined format. One type of message, namely a wireless message, includes a header and payload data having a predetermined number of bits of information. The wireless message may be placed in a format as one or more packets, frames or cells.

Station 3104-1 may perform the network application 3106. As used herein, a ‘network application’ may be an application (e.g., software designed to perform a group of functions) whose associated data may be transmitted over a network. For example, network application 3106 may involve requesting, by a computing device, data over network (e.g., network 3100) and/or retrieving data from network 3100, and partially processing retrieved data at the computing device. As an example, network application 3106 may be a file downloader and/or designed to providing streaming media and/or video-on-demand online, although examples are not so limited.

Network application 3106 may be performed via a data stream 3107-1 transmitted from station 3104-1. Stated differently, data associated with network application 3106 may be transmitted (e.g., transmittable) by the data stream 3107-1. As used herein, ‘stream’ may refer to information transmitted with a priority type and/or traffic type. For example, ‘stream’ may be data, address, control, management, and/or statistics (e.g., or any combination thereof) with a particular priority relative to those of other streams. As an example, a stream with a higher priority may be treated differently than (e.g., transmitted prior to) a stream with a lower priority.

Different streams may compete for resources (e.g., transmission time, frequency, and/or code) of network 3100. For example, different streams may operate on same transmission band, and/or each stream may be attempting to be transmitted at the same time. As such, in some circumstances, resources allocated to each wireless link, but in an reduced amount that would have not been reduced absent the competition, may not be sufficient to perform, for example, network applications (e.g., network application 3106) properly. Therefore, examples of the disclosure may provide benefits of indicating how well network applications will be performed under various circumstances.

Analytic engine 3102 may be a server (e.g., separate server) that is connected to network 3100. In some examples, analytic engine 3102 may include a plurality of servers such that those operations performable by Analytic engine 3102 are distributed across the plurality of servers.

Analytic engine 3102 may be coupled to various devices to receive information associated with streams 3107. The information associated with the streams 3107 may be, for example, received via a sensor located internal to and/or external to various network devices.

In some examples, access point 3108-1 may be able to (e.g., and/or include an embedded sensor that is able to) receive streams (e.g., streams 3107-1 and 3107-2) competing for the same resource of network 3100. In this example, those streams sensed (e.g., received) by the access point 3108-1 may be directed (e.g., redirected) to analytic engine 3102 for performing further operations.

In some examples, each access point 3108-1 and 3108-2 may be able to (e.g., and/or include an embedded sensor that is able to) receive a corresponding stream competing for the same resource of network 3100. For example, access point 3108-1 may include a first sensor internal to the access point 3108-1 and access point 3108-2 may include a second sensor internal to the access point 3108-2. In this example, those streams sensed by each access point 3108-1 and 3108-2 may be directed (e.g., redirected) to analytic engine 3102 for performing further operations.

In some examples, a sensor located external to access point 3108-1 may receive streams competing for the same resource of network 3100. In this example, those streams sensed by the external sensor may be directed to analytic engine 3102 for performing further operations.

In some examples, an individual sensor may be coupled to (e.g., located external to) each of the access points 3108 to receive a corresponding stream. For example, a first sensor may be externally coupled to the access point 3108-1 for sensing the stream 3107-1 and a second sensor may be externally coupled to the access point 3108-2 for sensing the stream 3107-2. Those streams sensed by each sensor may be directed to analytic engine 3102 for performing further operations.

In some examples, analytic engine 3102 itself may include an embedded sensor and/or may be able to sense streams competing for the same resource of network 3100. In this examples, those streams may be directly directed to analytic engine 3102 for performing further operations. In some examples, streams may be sensed by sensors embedded within a station (e.g., stations 104-1 and/or 104-2) such that information associated with the sensed streams may be, by a corresponding station, provided to the analytic engine 3102.

Analytic engine 3102 may perform various functions to, for example, determine a degree in which a demanding capacity of network application 3106 is met by an estimated capacity. As used herein, the term “capacity” can, for example, refer to a throughput indicating a rate at which information is transmitted. As used herein, the term “demanding capacity” can, for example, refer to a capacity that is sufficient to perform a corresponding network application properly (e.g., without experiencing undesired latencies). As used herein, the term “estimated capacity” can, for example, refer to a capacity estimated to be actual capacity of a corresponding data transmission (e.g., stream) over a network. Stated differently, the term “estimated capacity” may be a potential throughput at which the stream may be transmitted over the network.

In some examples, the estimated capacity may indicate differences among capacities in various circumstances. For example, the estimated capacity may indicate a decreased amount of capacity that would not have been decreased in the absent of a resource competition between a first stream and a second stream.

In some examples, the degree determined by analytic engine 3102 may indicate (e.g., estimate) of a level of performance of the network application 3106 over network 3100. For example, the estimated level of performance may be indicated and provided before an actual performance of the network application 3106 such that one who is provided the estimation may forecast the actual performance of the network application 3106.

Capacities of streams may be estimated responsive to various factors. In some examples, the capacities may be estimated responsive to transmission opportunities and an achievable transmission rate estimated for a corresponding stream. As used herein, the term “transmission opportunity” can, for example, refer to a time (e.g., duration) allocated to a transmitter (e.g., stations 3104), which can transmit information within the allocated time. In some examples, the transmitter may sense a medium (e.g., wireless link, network, etc.) prior to transmitting the information, and if the medium is sensed to be idle (e.g., available), the transmitter may be allocated a number of transmission opportunities during which the transmitter is allowed to transmit the information. If the medium is sensed to be congested (e.g., not available), the transmitter may wait for another period of time, which may be referred to as a backoff period.

In some examples, determining the transmission opportunities includes executing a max-min fairness algorithm. This may include all the streams using less than their fair share of transmission opportunities may win as many as they demanded and the remaining transmission opportunities may be equally divided among the remaining streams. Each stream may transmit a different average amount of time for its transmission opportunities. As such, the average medium usage of the stream combined with its transmit opportunities usage may be used to determine the transmission opportunities win for the stream. For example, assuming there is one stream that wins 180 transmission opportunities and transmits for 5 milliseconds each in a 1 second interval (accounting for about 10% of backoff overhead). If there is a new stream (with same priority as existing stream) that starts to contend and use the medium for 10 ms every time it wins the contention, the number of transmission opportunities may be equally divided between the existing stream and the new stream. However, the time may not be, as the existing stream may use about half the time of the new stream as it transmits half of the time of the new stream every time it wins the medium. In this case, one-contention-cycle can be computed as sum of all medium usage. In this case it may be 15 ms (10+5). Dividing 1-sec intervals into 15 msec contention cycles it can be found that about 60 cycles can be accommodated, accounting for about 10% of backoff overhead. As such, the existing stream may have 60 transmission opportunities and can use the wireless medium for 300 ms. The new stream may have 60 transmission opportunities and can use the wireless medium for 600 ms.

The transmission opportunities and/or the achievable transmission rate may be estimated responsive to capabilities of a transmitter (e.g., transmitter of the corresponding stream) and a receiver (e.g., receiver of the corresponding stream) of a wireless link, and collected information of a wireless transmission (e.g., transmission between a transmitter and a receiver). In some examples, the collected information of the wireless transmission may indicate that transmission signal with electromagnetic energy is above a threshold within a frequency band of the wireless link. In some examples, the wireless transmission is between the transmitter (e.g., stations 3104) and the receiver (e.g., access points 3108). In some examples, the wireless transmission includes electromagnetic energy of wireless transmission of different transmitters and receivers. In some examples, the wireless transmission includes electromagnetic energy from a different communication system. In some examples, the wireless transmission includes electromagnetic energy from separate source, such as, for example, a microwave oven.

In some examples, capabilities of a transmitter and of a receiver of the wireless link (e.g., wireless links 3107) may be sensed and obtained by analytic engine 3102. In some examples, the capabilities of a transmitter and of a receiver may be obtained directly from a database of a plurality of wireless devices of various types. For example, the database may be populated based on historical capability observations per device or per device type.

In some examples, the capabilities may include Backoff/contention parameters (CWmin, CWmax, AIFSN), Rate parameters (Nss (Number of spatial streams), Bandwidth, Modulation and Coding, Guard interval), Aggregation parameters (Number of MAC Protocol Data Units (MPDUs) in Aggregated MPDU (AMPDU), length of AMPDU, MPDU size), Burst behavior (This defines how many PPDUs (PLCP Protocol Data Units) will be sent in succession on a transmit opportunity win), PER (Packet error rate is a measure of how many packets had to be transmitted multiple times before the transmitter received the acknowledgement from the receiver), Overhead (Protocol overhead, protection frames overhead, security overhead etc.), and/or any combination thereof.

The achievable transmission rate of the transmitter may be estimated responsive to the collected information of the wireless transmission and the capabilities of the transmitter in various ways. In some examples, the achievable transmission rate by the transmitter may be estimated by determining the actual rate from the Physical layer (PHY) header of data PPDUs (PHY protocol data unit), looking the rate information from an application running on the client or from the wireless LAN controller if it provides such information.

In some examples, the achievable transmission rate by the transmitter may be estimated by determining the time duration from CTS (Clear to send frame) to BA (block acknowledgment frame), or the time duration from one BA to another BA in a burst. Responsive to the time duration and the AMPDU length (aggregate MAC protocol data unit), the rate at which the AMPDU was sent can be approximated. The AMPDU length itself can be estimated based on BA bitmap and the known or estimated MPDU length used by the transmitter.

In some examples, the achievable transmission rate by the transmitter may be estimated by determining the received signal strength indicator (RSSI) of the link and lookup the rate that is most likely to be used at this RSSI. In some examples, the achievable transmission rate by the transmitter may be estimated by using the rate from one of the AMPDUs already transmitted assuming the rate has not changed more than a threshold.

In some examples, the achievable transmission rate by the transmitter may be estimated by observing packets (e.g., of streams) during an observation period. As an example, observing packets may include observing at what transmission rate the transmitter decides to send the packet. As an example, observing packets may include observing the transmission rate distribution. As an example, observing packets may include observing a PHY header of a packet and inferring the transmission rate based on number of bytes and duration as encoded in the PHY header. In this example, the PHY header of a transmission packet is encoded more reliably than the remainder of the packet, and can thus be decoded with a lower error probability than the remainder of the packet. Thus, decoding PHY header while disregarding the remainder of the packet will yield more evidence for the transmission rate than the alternative approach of considering packets that are decoded successfully in their entirety. As an example, observing packets may include observing control packets and inferring the transmission rate of the data packets.

In some examples, the capacity may be estimated, responsive to the estimated transmission opportunities and the estimated achievable transmission rate, by taking protocol overhead into account. The protocol overhead may indicate a circumstance, in which medium resources are used for transmitting auxiliary information and thus are not available for transmitting payload information. In some examples, the protocol overhead may include: PHY header, Frame headers (includes MPDU header, MPDU delimiters in AMPDU, LLC (logical link control) header, Security header, AMSDU header in case of AMSDU, FCS (frame check sequence), Mandatory waiting periods before transmission due to backoff or SIFS time, TCP acknowledgements, Control frames (Protection frames such as RTS (request to send)/CTS, acknowledgement frames such as ack/blockacks).

In some examples, the capacity may be estimated, responsive to the estimated transmission opportunities and the estimated achievable transmission rate, by taking a reverse stream into account. For example, the reverse stream is the one where the transmitter and receiver in the original stream are swapped to become receiver and transmitter respectively. The priority of the stream may stay the same or change to some default priority such as Best Effort. Stated differently, the reverse stream is a stream in which the roles of the transmitter and the receiver are reversed. The reverse stream impacts the achievable throughput on the stream. As an example, TCP traffic entails ACK messages that travel in the reverse direction and compete for airtime with the data on the forward direction.

In some examples, the capacity may be estimated, responsive to the estimated transmission opportunities and the estimated achievable transmission rate, by taking a packet error rate (PER) of streams into account. For example, PER is observed during an observation period and assumed to remain constant. As an example, the PER is looked up based on RSSI/rate.

In some examples, the capacity may be estimated, responsive to the estimated transmission opportunities and the estimated achievable transmission rate, based on an assumption that a stream is part of a multi-hop network communication link, and by taking link properties of the (e.g., wireless/wired) hops external to the stream into account. For example, within a multi-hop system, the wireless stream traverses more links than the present wireless link, and the capacity may be limited by characteristics of one or more of the other links, and the capacity of the present link may be limited to the capacity of the one or more other links. In some examples, the characteristics of the other link may include other hop capacity, latencies, drop rates, jitter, fragmentation, window size.

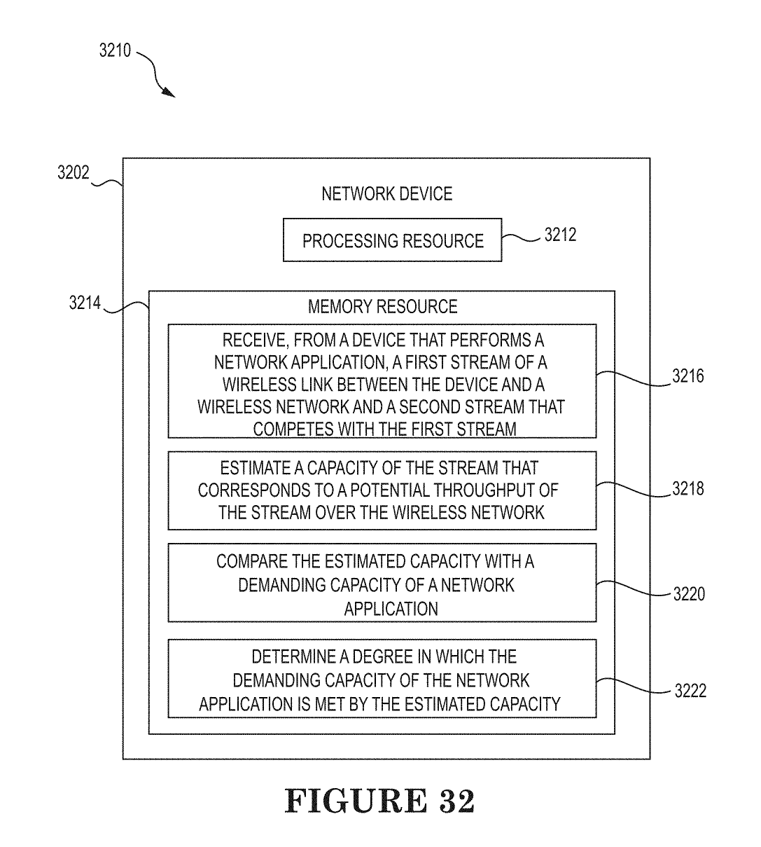

FIG. 32 is a block diagram 3210 of an example network device 3202 for capacity comparisons according to the disclosure. As illustrated in FIG. 32, the network device 3202 may comprise a processing resource 3212 and a memory resource 3214 storing machine-readable instructions to cause the processing resource 3212 to adjust an availability of a data path. Processing resource 3212 may be a central processing unit (CPU), microprocessor, and/or other hardware device suitable for retrieval and execution of instructions stored in memory resource 3214.

Network device 3202 may include instructions 3216 stored in the memory resource 3214 and executable by the processing resource 3212 to receive, from a device that performs a network application, a first stream of a wireless link between the device and a wireless network and a second stream that competes with the first stream. For example, the second stream may compete with the first stream for a resource of the wireless network. Network device 3202 may be an analytic engine 3102 illustrated and described in connection with FIG. 31.

Network device 3202 may include instructions 3218 stored in the memory resource 3214 and executable by the processing resource 3212 to estimate a capacity of the stream that corresponds to a potential throughput of the stream over the wireless network. In some examples, the capacity of the stream may be estimated prior to a transmission of the associated data by the stream over the wireless network.

In some examples, the instructions 3218 may include instructions to obtain capabilities of a transmitter and a receiver of the wireless link, collect information of a wireless transmission whose transmission signal with electromagnetic energy is above a threshold within a frequency band of the wireless link, estimate, responsive to the obtained capabilities and the collected information, an transmission opportunity available for the transmitter to transmit wireless communications to the receiver, and estimate, responsive to the determined capabilities and the collected information, an achievable transmission rate by the transmitter, as described in connection with FIG. 31. In some examples, the capacity may be estimated responsive to the estimated transmission opportunities and the estimated achievable transmission rate.

In some examples, the estimated capacity may be represented (e.g., displayed) in various forms. For example, the estimated capacity may be displayed as a histogram (e.g., over time) that indicates changes in capacities estimated over time. For example, the estimated capacity may be displayed as a statistical representation such as confidence interval/probability distribution that indicates which range of values (e.g., values of capacities) the estimated capacity may likely fall in. For example, the estimated capacity may be displayed as a number of times a threshold (e.g., threshold capacity) is exceeded by the estimated capacity.

In some examples, the estimated capacity may be one of a plurality of capacities estimated for streams received from the device. For example, the instructions 3222 may include instructions to compare among degrees in which the demanding capacity of a network application are met by each one of the plurality of estimated capacities, and instructions to select, responsive to the comparison, one of the degrees whose corresponding estimated capacity is greater than those estimated capacities of others of the degrees. In this example, those capacities estimated, for example, for a particular device may be compared among the estimated capacities such that it can be determined which capacity is greater/less than others.

Network device 3202 may include instructions 3220 stored in the memory resource 3214 and executable by the processing resource 3212 to compare the estimated capacity with a demanding capacity of the network application whose associated data are transmittable by the stream. The comparison may include determining whether the estimated capacity is greater (e.g., exceeds) and/or less than the demanding capacity. That the estimated capacity is greater than the demanding capacity may indicate that the network application may perform properly, and that the estimated capacity is less than the demanding capacity may indicate that the network application may not perform properly.

Network device 3202 may include instructions 3222 stored in the memory resource 3214 and executable by the processing resource 3212 to determine a degree in which the demanding capacity of the network application is met by the estimated capacity. In some examples, the instructions 3222 may include instructions to transmit the degree in which the demanding capacity of the network application is met by the estimated capacity to a requester in a communicable form. For example, the requester may be a device (e.g., user of the device) that performs the network application such that the transmitted degree may be displayed (e.g., via an email) on the device in various manners. For example, a requester may be a service provider of a network application who provides services associated with the network application. As an example, the service provider may receive information associated with the transmitted degree, and may utilized the information to analyze a quality of service offered in performing a particular network application in various circumstances. The degree may be transmitted in a communicable form (e.g., as a graphical representation) such that the degree may be easily identified by the requester.

In some examples, the instructions 3222 may include instructions to adjust changes in the capacities of the stream estimated over a particular time interval. For example, capacities of the stream may be estimated for a particular time interval such that, over the particular time interval, how capacities of the stream have been changed may be determined (e.g., adjusted). As such, a capacity at a particular time (e.g., within the time interval) that is greater than or less than other capacities at a different time may be determined.

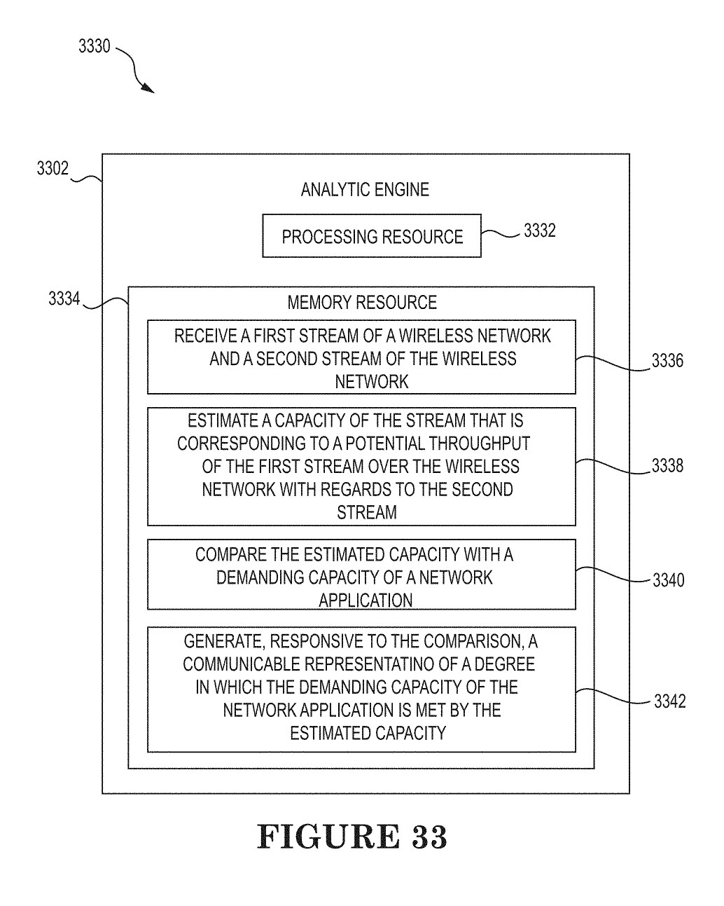

FIG. 33 is a block diagram 3330 of an example analytic engine 3302 for capacity comparisons according to the disclosure. As illustrated in FIG. 33, the network device 3302 may comprise a processing resource 3332 and a memory resource 3334 storing machine-readable instructions to cause the processing resource 3332 to adjust an availability of a data path. Processing resource 3332 may be a central processing unit (CPU), microprocessor, and/or other hardware device suitable for retrieval and execution of instructions stored in memory resource 3334.

Analytic engine 3302 may include instructions 3336 stored in memory resource 3334 and executable by processing resource 3332 to receive a first stream of a wireless network and a second stream of the wireless network. In some examples, the second stream may compete with the first stream for a resource of the wireless network.

Analytic engine 3302 may include instructions 3338 stored in memory resource 3334 and executable by processing resource 3332 to estimate a capacity of the first stream that is corresponding to a potential throughput of the first stream over the wireless network with regards to the second stream. In some examples, the instructions 3338 may include instructions to obtain capabilities of a transmitter and a receiver of the wireless link, collect information of a wireless transmission whose transmission signal with electromagnetic energy is above a threshold within a frequency band of the wireless link, estimate, responsive to the obtained capabilities and the collected information, an transmission opportunity available for the transmitter to transmit wireless communications to the receiver, and estimate, responsive to the determined capabilities and the collected information, an achievable transmission rate by the transmitter, as described in connection with FIG. 31. In some examples, the capacity may be estimated responsive to the estimated transmission opportunities and the estimated achievable transmission rate.

Analytic engine 3302 may include instructions 3340 stored in memory resource 3334 and executable by processing resource 3332 to compare the estimated capacity with a demanding capacity of a network application whose associated data are transmittable by the first stream. The comparison may include determining whether the estimated capacity is greater (e.g., exceeds) and/or less than the demanding capacity. That the estimated capacity is greater than the demanding capacity may indicate that the network application may perform properly, and that the estimated capacity is less than the demanding capacity may indicate that the network application may not perform properly.

The demanding capacity of the network application may be obtained through various ways. In some examples, the instructions 3340 may include instructions to measure the demanding capacity of the network application. In some examples, the instructions 3340 may include instructions to obtain the demanding capacity of the network application from a database.

Analytic engine 3302 may include instructions 3342 stored in memory resource 3334 and executable by processing resource 3332 to generate, responsive to the comparison, a communicable representation of a degree in which the demanding capacity is met by the estimated capacity. In some examples, the communicable representation of the degree may include a percentage (e.g., indicating that what percentage of the demanding capacity is met by the estimated capacity), a star rating, a red/yellow/green indicator, and/or a number rating.

The degree may indicate an estimation of a degree of performance of the network application over the wireless network, for example, prior to an actual performance of the network application. Stated differently, the actual performance of the network application over the wireless network may be estimated prior to the performance of the network application.

In some examples, the instructions 3342 may include instructions to analyze a plurality of factors influenced in determining the degree in which the demanding capacity is met by the estimated capacity, and instructions to generate a communicable representation of the analysis. For example, the plurality of analyzed factors may indicate that the demanding capacity is not met by the estimated capacity due to high non-WiFi interference and/or WiFi traffic.

In some examples, the instructions 3342 may include instructions to provide, responsive to a result of the comparison and the analysis of the factors, a recommendation. For example, when the recommendation is being provided to a user of a device performing the network application, the recommendation may be to replace/upgrade a particular access point among those access points the device is connected to, and/or connect to a different access point than (e.g., and/or in addition to) the particular access point the device is currently connected to.

In some examples, memory resource 3334 may include instructions and executable by processing resource 3332 to determine, responsive to the estimated capacity of the first stream, a demanding capacity of a first quality choice of performing the network application and a demanding capacity of a second quality choice of performing the network application. For example, in an example where the network application is performable according to a plurality of different quality choices (e.g., High Definition (HD), High Quality (HQ), standard video, etc.), a demanding capacity of each of the quality choices may be compared to the estimated capacity of the first stream. Memory resource 3334 may further include instructions (e.g., and executable by processing resource 3332) to adjust a tradeoff between degrees in which each of the demanding capacities of the quality choices is met by the estimated capacity. For example, the adjusted tradeoff may indicate benefits as well as losses of performing the network application according to the first quality choice as compared to the second quality choice. As an example, the benefits may indicate that the network application may perform better (e.g., with less latencies) at the first quality choice as compared to the second quality choice, while the losses may indicate a quality difference between the first quality choice and the second quality choice.

In some examples, memory resource 3334 may include instructions and executable by processing resource 3332 to estimate capacities of streams, which are transmitted from a device at a plurality of different locations of the device (e.g., device that performs the network application), compare the estimated capacities with the demanding capacity of the network application, and adjust changes in degrees in which the demanding capacity of the network application are met by the estimated capacities. For example, a device that is connected to the network may still be mobile among a plurality of different locations. In this example, streams transmittable at different locations may be estimated (e.g., and/or sensed) to vary depending on where the device is located at. Therefore, each of the capacities estimated/determined at the different locations may be compared to the demanding capacity of the network application (e.g., to result in degrees, in which the demanding capacity is met by each estimated capacity), and changes in degrees may be adjusted (e.g., determined). As an example, the changes in the degrees may be utilized to select a location where a capacity of a particular stream is greater than and/or less than capacities of others streams at other locations.

In some examples, memory resource 3334 may include instructions and executable by processing resource 3332 to estimate capacities of the streams, which are transmitted from a device (e.g., the device that performs the network application) at a plurality of different times, compare the estimated capacities with the demanding capacity of the network application, and adjust changes in degrees in which the demanding capacity of the network application are met by the estimated capacities. For example, network application may be performed with various capacities that may vary depending on a time at which the network application is performed. In such a case, capacities of streams may be estimated at a plurality of different times and compared with the demanding capacity of the network application such that, for example, a particular time (e.g., a particular time interval) at which the network application performs with greater/less capacity may be selected.

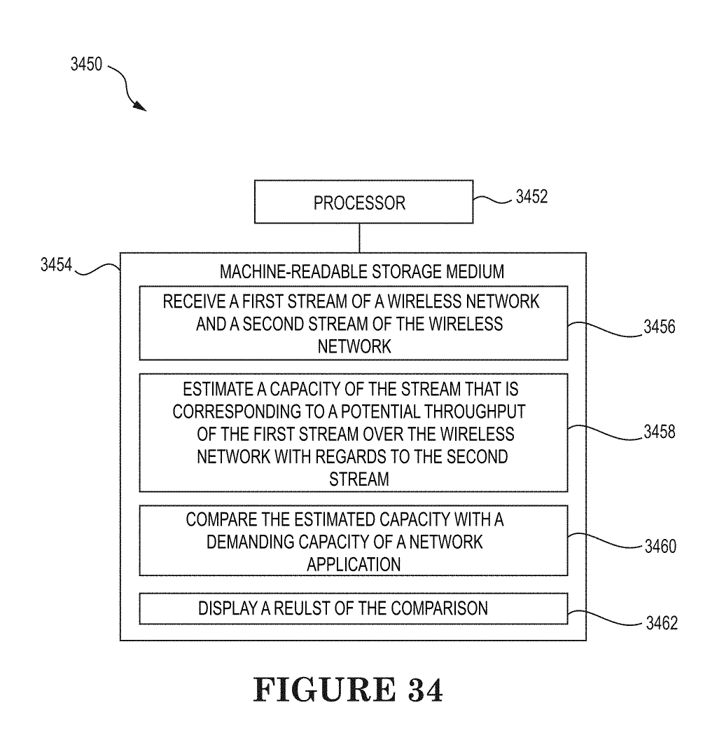

FIG. 34 is a block diagram of an example system 3450 according to the disclosure. In the example of FIG. 34, system 3450 includes a processor 3452 and a non-transitory machine-readable storage medium 3454. Although examples are not so limited, system 3450 may be analogous to network device 3202 and/or analytic engine 3302 as described in connection with FIGS. 32 and 33, respectively.

Although the following descriptions refer to a single processor and a single machine-readable storage medium, the descriptions may also apply to a system with multiple processors and multiple machine-readable storage mediums. In such examples, the instructions may be distributed across multiple machine-readable storage mediums and the instructions may be distributed across multiple processors. Put another way, the instructions may be stored across multiple machine-readable storage mediums and executed across multiple processors, such as in a distributed computing environment.

Processor 3452 may be a central processing unit (CPU), microprocessor, and/or other hardware device suitable for retrieval and execution of instructions stored in machine-readable storage medium 3454. In the particular example shown in FIG. 34, processor 3452 may receive, determine, and send instructions 3456 and 3458. As an alternative or in addition to retrieving and executing instructions, processor 3452 may include an electronic circuit comprising a number of electronic components for performing the operations of the instructions in non-transitory machine-readable storage medium 3454. With respect to the executable instruction representations or boxes described and shown herein, it should be understood that part or all of the executable instructions and/or electronic circuits included within one box may be included in a different box shown in the figures or in a different box not shown.

Non-transitory machine-readable storage medium 3454 may be any electronic, magnetic, optical, or other physical storage device that stores executable instructions. Thus, machine-readable storage medium 3454 may be, for example, Random Access Memory (RAM), an Electrically-Erasable Programmable Read-Only Memory (EEPROM), a storage drive, an optical disc, and the like. The executable instructions may be “installed” on system 3450 illustrated in FIG. 34. Non-transitory machine-readable storage medium 3454 may be a portable, external or remote storage medium, for example, that allows system 3450 to download the instructions from the portable/external/remote storage medium. In this situation, the executable instructions may be part of an “installation package”. As described herein, machine-readable storage medium 3454 may be encoded with executable instructions for standby controllers for access points.

Instructions 3456, when executed by a processor such as processor 3452, may cause system 3454 to receive a first stream of a wireless network and a second stream of the wireless network. In some examples, the second stream may compete with the first stream for a resource of the wireless network.

Instructions 3458, when executed by a processor such as processor 3452, may cause system 3454 to estimate a capacity of the first stream that is corresponding to a potential throughput of the first stream over the wireless network with regards to the second stream. In some examples, the estimated capacity of the first stream may be a capacity estimated to be an actual capacity of the first stream over the wireless network. Stated differently, an actual throughput of the first stream that is transmitted over the wireless network may be estimated, responsive to the estimated capacity, prior to the transmission of the first stream.

In some examples, the instructions 3458 may include instructions to obtain capabilities of a transmitter and a receiver of the wireless link, collect information of a wireless transmission whose transmission signal with electromagnetic energy is above a threshold within a frequency band of the wireless link, estimate, responsive to the obtained capabilities and the collected information, an transmission opportunity available for the transmitter to transmit wireless communications to the receiver, and estimate, responsive to the determined capabilities and the collected information, an achievable transmission rate by the transmitter, as described in connection with FIG. 31. In some examples, the capacity may be estimated responsive to the estimated transmission opportunities and the estimated achievable transmission rate.

Instructions 3460, when executed by a processor such as processor 3452, may cause system 3454 to compare the estimated capacity with a demanding capacity of a network application whose associated data are transmittable by the first stream. The comparison may include determining whether the estimated capacity is greater (e.g., exceeds) and/or less than the demanding capacity. That the estimated capacity is greater than the demanding capacity may indicate that the network application can perform properly, and that the estimated capacity is less than the demanding capacity may indicate that the network application may not perform properly.

Instructions 3462, when executed by a processor such as processor 3452, may cause system 3454 to display a result of the comparison. In some examples, the instructions 3462 to display the result of the comparison may include instructions to display a degree of match between the estimated capacity and the demanding capacity. For example, the degree may be displayed in a form of a percentage indicating that what percentage of the demanding capacity met by (e.g., exceeded by) the estimated capacity. However, examples are not limited to a particular form. For example, the degree may be displayed in a form of a star rating, a red/yellow/green indicator, and/or a number rating.

In some examples, the instructions 3462 may include instructions to display one of two different states. For example, a first of the two different states may indicate that the demanding capacity is met by the estimated capacity, and a second of the two different states may indicate that the demanding capacity is not met by the estimated capacity. As an example, a “PASS” may be displayed when the demanding capacity is met by the estimated capacity, and a “FAIL” may be displayed when the demanding capacity is not met by the estimated capacity, although examples are not so limited.

It will be understood that when an element is referred to as being “on,” “connected to”, “coupled to”, or “coupled with” another element, it can be directly on, connected, or coupled with the other element or intervening elements may be present. In contrast, when an object is “directly coupled to” or “directly coupled with” another element it is understood that are no intervening elements (adhesives, screws, other elements) etc.

In the foregoing detailed description of the disclosure, reference is made to the accompanying drawings that form a part hereof, and in which is shown by way of illustration how examples of the disclosure may be practiced. These examples are described in sufficient detail to enable practice of the examples of this disclosure, and it is to be understood that other examples may be utilized and that process, electrical, and/or structural changes may be made without departing from the scope of the disclosure.

The FIGS. 31-34 follow a numbering convention in which the first digit corresponds to the drawing figure number and the remaining digits identify an element or component in the drawing. For example, reference numeral 3106 may refer to element 3102 in FIG. 31 and an analogous element may be identified by reference numeral 3202 in FIG. 32. Elements shown in the various figures herein can be added, exchanged, and/or eliminated to provide additional examples of the disclosure. In this regard, directional terminology, such as “front,” “rear” etc., is used with reference to the orientation of the Figure(s) being described. In addition, the proportion and the relative scale of the elements provided in the figures are intended to illustrate the examples of the disclosure, and should not be taken in a limiting sense.

What is claimed:

1. A network device, including:
a processing resource; and
a memory resource storing machine readable instructions to cause the processing resource to:
receive, from a device that performs a network application, a first stream of a wireless link between the device and a wireless network and a second stream of the wireless network, wherein the second stream competes with the first stream for a resource of the wireless network;
estimate a capacity of the stream that corresponds to a potential throughput of the stream over the wireless network;
compare the estimated capacity with a demanding capacity of the network application whose associated data are transmittable by the stream; and
determine a degree in which the demanding capacity of the network application is met by the estimated capacity.

2. The network device of claim 1, including instructions to adjust changes in the capacities of the stream estimated over a particular time interval.

3. The network device of claim 1, wherein the capacity of the stream is estimated prior to a transmission of the associated data by the stream over the wireless network.

4. The network device of claim 1, including instructions to transmit the degree in which the demanding capacity of the network application is met by the estimated capacity in a communicable form.

5. The network device of claim 1, wherein the capacity is one of a plurality of capacities estimated for streams received from the device, and including instructions to:
compare among degrees in which the demanding capacity of a network application are met by each one of the plurality of estimated capacities; and
select, responsive to the comparison, one of the degrees whose corresponding estimated capacity is greater than those estimated capacities of others of the degrees.

6. The network device of claim 1, wherein the instructions to estimate the capacity of the stream that corresponds to a potential throughput of the stream over the wireless network comprises instructions to:
obtain capabilities of a transmitter and a receiver of the wireless link;
collect information of a wireless transmission whose transmission signal with electromagnetic energy is above a threshold within a frequency band of the wireless link;
estimate, responsive to the obtained capabilities and the collected information, a transmission opportunity available for the transmitter to transmit wireless communications to the receiver; and
estimate, responsive to the determined capabilities and the collected information, an achievable transmission rate by the transmitter, wherein the capacity is estimated responsive to the estimated transmission opportunities and the estimated achievable transmission rate.

7. An analytic engine, including:
a processing resource; and
a memory resource storing machine readable instructions to cause the processing resource to:
receive a first stream of a wireless network and a second stream of the wireless network, wherein the second stream competes with the first stream for a resource of the wireless network;
estimate a capacity of the first stream that is corresponding to a potential throughput of the first stream over the wireless network with regards to the second stream;
compare the estimated capacity with a demanding capacity of a network application whose associated data are transmittable by the first stream; and
generate, responsive to the comparison, a communicable representation of a degree in which the demanding capacity is met by the estimated capacity.

8. The analytic engine of claim 7, including instructions to:
analyze a plurality of factors influenced in determining the degree in which the demanding capacity is met by the estimated capacity; and
generate a communicable representation of the analysis.

9. The analytic engine of claim 7, wherein the degree indicates an estimation of a degree of performance of the network application over the wireless network prior to an actual performance of the network application.

10. The analytic engine of claim 7, including instructions to:
compare, to the estimated capacity of the first stream, demanding capacities of a first quality choice and a second quality choice of performing the network application; and
adjust a tradeoff between degrees in which each of the demanding capacities of the quality choices is met by the estimated capacity.

11. The analytic engine of claim 7, including instructions to:
estimate capacities of streams, which are transmitted from a device at a plurality of different locations of the device, wherein the device is to perform the network application;
compare the estimated capacities with the demanding capacity of the network application; and
adjust changes in degrees in which the demanding capacity of the network application are met by the estimated capacities.

12. The analytic engine of claim 7, including instructions to:
estimate capacities of the streams, which are transmitted from a device at a plurality of different times, wherein the device is to perform the network application;
compare the estimated capacities with the demanding capacity of the network application; and
adjust changes in degrees in which the demanding capacity of the network application are met by the estimated capacities.

13. The analytic engine of claim 7, including instructions to measure the demanding capacity of the network application.

14. The analytic engine of claim 7, including instructions to obtain the demanding capacity of the network application from a database.

15. The analytic engine of claim 7, wherein the instructions to estimate a capacity of the first stream that is corresponding to a potential throughput of the first stream over the wireless network with regards to the second stream comprises instructions to:
obtain capabilities of a transmitter and a receiver of a wireless link via which the first stream is transmitted;
collect information of a wireless transmission whose transmission signal with electromagnetic energy is above a threshold within a frequency band of the wireless link;
estimate, responsive to the obtained capabilities and the collected information, a transmission opportunity available for the transmitter to transmit wireless communications to the receiver; and
estimate, responsive to the determined capabilities and the collected information, an achievable transmission rate by the transmitter, wherein the capacity is estimated responsive to the estimated transmission opportunities and the estimated achievable transmission rate.

16. A non-transitory machine-readable storage medium having stored thereon machine-readable instructions to cause a processor to:
receive a first stream of a wireless network and a second stream of the wireless network, wherein the second stream competes with the first stream for a resource of the wireless network;
estimate a capacity of the first stream that is corresponding to a potential throughput of the first stream over the wireless network with regards to the second stream;
compare the estimated capacity with a demanding capacity of a network application whose associated data are transmittable by the first stream; and
display a result of the comparison.

17. The medium of claim 16, wherein the instructions to display the result of the comparison comprises instructions to display a degree of match between the estimated capacity and the demanding capacity.

18. The medium of claim 16, wherein the estimated capacity of the first stream is a capacity estimated to be an actual capacity of the first stream over the wireless network.

19. The medium of claim 16, wherein the instructions to display the result of the comparison comprises instructions to display one of two states including:
a first state indicating that the demanding capacity is met by the estimated capacity; and
a second state indicating that the demanding capacity is not met by the estimated capacity.

20. The medium of claim 16, wherein the instructions to estimate a capacity of the first stream that is corresponding to a potential throughput of the first stream over the wireless network with regards to the second stream comprises instructions to:
obtain capabilities of a transmitter and a receiver of a wireless link via which the first stream is transmitted;
collect information of a wireless transmission whose transmission signal with electromagnetic energy is above a threshold within a frequency band of the wireless link;
estimate, responsive to the obtained capabilities and the collected information, a transmission opportunity available for the transmitter to transmit wireless communications to the receiver; and
estimate, responsive to the determined capabilities and the collected information, an achievable transmission rate by the transmitter, wherein the capacity is estimated responsive to the estimated transmission opportunities and the estimated achievable transmission rate.
